(19) United States
(12) Patent Application Publication
(10) Pub. No.: US 2006/0245505 A1
(43) Pub. Date: Nov. 2, 2006

(54) Digital television signals using linear block coding

(76) Inventor: Allen LeRoy Limberg, Port Charlotte, FL (US)

Correspondence Address: ALLEN LEROY LIMBERG, ESQ., 1053 KENSINGTON STREET, PORT CHARLOTTE, FL, 33952, US

(21) Appl. No.: 11/119,662

(22) Filed: May 2, 2005

(51) Int. Cl. H04B 1/66

(52) U.S. Cl. 375/240.27

(57) ABSTRACT

To increase the robustness of a broadcast DTV signal, complete (207, 187) Reed-Solomon forward-error-correction codewords are coded using binary linear block codes that reduce code rate by two or slightly less, enabling a DTV receiver to correct bit errors. Also, a DTV receiver can use a (15, 8), (16, 8) or (8, 4) block code to locate erroneous bytes for decoding (207, 187) Reed-Solomon code, so twice as many erroneous bytes can be corrected in a 187-byte data packet. The reduced code rate permits robust transmission of a 187-byte data packet in only two data segments and its super-robust transmission using a restricted symbol alphabet in only four data segments. This simplifies time-division multiplexing of data segments used for ordinary 8VSB transmissions with those used for robust and super-robust transmissions. Procedures to make legacy DTV receivers disregard data segments used for robust and super-robust transmission are disclosed.

This invention relates to symbol coding of digital signals, such as those used for broadcasting digital television.

### BACKGROUND OF THE INVENTION

Annex D of the “ATSC Digital Television Standard” was published by the Advanced Television Systems Committee (ATSC) in September 1995 as its document A/53. This standard defined the broadcasting of digital television (DTV) signals within the United States of America and is referred to in this specification simply as “A/53”. A/53 specifies a vestigial-sideband amplitude-modulation signal in which the digital symbols are transmitted by eight-level modulation known as 8VSB which has +7, +5, +1, −1, −3, −5 and −7 normalized modulation signal values. The digital symbols are subjected to ⅔ trellis coding. The transmission of more robust DTV signals at halved or quartered code rate subsequently became a subject of interest at the beginning of the twenty-first century.

One approach to improving the robustness of DTV transmissions by reducing code rate is to increase the amount of forward-error-correction coding of the digital data. An approach which introduces further Reed-Solomon coding and further trellis coding of the less significant bits of each symbol is described in a “ATSC Digital Television Standard, Revision C” published by the Advanced Television Systems Committee (ATSC) in July 2004. This revised standard is referred to as ATSC document A/53C with Amendment No. 1. This revised standard describes code rate being further reduced by applying trellis coding to the most significant bit of each symbol. An alternative approach to improving the robustness of DTV transmissions is to restrict the symbol alphabet to increase the distance between the levels of amplitude modulation used to form the symbols.

U.S. patent application Ser. No. 10/955,212 filed 30 Sep. 2004 by Allen LeRoy Limberg and titled “TIME-DEPENDENT TRELLIS CODING FOR MORE ROBUST DIGITAL TELEVISION SIGNALS” is incorporated herein by reference. That application describes a previously known first type of robust modulation called “pseudo-2VSB”, or “P2VSB”. In P2VSB the digital symbols are restricted to +7, +5, −5 and −7 normalized modulation signal values, but sustain trellis coding. That application also describes a previously known second type of robust modulation called “enhanced 4VSB”, or “E4VSB”. In E4VSB the digital symbols are restricted to +7, +1, −3 and −5 normalized modulation signal values, but sustain trellis coding. U.S. patent application Ser. No. 10/955,212 discloses a third type of modulation in which the symbol alphabet of a digital television signal is restricted in either of two alternative ways. In accordance with a prescribed pattern, a ZERO or a ONE is inserted after each bit in a data segment to be incorporated into a data field for randomization, R-S FEC coding, convolutional interleaving, and trellis coding. Inserting a ONE after each bit in a stream of randomized data causes the trellis coding procedure to generate a restricted-alphabet signal which excludes the −7, −5, +1 and +3 symbol values of the full 8VSB alphabet. Inserting a ZERO after each bit in a stream of randomized data causes the trellis coding procedure to generate a restricted-alphabet signal which excludes the −3, −1, +5 and +7 symbol values of the full 8VSB alphabet. This specification refers to this third type of modulation as “prescribed-coset-pattern modulation”, or “PCPM”. Each of these three types of robust modulation that restrict the symbol alphabet halve the code rate of ordinary 8VSB.

Halving the code rate again to achieve still more robust “super-robust” signal transmission by further restricting the symbol alphabet is infeasible, it is observed. This is because the pattern of trellis coding A/53 prescribed for the less significant bits of 8VSB symbols has to be preserved within the data segments of each field of convolutionally interleaved data. Otherwise, legacy DTV receivers designed to receive 8VSB transmitted as prescribed by A/53 will not be able to receive 8VSB data segments successfully if those segments have been convolutionally interleaved with segments of robust data. So, further reduction of the code rate will have to be done by additional coding that extends over a plurality of 8VSB symbol epochs.

It is observed that this additional coding should be such that it does not involve data transmitted at normal 8VSB code rate, nor robust data transmitted at one-half 8VSB code rate, which data are apt to be convolutionally interleaved with super-robust data transmitted at one-quarter 8VSB code rate or so. A binary linear block code can provide for such additional coding. To facilitate time-division multiplexing with data segments of ordinary 8VSB and data segments of restricted-alphabet symbols, it would be preferable that an integral number of blocks of the additional coding fall within an interval equal to a multiple of 828 symbol epochs of 8VSB.

A (23, 12) binary Golay code has a block-length of twenty-three bits and consists of 2¹² codewords. The (23, 12) binary Golay code has a minimum Hamming distance of seven and corrects as many as three errors within a block. Code rate is reduced by a factor of 46/12, or 23/6, and is therefore actually slightly more than one-quarter 8VSB code rate. Thirty-six blocks of the (23, 12) binary Golay code span 828 8VSB symbol epochs and so will transmit, at quartered code rate, one-quarter of a (207, 187) R-S FEC codeword plus an extra eighteen bits. Twelve of those extra eighteen bits can be used for generating an auxiliary header that will cause a legacy DTV receiver to disregard the data segment. Two other of the extra bits can identify whether the segment is the first, second, third or fourth one of the four data segments containing super-robust coding of an MPEG-2 packet.

A (24, 12) binary extended Golay code has a block length of twenty-four bits and consists of 2¹² codewords. Sixty-nine blocks of the (24, 12) binary Golay code span 1656 8VSB symbol epochs and so will transmit one-half of a (207, 187) R-S FEC codeword at quartered code rate. The (24, 12) binary Golay code has a minimum Hamming distance of eight and corrects as many as three errors within a block. A decoding algorithm for the (24, 12) binary extended Golay code appears on page 135 of the textbook “An Introduction to Error Correcting Codes with Applications” written by Scott A. Vanstone and Paul C. van Oorschot, copyright 1989 by Kluwer Academic Publishers.

An (8, 4) linear block code has a block length of eight bits and consists of 2⁴ codewords. Insofar as this specification and the appended claims are concerned, a linear block code is defined to be capable of correcting or locating at least one bit error. With minimum Hamming distance of four, the (8, 4) linear block code can correct one bit error per 8-bit block and can detect up to three bit errors per 16-bit block and can detect up to eight bit errors per 16-bit block. It is here noted that the (8, 4) and (16, 8) linear block codes are of particular interest because they can locate byte errors for the (207, 187) Reed-Solomon forward-error-correcting outer code used in the DTV broadcast signal. This facilitates the use of an alternative (207, 187) Reed-Solomon error-correction algorithm that does not locate byte errors and that can correct twenty byte errors per 207-byte codeword, rather than just ten. The conventionally used (207, 187) Reed-Solomon error-correction algorithm that locates byte errors to be corrected cannot correct more than ten byte errors per 207-byte codeword.

A (15, 8) linear block code has a block length of fifteen bits and consists of 2⁸ codewords. The (15, 8) block code reduces code rate slightly less than halving it, making room for the insertion of auxiliary headers in the data segments used for robust transmission. It is here noted that the (15, 8) block code also can locate byte errors for the (207, 187) R-S FEC outer code used in the DTV broadcast signal. One way to obtain a (15, 8) block code is to expurgate a (15, 11) Hamming code, which can correct one bit error in a 15-bit block. A (15, 8) block code that can correct up to three bit errors in a 15-bit block is possible, however.

The (23, 12) Golay code or a (15, 8) linear block code can be used by itself to obtain a robust DTV transmission. Since each of these codes converts a single data segment to somewhat less than two data segments, an auxiliary header can be inserted before each data segment of code that will cause the data segment to be disregarded by a legacy DTV receiver.

The (24, 12) Golay code can also be used by itself to obtain a robust DTV transmission. So can an (8,4) or (16, 8) linear block code. Since the (24, 12) Golay code and the linear block codes that halve code rate convert a single data segment to two full data segments, these codes allow no room to insert auxiliary headers. As described in this specification, steps can be taken to assure that the data segments used for robust or super-robust transmissions do not resemble correct or correctable (207, 187) R-S FEC codewords transmitted by ordinary 8VSB. This is done to cause legacy DTV receivers to discard such data segments.

Previous proposals of more robust DTV signals have retained a three-byte header and twenty parity-check bytes of (207, 187) Reed-Solomon forward-error-correction coding in data segments containing reduced-code-rate information. The halving or quartering of code rate has been confined just to the 184-byte portions of the 207-byte data segments in these previous proposals. Accordingly, the robust transmission of an MPEG-2 data packet cannot be completed within just two data segments, but requires somewhat more than two data segments, complicating time-division multiplexing of the robust transmissions with transmissions of other code rate(s). Also, the super-robust transmission of an MPEG-2 data packet cannot be completed within just four data segments, but requires somewhat more than four data segments, complicating time-division multiplexing of the super-robust transmissions with transmissions of the other code rate(s).

### SUMMARY OF THE INVENTION

An aspect of the invention is the linear block coding of complete (207, 187) Reed-Solomon forward-error-correction codewords to increase the robustness of a broadcast digital television signal. The linear block coding is of a sort that reduces code rate by a factor of two or slightly less. Accordingly, the robust transmission of an MPEG-2 data packet can be completed within two data segments, and the super-robust transmission of an MPEG-2 data packet can be completed within four data segments. The linear block coding can use (23, 12) binary Golay codes, (24, 12) binary extended Golay codes, (8, 4) linear block codes, (16, 8) linear block codes or (15, 8) linear block codes, by way of specific examples. Other aspects of the invention concern transmitter apparatus for broadcasting a broadcast digital television signal employing linear block coding of complete (207, 187) Reed-Solomon forward-error-correction codewords. Still other aspects of the invention concern receiver apparatus for usefully receiving such robust data transmissions.

A further aspect of the invention is the making of super-robust data transmissions by linear block coding data and subsequently transmitting the block-coded data with a restricted alphabet of trellis-coded 8VSB symbols as part of a broadcast digital television signal. Other aspects of the invention concern transmitter apparatus for broadcasting a broadcast digital television signal including such super-robust data transmissions. Still other aspects of the invention concern receiver apparatus for usefully receiving such super-robust data transmissions.

A still further aspect of the invention is making robust and super-robust data transmissions in such way that digital television receivers already in the field, so-called “legacy” DTV receivers, will not be adversely affected insofar as usefully receiving ordinary 8VSB transmissions time-division multiplexed with the robust and super-robust data transmissions. Using (23, 12) binary Golay codes or (15, 8) linear block codes in more robust data transmissions allows the insertion of headers that will cause legacy DTV receivers to disregard those more robust data transmissions. Another general procedure for transmitting more robust data transmissions that legacy DTV receivers will disregard is as follows. The (207, 187) Reed-Solomon forward-error-correction codewords to be used in the more robust data transmissions are barrel-shifted before redundant coding to generate data segments to be transmitted more robustly. The barrel shifts position the parity-check bytes at the outsets of the data segments rather than at their conclusions. The final twenty bytes of a data segment to be transmitted more robustly are modified if the data segment would appear to legacy DTV receivers to be a correctable (207, 187) R-S FEC codeword recovered from an ordinary 8VSB transmission. Another still further aspect of the invention is a DTV receiver designed to recover robustly transmitted data packets from data segments which are subject to modification as described.

### BRIEF DESCRIPTION OF THE DRAWING

FIG. 1 is a schematic diagram of a broadcast digital television transmitter for transmitting 8VSB signals in time-division multiplex with super-robust data transmissions employing (23, 12) binary Golay coding to reduce code rate by a factor slightly less than two and restricting the 8VSB alphabet to halve code rate further, which transmitter embodies an aspect of the invention.

FIG. 2 is a schematic diagram showing one particular construction of the X₁ bits generator for any of the DTV transmitters of FIGS. 1, 10 and 15.

FIG. 3 is a table showing a possible set of X₁ bits stored in read-only memory included in the X₁ bits generator of FIG. 2.

FIG. 4 is a schematic diagram of a modification that is made to any of the DTV transmitters of FIGS. 1, 10 and 15 to provide for the transmission of block-coded pseudo-2VSB DTV signals with code rate substantially one-quarter that of ordinary 8VSB.

FIG. 5 is a schematic diagram of a modification that is made to any of the DTV transmitters of FIGS. 1, 10 and 15 to provide for the transmission of block-coded E4VSB DTV signals with code rate substantially one-quarter that of ordinary 8VSB.

FIG. 6 is a schematic diagram of a broadcast digital television transmitter for transmitting 8VSB signals in time-division multiplex with robust data transmissions employing (23, 12) binary Golay coding to reduce code rate, which transmitter embodies an aspect of the invention.

FIGS. 7A and 7B are diagrams showing how an assembler in the FIG. 1 DTV transmitter or the FIG. 6 DTV transmitter dissects each MPEG-2 data packet into four quarter-segments of data and inserts a respective 18-bit auxiliary header before each quarter-segment of data.

FIGS. 8A and 8B are diagrams of two data segments that an encoder for (23, 12) binary Golay code within the FIG. 1 DTV transmitter of the FIG. 6 DTV transmitter generates responsive to an MPEG-2 data packet.

FIGS. 9A, 9B, 9 and 9D are diagrams of four data segments of re-sampled (23, 12) binary Golay code generated within the FIG. 1 DTV transmitter responsive to an MPEG-2 data packet.

FIG. 10 is a schematic diagram of a broadcast digital television transmitter for transmitting 8VSB signals in time-division multiplex with super-robust data transmissions employing (15, 8) binary linear block coding to reduce code rate and restricting the 8VSB alphabet to halve code rate further, which transmitter embodies an aspect of the invention.

FIG. 11 is a schematic diagram of a broadcast digital television transmitter for transmitting 8VSB signals in time-division multiplex with robust data transmissions employing (15, 8) binary linear block coding to reduce code rate, which transmitter embodies an aspect of the invention.

FIGS. 12A and 12B are diagrams showing how an assembler in the FIG. 10 DTV transmitter or the FIG. 11 DTV transmitter dissects each MPEG-2 data packet into four quarter-segments of data and inserts a respective 26-bit auxiliary header before each quarter-segment of data.

FIGS. 13A and 13B are diagrams of two data segments that an encoder for (15, 8) binary linear block code within the FIG. 10 DTV transmitter or the FIG. 11 DTV transmitter generates responsive to an MPEG-2 data packet.

FIGS. 14A, 14B, 14C and 14D are diagrams of four data segments of re-sampled (15, 8) binary linear block code generated within the FIG. 10 DTV transmitter responsive to an MPEG-2 data packet.

FIG. 15 is a schematic diagram of a broadcast digital television transmitter for transmitting 8VSB signals in time-division multiplex with super-robust data transmissions employing linear block coding to halve code rate and restricting the 8VSB alphabet to halve code rate again, which transmitter embodies an aspect of the invention.

FIG. 16 is a schematic diagram showing that the linear block coding is (24, 12) binary extended Golay coding in one species of the FIGS. 15 DTV transmitter.

FIG. 17 is a schematic diagram showing that the linear block coding is (8, 4) binary linear block coding in another species of the FIG. 15 DTV transmitter.

FIG. 18 shows one possible generator matrix for (8, 4) binary linear block coding.

FIG. 19 is a schematic digram showing that the linear block coding is (16, 8) binary linear block coding in still another species of the FIG. 15 DTV transmitter.

FIG. 20 shows one possible generator matrix for (16, 8) binary linear block coding.

FIG. 21 is a schematic diagram of a broadcast digital television transmitter for transmitting 8VSB signal in time-division multiplex with robust data transmissions employing binary linear block coding to halve code rate, which transmitter embodies an aspect of the invention.

FIGS. 22A and 22B are diagrams showing how circuitry in the FIG. 15 DTV transmitter or the FIG. 21 DTV transmitter arranges each (207, 187) Reed-Solomon forward-error-correction code so the twenty parity-check bytes precede the 187 bytes of a shortened MPEG-2 data packet.

FIGS. 23A and 23B are diagrams of two data segments that an encoder for linear block code within the FIG. 15 DTV transmitter or the FIG. 21 DTV transmitter generates responsive to an MPEG-2 data packet.

FIGS. 24A, 24B, 24C and 24D are diagrams of four half data segments of linear block code generated within the FIG. 15 DTV transmitter responsive to an MPEG-2 data packet.

FIGS. 25A, 25B, 25C and 25D are diagrams of four data segments of linear block code as re-sampled within the FIG. 15 DTV transmitter for super-robust transmission with a restricted symbol alphabet.

FIG. 26 is a schematic diagram of a broadcast digital television transmitter for transmitting 8VSB signals in time-division multiplex with robust data transmissions employing a restricted symbol alphabet to halve code rate, which transmitter embodies an aspect of the invention.

FIGS. 27A and 27B are diagrams showing how circuitry in the FIGS. 26 DTV transmitter arranges each (207, 187) Reed-Solomon forward-error-correction code so the twenty parity-check bytes precede the 187 bytes of a shortened MPEG-2 data packet.

FIGS. 28A and 28B are diagrams of two data segments that a re-sampler used within the FIG. 26 DTV transmitter generates responsive to an MPEG-2 data packet.

FIG. 29 is a schematic diagram of a portion of a broadcast DTV signal receiver that in accordance with an aspect of the invention is capable of usefully receiving robust or super-robust broadcast DTV signals that employ Golay coding, extended Golay coding, or other linear block coding.

FIG. 30 is a schematic diagram of a further portion of a broadcast DTV signal receiver constructed in accordance with an aspect of the invention to be capable of usefully receiving robust or super-robust broadcast DTV signals that employ Golay coding or extended Golay coding.

FIG. 31 is a schematic diagram showing in detail apparatus including circuitry for decoding (23, 12) binary Golay code used in an embodiment of the broadcast DTV signal receiver of FIGS. 29 and 30.

FIG. 32 is a schematic diagram showing in detail further apparatus, used together with the FIG. 31 apparatus in an embodiment of the broadcast DTV signal receiver of FIGS. 29 and 30, and also used together with the FIG. 36 apparatus in an embodiment of the broadcast DTV signal receiver of FIGS. 29 and 35.

FIG. 33 is a schematic diagram showing in detail apparatus including circuitry for decoding (24, 12) binary extended Golay code used in an embodiment of the broadcast DTV signal receiver of FIGS. 29 and 30.

FIG. 34 is a schematic diagram showing in detail further apparatus, used together with the FIG. 31 apparatus in an embodiment of the broadcast DTV signal receiver of FIGS. 29 and 30, and used together with the apparatuses of FIGS. 37 and 38 in further embodiments of the broadcast DTV signal receiver of FIGS. 29 and 35.

FIG. 35 is a schematic diagram of a portion of a broadcast DTV signal receiver combining with the FIG. 29 portion in accordance with an aspect of the invention to form a receiver capable of usefully receiving robust or super-robust broadcast DTV signals that employ (15, 8), (8, 4) or (16, 8) linear block coding.

FIG. 36 is a schematic diagram showing in detail apparatus including circuit for decoding (15, 8) linear block code used together with the further apparatus of FIG. 32 in an embodiment of the broadcast DTV signal receiver of FIGS. 29 and 35.

FIG. 37 is a schematic diagram showing in detail apparatus including circuitry for decoding (8, 4) linear block code used together with the further apparatus of FIG. 34 in an embodiment of the broadcast DTV signal receiver of FIGS. 29 and 35.

FIG. 38 is a schematic diagram showing in detail apparatus including circuitry for decoding (16, 8) linear block code used together with the further apparatus of FIG. 34 in an embodiment of the broadcast DTV signal receiver of FIGS. 29 and 35.

FIG. 39 is a schematic diagram of a modification of the FIG. 29 portion of a broadcast DTV signal receiver, which modification determines the pattern of data segments in a de-interleaved data field by analyzing the natures of those data segments themselves.

FIG. 40 is a schematic diagram showing in detail an alternative type of decoder used in the FIG. 39 portion of a broadcast DTV signal receiver to determine the pattern of data segments in a de-interleaved data field.

FIG. 41 is a schematic diagram of a modification of the FIG. 40 decoder used in the FIG. 39 portion of a broadcast DTV signal receiver to determine the pattern of data segments in a de-interleaved data field.

Connections that convey control signals are shown in dashed lines in the figures of the drawing. Some connections may require the insertion of shim delays, which shim delays are omitted in drawing figures to avoid clutter that would make them more difficult to understand.

### DETAILED DESCRIPTION

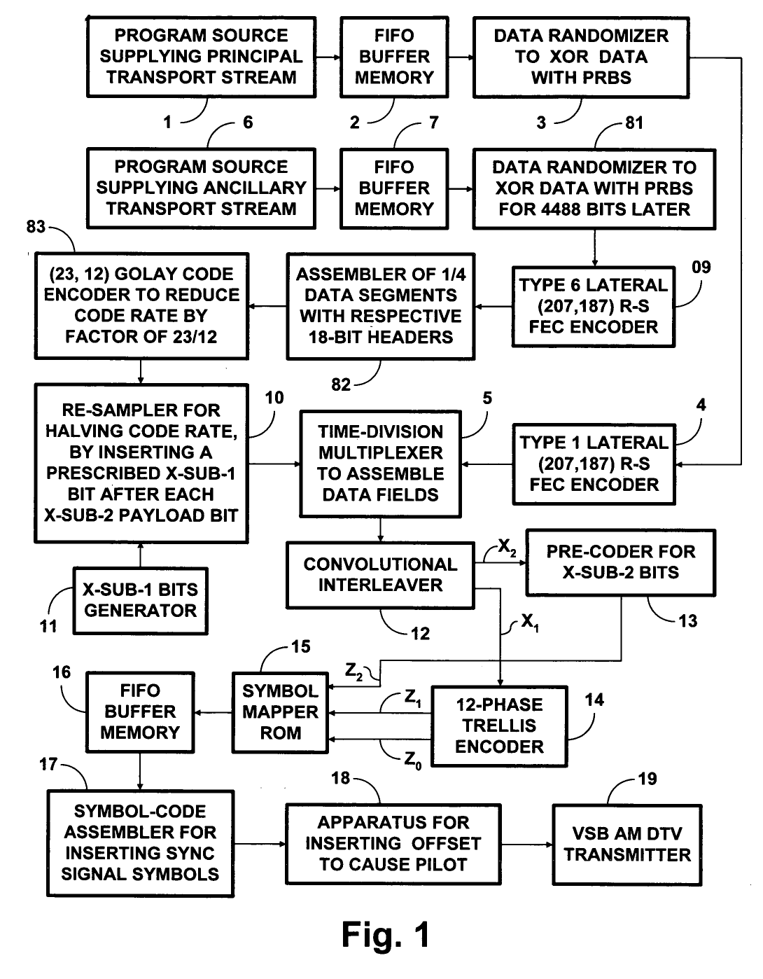

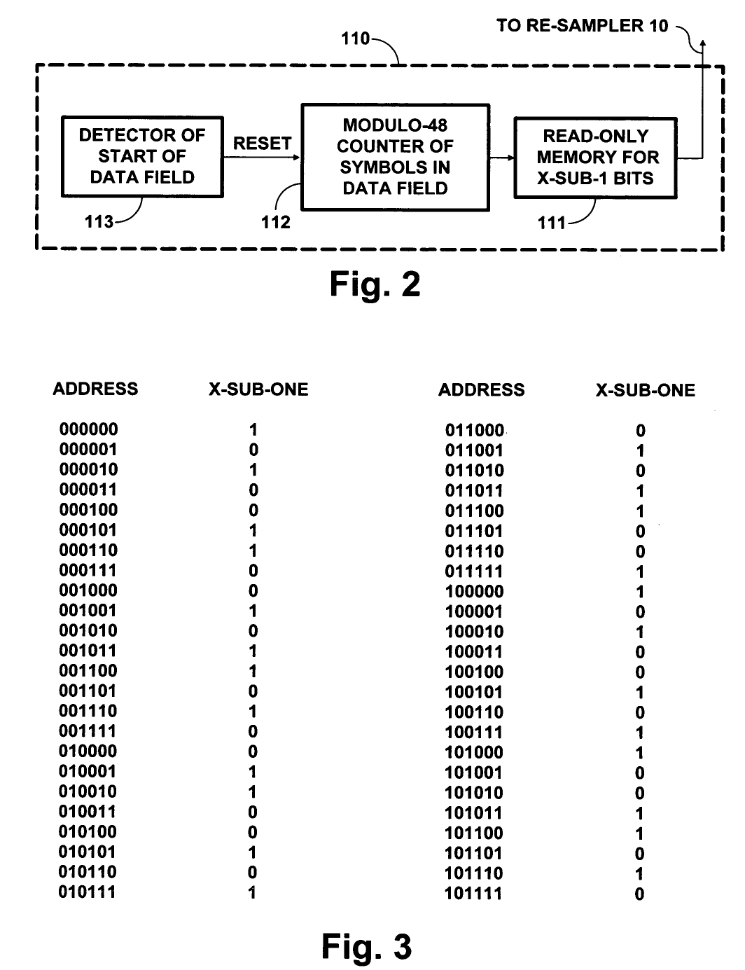

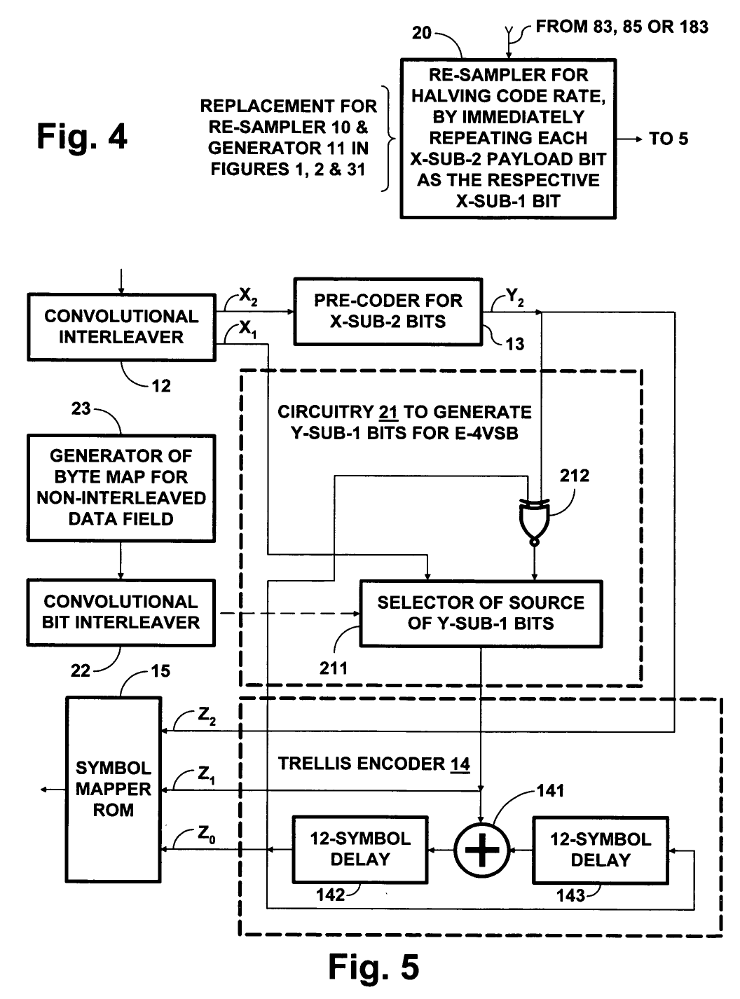

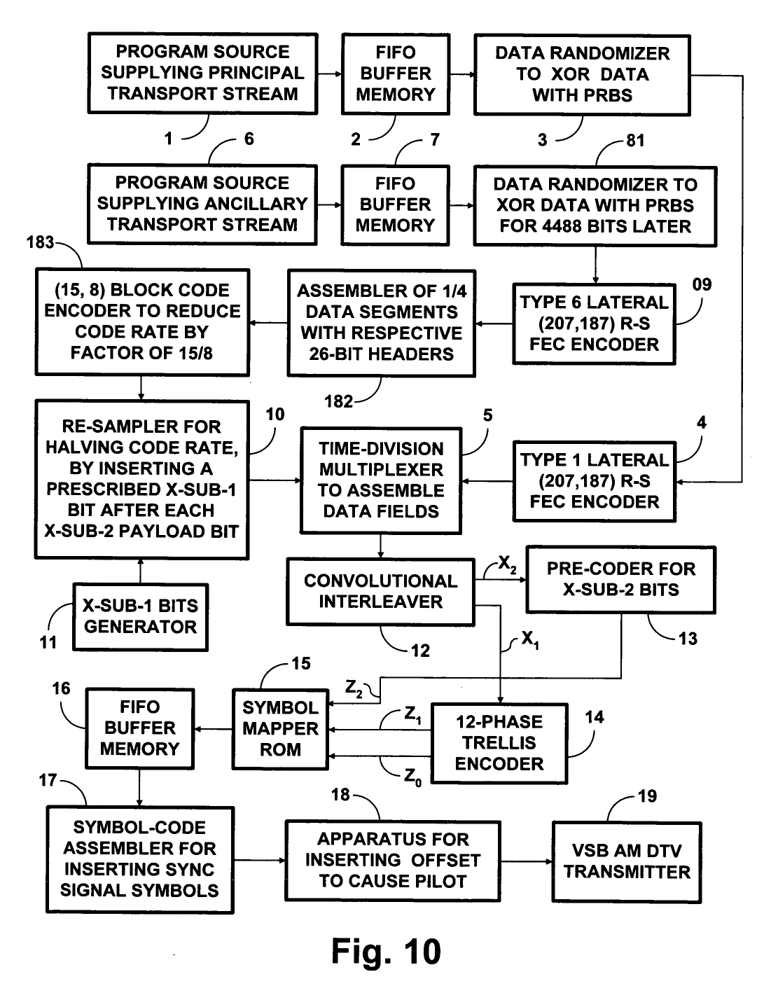

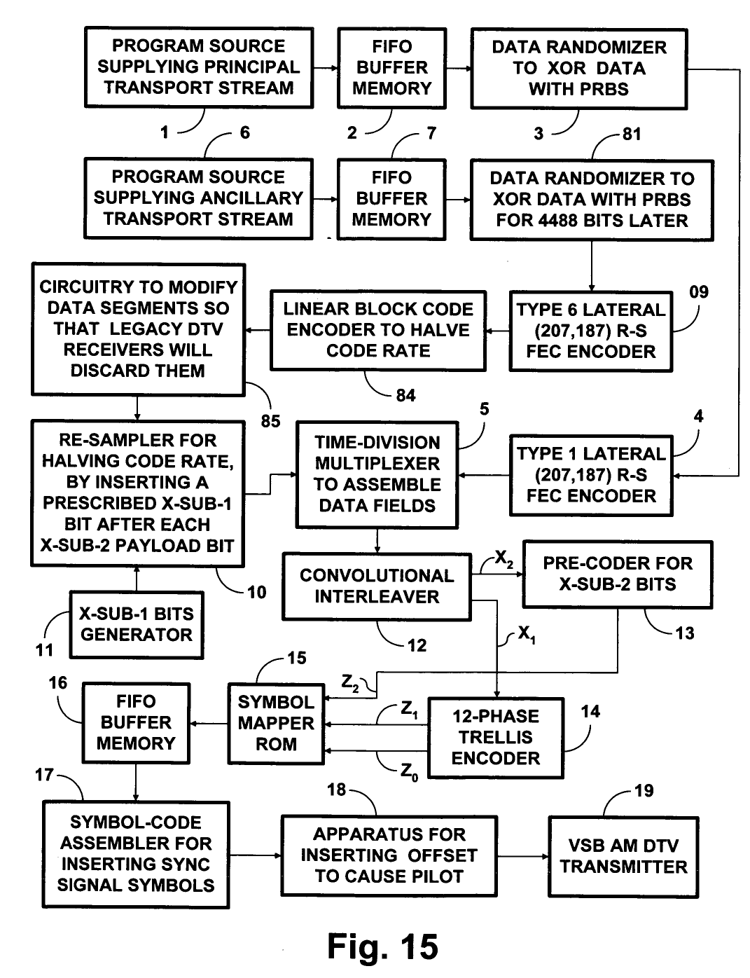

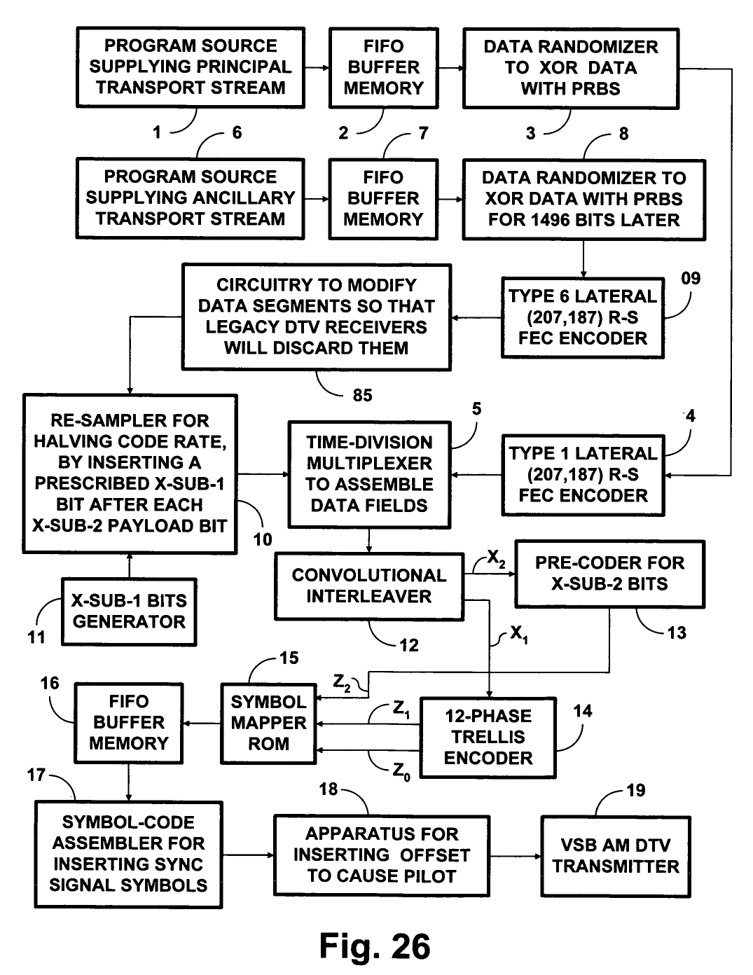

In accordance with aspects of the invention, the DTV transmitter shown in FIG. 1 of U.S. patent application Ser. No. 10/955,212 is modified in various ways as shown in FIGS. 1, 6, 10, 11, 15, 21 and 26 accompanying this specification. In the modified DTV transmitters shown in FIGS. 1, 10 and 15 accompanying this specification, the data randomizer 8 is replaced by a data randomizer 81, which uses a randomization pattern for a later time. This replacement by the data randomizer 81 takes into account the latent delay associated with compressing super-robust data in the DTV receiver being longer than the latent delay associated with compressing robust data. The modified DTV transmitters shown in FIGS. 1, 6, 10, 11, 15, 21 and 26 accompanying this specification all include a lateral (207, 187) Reed-Solomon forward-error-correction encoder 09 of sixth type. It replaces lateral (207, 187) Reed-Solomon forward-error-correction encoder 9 of first type that FIG. 1 of U.S. patent application Ser. No. 10/955,212 shows. The (207, 187) R-S FEC encoder 9 of first type is conventional in nature, with the twenty parity-check bytes succeeding the 187 information bytes as specified in A/53, Annex D, §§ 4.2.3 titled “Reed-Solomon encoder”. The (207, 187) R-S FEC encoder 09 of sixth type differs from the (207, 187) R-S FEC encoder 9 of first type in that the bytes are barrel-shifted so that the twenty parity-check bytes precede the 187 information bytes, rather than succeeding them. In the FIG. 1 modified DTV transmitter the (207, 187) R-S FEC encoder 09 is followed by the cascade connection of an assembler 82 of quarter-segments of data with respective 18-bit auxiliary headers and a subsequent encoder 83 for (23, 12) binary Golay code. The encoder 83 reduces code rate of the extended quarter-segments of data by a factor of 23/12. In the FIG. 10 modified DTV transmitter the (207, 187) R-S FEC encoder 09 is followed by the cascade connection of an assembler 182 of quarter-segments of data with respective 26-bit auxiliary headers and a subsequent encoder 183 for (15, 8) binary linear block code. The encoder 183 reduces code rate of the extended quarter-segments of data by a factor of 15/8. In the FIG. 15 modified DTV transmitter an encoder 84 for linear block coding is included after the (207, 187) R-S FEC encoder 09 for halving code rate. The encoder 84 is followed by circuitry 85 to modify the resulting data segments as needed, so that legacy DTV receivers will disregard them. In the FIG. 26 modified DTV transmitter the circuitry 85 is included directly after the (207, 187) R-S FEC encoder 09 for halving code rate.

In the modified DTV transmitter of FIG. 1 a program source 1 of a principal transport stream is connected for supplying the successive 187-byte data packets to a first-in/first-out buffer memory 2 for being written into temporary storage therein. A data randomizer 3 is connected for receiving data packets read from the FIFO buffer memory 2 and randomizing the bits in those data packets by exclusive-ORing those bits with the bits of a 2¹⁶-bit maximal length pseudo-random binary sequence (PRBS). The PRBS, which is initialized at the beginning of each data field, is that specified in A/53, Annex D, §§ 4.2.2 titled “Data randomizer”. The portion of the PRBS used in exclusive-ORing each data segment is that portion which is suitable for the location of that data segment in the non-interleaved data field that will be assembled for subsequent lateral (207, 187) R-S FEC coding, convolutional interleaving and trellis coding. A lateral (207, 187) Reed-Solomon forward-error-correction encoder 4 is connected for receiving from the data randomizer 3 the 187-byte packets of randomized data from the principal transport stream. The lateral (207, 187) R-S FEC encoder 4 converts these randomized 187-byte data packets to respective 207-byte segments of lateral (207, 187) Reed-Solomon forward-error-correction coding that appends the respective twenty parity-check bytes of the coding of each randomized 187-byte data packet after the conclusion thereof. The lateral (207, 187) R-S FEC encoder 4 is of a first type that is conventional in nature; and the practice specified in A/53, Annex D, §§ 4.2.3 titled “Reed-Solomon encoder” is followed. A time-division multiplexer 5 used to assemble data fields is connected for receiving at a first of its two input ports the 207-byte segments of lateral (207, 187) R-S FEC coding generated by the lateral (207, 187) R-S FEC encoder 4.

FIG. 1 shows a program source 6 of an ancillary transport stream connected for supplying the successive 187-byte data packets in that transport stream to be written into a first-in/first-out buffer memory 7 for temporary storage therein. The data randomizer 81 is connected for receiving data packets read from the FIFO buffer memory 7. The data randomizer 81 is operated for randomizing the bits in those data packets by exclusive-ORing them with the bits of the PRBS for a time 4488 bits (3 data packets) later than the location of the beginning of data segments coding that data packet in the non-interleaved data field. The lateral (207, 187) Reed-Solomon forward-error-correction encoder 09 of the sixth type is connected for receiving from the data randomizer 81 the 187-byte packets of randomized data from the ancillary transport stream. The lateral (207, 187) R-S FEC encoder 09 converts these 187-byte packets of randomized data to respective 207-byte segments of lateral (207, 187) R-S FEC coding that positions the respective twenty parity-check bytes of the coding of each 187-byte packet of randomized data after the conclusion thereof. The assembler 82 inserts a respective 18-bit auxiliary header before each quarter-segment of data supplied from the (207, 187) R-S FEC encoder 09 and supplies the resulting extended quarter-segments of data to the encoder 83 for (23, 12) binary Golay coding. The encoder 83 generates in response to each successive pair of these extended quarter-segments of data a respective 207-byte data segment at halved code rate, which is supplied to the re-sampler 10. The re-sampler 10 treats each of these 207-byte data segments from encoder 83 as consisting of the X₂ bits utilized in the data stream that the re-sampler 10 supplies to a second of the two input ports of the time-division multiplexer 5. The re-sampler 10 halves the code rate of its response by inserting a respective X₁ bit received from an X₁ bits generator 11 after each of the X₂ bits it receives from the encoder 83. The halving of code rate by the re-sampler 10 combines with the reduction of code rate by the cascaded assembler 82 and encoder 83 for (23, 12) Golay code, to reduce effective code rate to one quarter that of ordinary 8VSB signal.

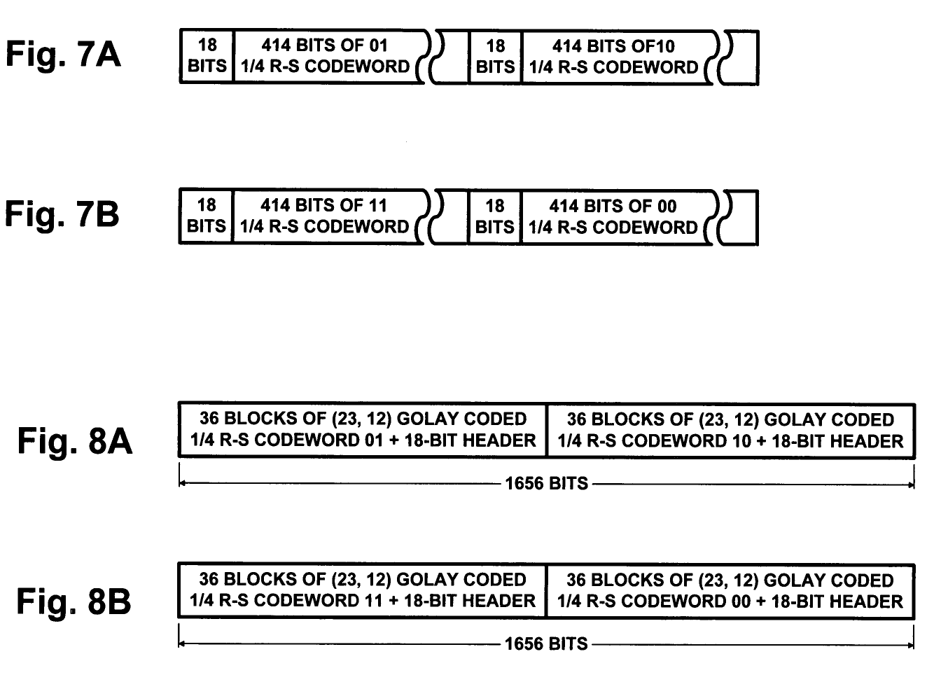

A convolutional interleaver 12 is connected for receiving the successive data segments of the non-interleaved data field assembled by the time-division multiplexer 5. The convolutional interleaver 12 responds to supply the successive data segments of an interleaved data field using interleaving as prescribed by A/53, Annex D, §§ 4.2.4 titled “Interleaving”. A precoder 13 is connected for receiving the X₂ bits of the convolutional interleaver 12 response and generating Z₂ bits by adding modulo-2 the X₂ bits with those bits from twelve symbol epochs previous. A 12-phase trellis encoder 14 is connected for receiving the X₁ bits of the convolutional interleaver 12 response and supplying them as Z₁ bits. The trellis encoder 14 is connected for supplying Z₀ bits that it generates dependent on previously received X₁ bits. A symbol map read-only memory 15 is connected for receiving Z₂ bits from the precoder 13 as a portion of its addressing input signal and for receiving the Z₁ and Z₀ bits from the trellis encoder 14 as the remaining portion of its addressing input signal. The trellis encoder 14, the precoder 13 and the symbol map ROM 15 conform with the 8VSB trellis encoder, precoder and symbol mapper shown in FIG. 7 of A/53, annex D. The precoder 13, the trellis encoder 14 and the symbol map ROM 15 are operated in conformance with A/53, Annex D, §§ 4.2.5 titled “Trellis coding”.

The symbol map ROM 15 operates as a symbol mapper for supplying 3-bit, 8-level symbols to a first-in/first-out buffer memory 16. The FIFO buffer memory 16 is operated to provide rate buffering and to open up intervals between 828-symbol groups in the symbol stream supplied to a symbol-code assembler 17, into which intervals the symbol-code assembler 17 inserts synchronizing signal symbols. Each of the successive data fields begins with a respective interval into which the symbol-code assembler 17 inserts symbol code descriptive of a data-segment-synchronization (DSS) sequence followed by symbol code descriptive of an initial data segment including an appropriate data-field-synchronization (DFS) sequence. Each data segment in the respective remainder of each data field is followed by a respective interval into which the symbol-code assembler 17 inserts symbol code descriptive of a respective DSS sequence. Apparatus 18 for inserting the offset to cause pilot is connected to receive assembled data fields from the symbol-code assembler 17. The apparatus 18 is simply a clocked digital adder that zero extends the number used as symbol code and adds a constant term thereto to generate a read-only modulating signal in digital form, supplied to a vestigial-sideband amplitude-modulation digital television transmitter 19 of conventional construction.

FIG. 2 shows one particular construction 110 of the X₁ bits generator 11 for and of the DTV transmitters shown in FIGS. 1, 10 and 15. Responsive to input addressing received from a symbol counter 112, a read-only memory 111 supplies X₁ bits to the re-sampler 10 in the DTV transmitter of FIG. 1 or 10 or 15. FIG. 3 is a table showing a possible set of X₁ bits stored in the ROM 111. The symbol counter 112 is of a type supplying consecutive counts zero through forty-seven and rolling back to zero count after forty-seven count. If the trellis encoder 14 receives X₁ bits that change value every second X₁ bit for each of the twelve trellis coding phases, the trellis encoder 14 generates all four types of Z₁, Z₀ pairs in substantially the same number over a long enough period of time. By staggering the way the X₁ repeats occur in the twelve trellis coding phases, the length of this period of time can be shortened some.

However, there is a preference that each grouping of the quartered-code-rate signal in the convolutional interleaver 12 response contains 48 or a multiple of 48 successive symbols. This can be achieved most of the time by grouping the quartered-code-rate signal in the time-division multiplexer 5 response so it occurs in bands of twelve contiguous data segments.

Since the X₂ bits are randomized, the Z₂ bits supplied from the precoder 13 are also randomized. The randomized nature of the Z₂ bits, all four types of Z₁, Z₀ pairs occurring in substantially the same number over a period of time, and the independence of the Z₀ and Z₁ bits cause the eight 8VSB symbols to occur substantially as often as each other in the robust modulation. Accordingly, the ratio of peak power to average power in the robust modulation generated in response to the particular construction 110 of the X₁ bits generator 11 is substantially the same as in normal 8VSB modulation.

FIG. 2 shows a detector 113 of the start of the data field connected to supply the symbol counter 112 with a reset pulse at the beginning of each data field, which reset pulse resets the count to 0000000. A typical construction for the detector 113 includes a match filter for generating a pulse response to the PN511 sequence in the initial data segment of the data field DFS. The typical construction for the detector 113 further includes a clocked digital delay line for delaying that pulse response to provide the reset pulse to the symbol counter 112 to reset it to the 0000000 count at the beginning of the actual data field, exclusive of synchronizing signals.

FIG. 4 shows a modification that can be made to the DTV transmitter of FIG. 1 or 10 or 15, which modification provides for the transmission of 8VSB and pseudo-2VSB signal in time-division multiplex. The re-sampler 10 and the X₁ bits generator 11 of the DTV transmitter of FIG. 1 or 10 or 15 are replaced by a re-sampler 20. The re-sampler 20 halves code rate in the data stream it supplies to the time-division multiplexer 5 used to assemble data fields. The re-sampler 20 halves code rate by immediately repeating each X₂ bit, thereby generating a respective X₁ bit. The pre-coder 13, the trellis encoder 14 and the symbol map ROM 15 convert each of the resulting bit pairs to a respective pseudo-2VSB symbol.

FIG. 5 shows a modification of the DTV transmitter of FIG. 1 or 10 or 15, which modification provides for the transmission of enhanced-4VSB signal in time-division multiplex with normal 8VSB signal. Circuitry 21 to generate the Y₁ bits for E-4VSB is interposed between the convolutional interleaver 12 and the trellis encoder 14. A selector 211 of the source of Y₁ bits is connected for supplying Y₁ bits to the trellis encoder 14. When a normal 8VSB symbol is to be transmitted, the selector 211 generates the Y₁ bit by reproducing the X₁ bit from the convolutional interleaver 12 response. Whenever an E-4VSB symbol is to be transmitted, the selector 211 generates the Y₁ bit by reproducing the response from an exclusive-NOR gate 212. The exclusive-NOR gate 212 is connected for receiving each successive Y₂ bit from the precoder 13 at one of its two input ports and for receiving each successive Z₀ bit from the trellis encoder 14 at the other of its two input ports. The Y₂ bit from the precoder 13 corresponds to the Z₂ bit from the trellis encoder 14, so effectively the Z₁ bit of each E-4VSB symbol that is to be transmitted is the exclusive-NOR gate 212 response to its Z₂ and Z₀ bits. If the Z₂ and Z₀ bits of the E-4VSB symbol are ZERO and ONE, respectively, the E-4VSB symbol must have a −5 symbol code with a Z₁ bit that is a ZERO. If the Z₂ and Z₀ bits of the E-4VSB symbol are both ZEROes, the E-4VSB symbol must have a −3 symbol code with a Z₁ bit that is a ONE. If the Z₂ and Z₀ bits of the E-4VSB symbol are ONE and ZERO, respectively, the E-4VSB symbol must have a +1 symbol code with a Z₁ bit that is a ZERO. If the Z₂ and Z₀ bits of the E-4VSB symbol are both ONEs, the E-4VSB symbol must have a +7-symbol code wit a Z₁ bit that is a ONE.

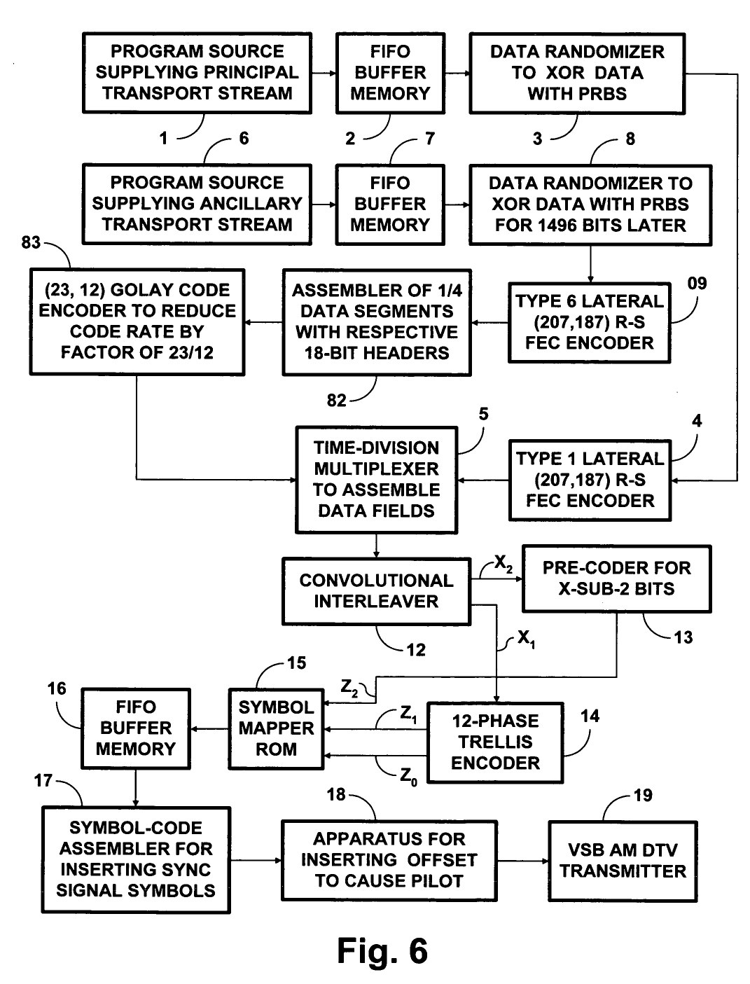

The DTV transmitter in FIG. 1 accompanying this specification can be viewed from the standpoint that the (23, 12) binary Golay coding provides for robust transmission with the restriction of 8VSB alphabet providing additional robustness to provide super-robust transmission. In the FIG. 6 transmitter for broadcast DTV signals, the (23, 12) binary Golay coding provides for robust transmission; and the re-sampler 10 and the X₁ bits generator 11 used by the FIG. 1 transmitter to provide for super-robust transmission are dispensed with. The cascade connection of the assembler 82 of quarter R-S codewords with respective 18-bit auxiliary headers and the subsequent (23, 12) Golay encoder 83 connect the R-S FEC encoder 09 to the input port of the time-division multiplexer 5. The data randomizer 81 is replaced by a data randomizer 8, which uses a randomization pattern for a time only 1496 bits (one data packet) later.

Data compression in DTV receivers is facilitated if an MPEG-2 data packet prepared for robust transmission occupies two consecutive data segments in the data field before interleaving. This reduces the number of possible patterns of the inclusion with a data field of data segments for robust transmission. The number of such patterns can be reduced still further by requiring every MPEG-2 data packet prepared for robust transmission to begin in one of the consecutively numbered segments of the non-interleaved data field that is either even numbered or is odd numbered. Such requirement augments the continuity count within the MPEG-2 data packet.

Similarly, data compression in DTV receivers is facilitated if an MPEG-2 data packet prepared for super-robust transmission occupies four consecutive data segments in the data field before interleaving. The number of possible patterns of the inclusion with a data field of data segments for super-robust transmission is limited by this requirement. The number of such patterns can be reduced still further, by requiring every MPEG-2 data packet prepared for robust transmission to begin in prescribed ones of the consecutively numbered segments of the non-interleaved data field. Such requirement augments the continuity count within the MPEG-2 data packet.

Indexing the location of the data segments containing a (207, 187) R-S FEC codeword for robust or super-robust transmission is less important if (23, 12) Golay encoding or (15, 8) linear block encoding is used than if (24, 12) Golay encoding, (8, 4) block coding or (16, 8) block coding is used. This is because the data segments with (23, 12) binary Golay encoding or (15, 8) linear block encoding have auxiliary headers that can include bits specifying how the data in them are to be disposed in the complete (207, 187) R-S FEC codeword. These bits are among the last six bits in the first 12-bit block generating bits within the auxiliary header of each data segment of (23, 12) Golay encoding, so their presence is not of consequence to legacy DTV receivers discarding each such data segment. These bits appear in the first and second 8-bit blocks generating bits within the auxiliary header of each data segment of (15, 8) linear block encoding, so their presence is not of consequence to legacy DTV receivers.

In this specification DTV transmitters embodying aspects of the invention are described presuming that each (207, 187) R-S FEC codeword encoded for additional robustness is encoded so as to appear in successive data segments of a data field that is not yet subjected to convolutional interleaving. In this specification DTV receivers embodying aspects of the invention are described presuming that each (207, 187) R-S FEC codeword encoded for additional robustness is encoded so as to appear in successive data segments of a de-interleaved data field. These presumptions are made for simplicity of description and are not applicable to some embodiments of the invention.

FIGS. 7A and 7B diagram the bit output from the assembler 82 of quarter R-S codewords with respective 18-bit auxiliary headers that the DTV transmitters of FIGS. 1 and 6 each include. These DTV transmitters are of particular interest because they can readily provide for robust and super-robust transmissions that a DTV receiver already in the field, a so-called “legacy” DTV receiver, will disregard. The first 12 bits of each of these 18-bit auxiliary headers will generate 23 bits of (23, 12) binary Golay code that is independent of other (23, 12) binary Golay code and will be unaffected by the data transported in that other (23, 12) binary Golay code. The first 12 bits of each of these 18-bit auxiliary headers are chosen such that the fourth through sixteenth bits of the 23 bits of (23, 12) binary Golay code generated therefrom constitute a particular packet identifier (PID) sequence. This PID sequence is such as to cause legacy DTV receivers to discard data segments coding information of the sort shown in FIGS. 7A and 7B.

FIGS. 8A and 8B diagram two successive data segments of the bit output from the encoder 83 for (23, 12) binary Golay code that the DTV transmitters of FIGS. 1 and 6 each include. As shown in FIG. 8A, the encoder 83 generates thirty-six 23-bit blocks of (23, 12) binary Golay code in response to the first quarter R-S codeword 01 of four and its 18-bit auxiliary header supplied from the assembler 82. Then, the encoder 83 generates another thirty-six 23-bit blocks of (23, 12) binary Golay code in response to the second quarter R-S codeword 10 of four and its 18-bit auxiliary header supplied from the assembler 82. The seventy-two 23-bit blocks of (23, 12) binary Golay code in the FIG. 8A data segment contain 1656 bits, the number of bits that when ⅔ trellis coded generate 828 symbols from the 8VSB alphabet. As shown in FIG. 8B, the encoder 83 generates thirty-six 23-bit blocks of (23, 12) binary Golay code in response to the third quarter R-S codeword 11 of four and its 18-bit auxiliary header supplied from the assembler 82. Then, the encoder 83 generates another thirty-six 23-bit blocks of (23, 12) binary Golay code in response to the fourth quarter R-S codeword 00 of four and its 18-bit auxiliary header supplied from the assembler 81. The seventy-two 23-bit blocks of (23, 12) binary Golay code in the FIG. 8B data segment contain 1656 bits, the number of bits that when ⅔ trellis coded generate 828 symbols from the 8VSB alphabet. In the FIG. 1 DTV transmitter, each of the two successive data segments of (23, 12) binary Golay code are re-coded using a restricted symbol alphabet, thereby generating four data segments for super-robust transmission.

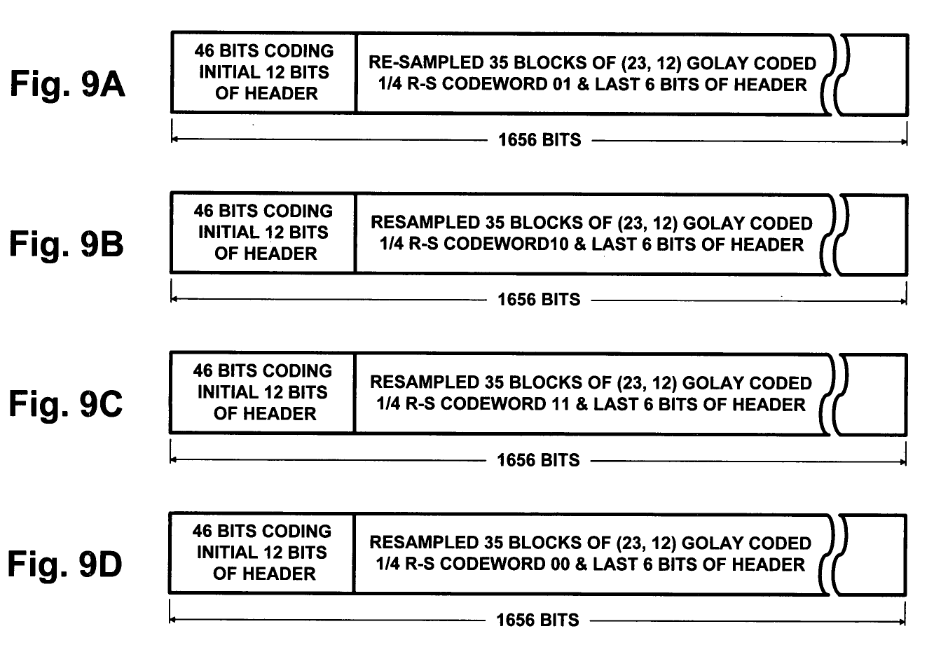

FIGS. 9A, 9B, 9C and 9D show a set of four data segments for super-robust transmission generated by recoding two data segments of (23, 12) binary Golay code so as to use a restricted symbol alphabet. In each of FIGS. 9A, 9B, 9C and 9D a block of (23, 12) binary Golay code corresponding to the initial twelve bits of an 18-bit auxiliary header is re-coded to generate the initial 46 bits of a data segment prepared for subsequent super-robust transmission. When the P2VSB or the PCPM restricted alphabet is used, the first 12 bits of each of these 18-bit auxiliary headers are chosen such that the fourth through sixteenth bits of the 46 bits of (23, 12) binary Golay code constitute a particular packet identifier (PID) sequence. If possible, this PID sequence should be such as to cause legacy DTV receivers to discard the data segments shown in FIGS. 9A, 9B, 9C and 9D.

E4VSB presents the problem that the X₁ bits depend on the X₂ bits generated responsive to other types of data transmission interleaved with the E4VSB super-robust transmission. When the E4VSB restricted alphabet is used, the first 12 bits of each of these 18-bit auxiliary headers are chosen such that the fourth through sixteenth bits of these 46 bits constitute one of a set of particular packet identifier (PID) sequences. If possible, each of these PID sequences should be such as to cause legacy DTV receivers to discard the data segments shown in FIGS. 9A, 9B, 9C and 9D.

In each of the FIGS. 9A, 9B, 9C and 9D the initial 46 bits of a data segment corresponding to the initial twelve bits of an 18-bit auxiliary header are followed by a re-coding of 35 blocks of (23, 12) binary Golay code in preparation for subsequent super-robust transmission using a restricted symbol alphabet. The re-coded 35 blocks of Golay code in the FIG. 9A data segment describe the first quarter of an MPEG-2 packet and the final six bits of its 18-bit auxiliary header. The re-coded 35 blocks of Golay code in the FIG. 9B data segment describe the second quarter of an MPEG-2 packet and the final six bits of its 18-bit auxiliary header. The re-coded 35 blocks of Golay code in the FIG. 9C data segment describe the third quarter of an MPEG-2 packet and the final six bits of its 18-bit auxiliary header. The re-coded 35 blocks of Golay code in the FIG. 9D data segment describe the fourth quarter of an MPEG-2 packet and the final six bits of its 18-bit auxiliary header. The initial twelve bits of the 18-bit auxiliary headers are prescribed, so as to cause the ensuing quarters of an MPEG-2 packet to be discarded by legacy DTV receivers. However, the final six bits of the 18-bit auxiliary headers can be freely chosen. It is useful to use at least of these bits to identify where the data segment reposes in the cycle of plural data segments encoding a particular MPEG-2 packet.

As described above, the FIG. 1 transmitter inserts auxiliary headers into the data segments used for super-robust transmission using (23, 12) binary Golay coding have a different PID than the auxiliary headers that the FIG. 6 transmitter inserts into the data segments using (23, 12) binary Golay coding for robust transmission. Using auxiliary headers with unique PIDs for different types of robust and super-robust transmissions using (23, 12) binary Golay coding provides an alternative way of identifying the pattern of data segments in a data field that use different types of robust and super-robust transmissions. However, when decoding the robust transmissions using (23, 12) binary Golay coding, a DTV receiver does not consider the initial 23-bit block in each of the data segments. So, if desired, these initial 23-bit blocks can be replaced by initial 23-bit blocks identical to those used in a particular sort of super-robust transmission.

The FIG. 10 DTV transmitter differs from the FIG. 1 DTV transmitter in that the assembler 82 and the encoder 83 for (23, 12) binary Golay code are replaced by an assembler 182 and an encoder 183 for a (15, 8) linear block code that reduces code rate by a factor of 15/8. The (15, 8) block code still allows the introduction of auxiliary headers on data segments used for robust transmission or for super-robust transmission. However, the (15, 8) block code is suited for locating byte errors when the (207, 187) R-S FEC coding is decoded in a DTV receiver. The assembler 182 inserts a respective 26-bit auxiliary header before each quarter-segment of data supplied from the (207, 187) R-S FEC encoder 09 and supplies the resulting extended quarter-segments of data to the encoder 183. One possible generator matrix for the (15, 8) block code resembles the generator matrix shown in FIG. 20 modified to remove the leftmost column of zeroes. A minimum Hamming distance of eight between all eight rows remains, so a (15, 8) block code using this modified generator matrix should be able to correct as many as three bit errors in eight bits.

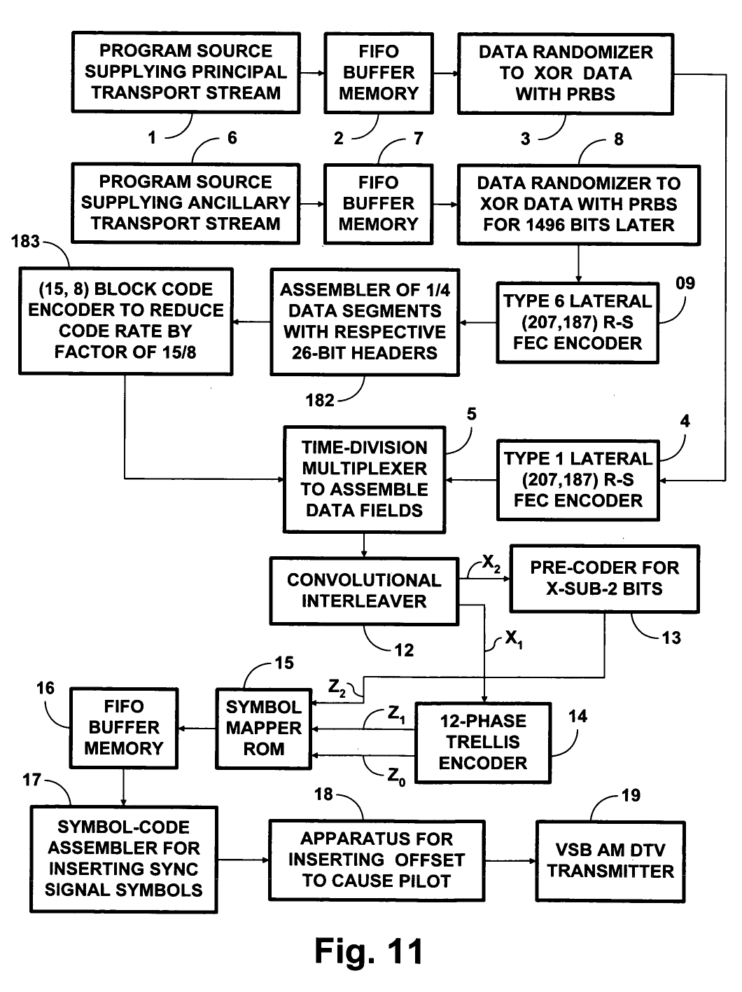

The DTV transmitter in FIG. 10 can be viewed from the standpoint that the binary linear block coding provides for robust transmission with the restriction of 8VSB alphabet providing additional robustness to provide super-robust transmission. In the FIG. 11 transmitter for broadcast DTV signals, the binary linear block coding provides for robust transmission; and the re-sampler 10 and the X₁ bits generator 11 used by the FIG. 10 transmitter to provide for super-robust transmission are dispensed with. The binary block-coded output signal from the encoder 84, as modified by the circuitry 85 as needed, is applied to the time-division multiplexer 5 input port without being re-sampled to still lower code rate. The DTV transmitter of FIG. 11 differs from that of FIG. 10 also in that the data randomizer 81 is replaced by a data randomizer 8, which uses a randomization pattern for a time only 1496 bits (one data packet) later.

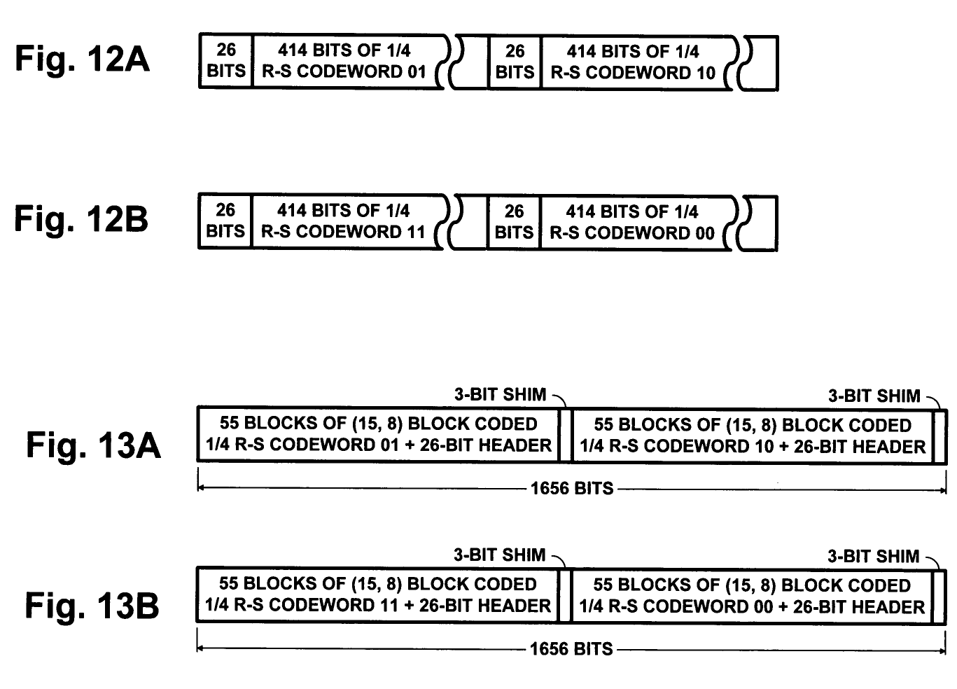

FIGS. 12A and 12B diagram two successive data segments of the bit output from the encoder 183 for (15, 8) binary linear block code that the DTV transmitters of FIGS. 1 and 5 each include. As shown in FIG. 12A, the encoder 183 generates fifty-five 15-bit blocks of (15, 8) binary linear block code in response to the first quarter R-S codeword 01 of four and its 26-bit auxiliary header supplied from the assembler 182. The encoder 183 inserts a 3-bit shim after these fifty-five 15-bit blocks encoding the quarter R-S codeword 01 and its auxiliary header. Then, the encoder 183 generates another fifty-five 15-bit blocks of (15, 8) binary linear block code in response to the second quarter R-S codeword 10 of four and its 26-bit auxiliary header supplied from the assembler 182. The encoder 183 inserts a 3-bit shim after these fifty-five 15-bit blocks encoding the quarter R-S codeword 10 and its auxiliary header. As shown in FIG. 12B, the encoder 183 generates fifty-five 15-bit blocks of (15, 8) binary linear block code in response to the third quarter R-S codeword 11 of four and its 26-bit auxiliary header supplied from the assembler 182. The encoder 183 inserts a 3-bit shim after these fifty-five 15-bit blocks encoding the quarter R-S codeword 11 and its auxiliary header. Then, the encoder 183 generates another fifty-five 15-bit blocks of (15, 8) binary linear block code in response to the fourth quarter R-S codeword 00 of four and its 26-bit auxiliary header supplied from the assembler 182. The encoder 183 inserts a 3-bit shim after these fifty-five 15-bit blocks encoding the quarter R-S codeword 00 and its auxiliary header. The one hundred ten 15-blocks of (15, 8) binary linear block code in each of the data segments shown in FIGS. 12A and 12B contain 1650 bits, six less than the number of bits that when ⅔ trellis coded generate 828 symbols from the 8VSB alphabet. This is the reason six bit of shim are inserted into these data segments. In the FIG. 1 DTV transmitter each two data segments of (15, 8) binary linear block code are re-coded using a restricted symbol alphabet, thereby generating four data segments for super-robust transmission.

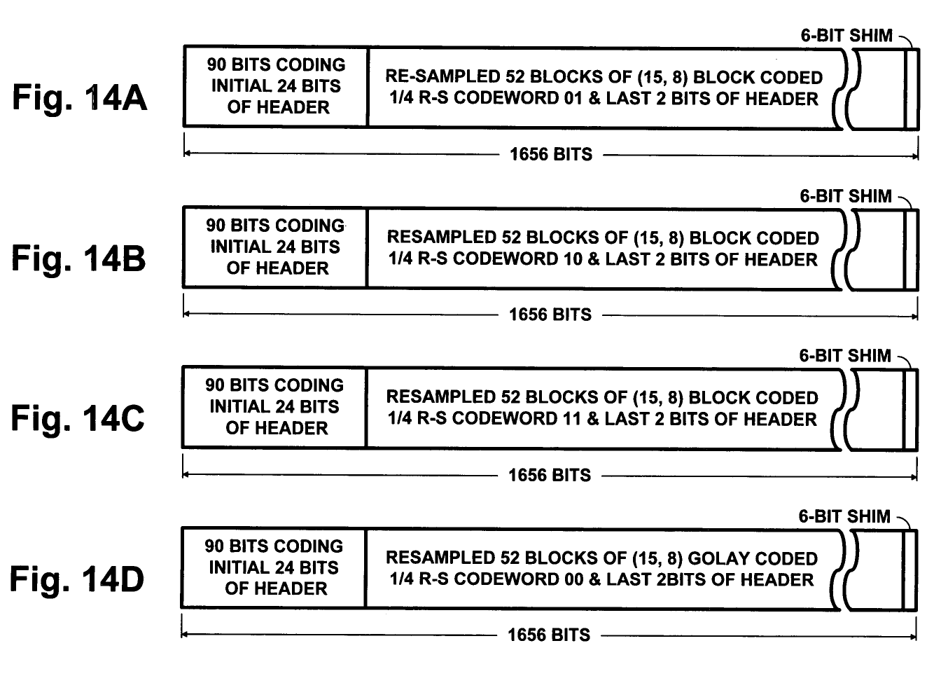

FIGS. 14A, 14B, 14C and 14D show a set of four data segments for super-robust transmission generated by recoding two data segments of (15, 8) binary linear block code so as to use a restricted symbol alphabet. In each of FIGS. 14A, 14B, 14C and 14D a block of (15, 8) binary linear block code corresponding to the initial twenty-four bits of a 26-bit auxiliary header is re-coded to generate the initial 45 bits of a data segment prepared for subsequent super-robust transmission. When the P2VSB or the PCPM restricted alphabet is used, the first sixteen bits of each of these 26-bit auxiliary headers are chosen such that the fourth through sixteenth bits of these 45 bits of (15, 8) binary linear block code constitute a particular packet identifier (PID) sequence. If possible, this PID sequence should be such as to cause legacy DTV receivers to discard the data segments shown in FIGS. 14A, 14B, 14C and 14D.

The FIG. 15 DTV transmitter differs from the FIG. 1 DTV transmitter in that the assembler 82 and the encoder 83 for (23, 12) binary Golay code are replaced by the encoder 84 for a linear block code that halves code rate. The encoder 83 is followed by circuitry 85 to modify the resulting data segments as needed, so that legacy DTV receivers will disregard them. A linear block code that halves code rate is not well adapted to the insertion of an auxiliary header into each data segment of the code which auxiliary header will condition legacy DTV receivers to disregard that data segment. Instead, each data segment of linear block code is made to differ from a (207, 187) R-S FEC codeword capable of correction, so legacy DTV receivers will disregard that data segment.

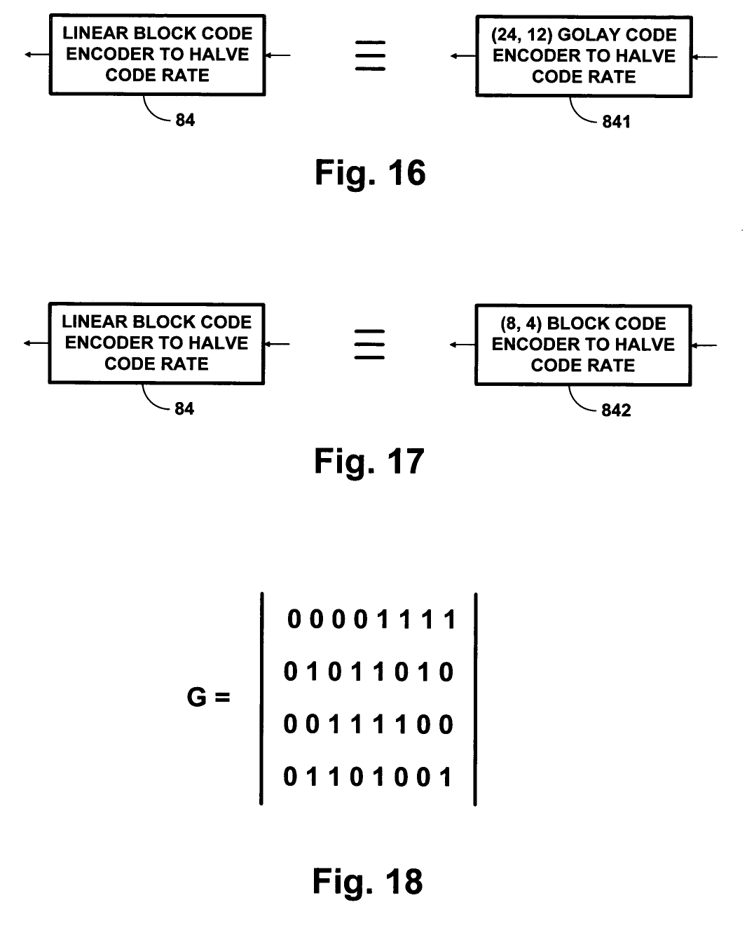

FIG. 16 shows an encoder 841 for (24, 12) binary extended Golay code, which encoder 841 is identical to the encoder 84 for a linear block code in one embodiment of the FIG. 15 DTV transmitter. The (24, 12) binary extended Golay code is just one example of a linear block code that halves code rate. The (24, 12) binary extended Golay code that codes twelve bits is not as well suited to locating erroneous 8-bit bytes in (207, 187) R-S FEC codewords as a linear block code that codes eight bits or four bits is.

FIG. 17 shows an encoder 842 for (8, 4) binary linear block code, which encoder 842 is identical to the encoder 84 for a linear block code in another embodiment of the FIG. 15 DTV transmitter. FIG. 18 shows one possible generator matrix G for the (8, 4) binary linear block code that the encoder 842 generates. The rows, which were selected from an 8-by-8 Hadamard matrix, are each separated from all the others by Hamming distances of four. So, the (8, 4) binary linear block code can correct only one bit error in eight.

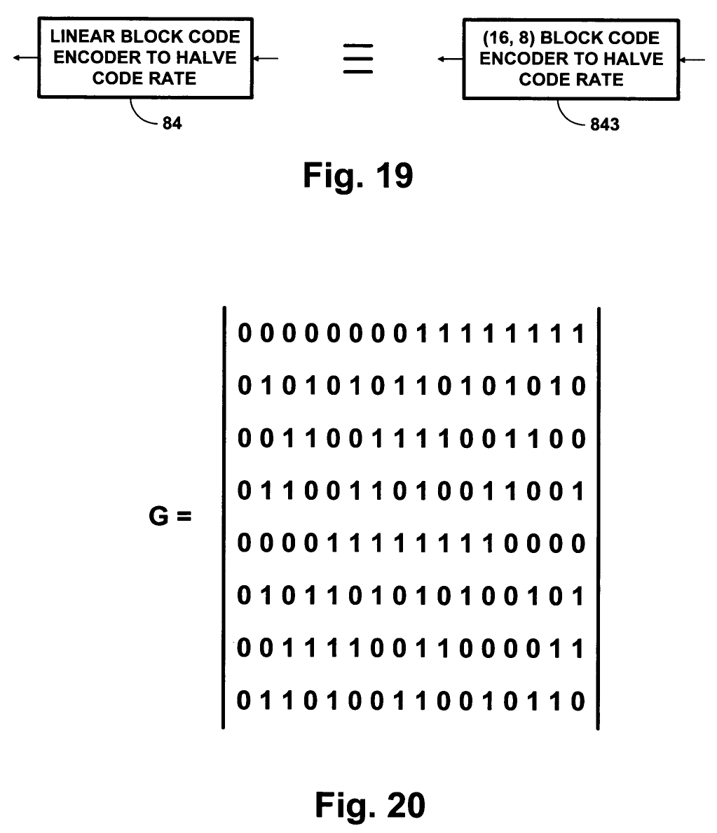

FIG. 19 shows an encoder 843 for (16, 8) binary linear block code, which encoder 842 is identical the encoder 84 for a linear block code in still another embodiment of the FIG. 15 DTV transmitter. FIG. 20 shows one possible generator matrix G for the (16, 8) binary linear block code that the encoder 843 generates. The rows, which were selected from a 16-by-16 Hadamard matrix, are each separated from all the others by Hamming distances of eight. So, the (16, 8) binary linear block code can correct three bit errors in sixteen.

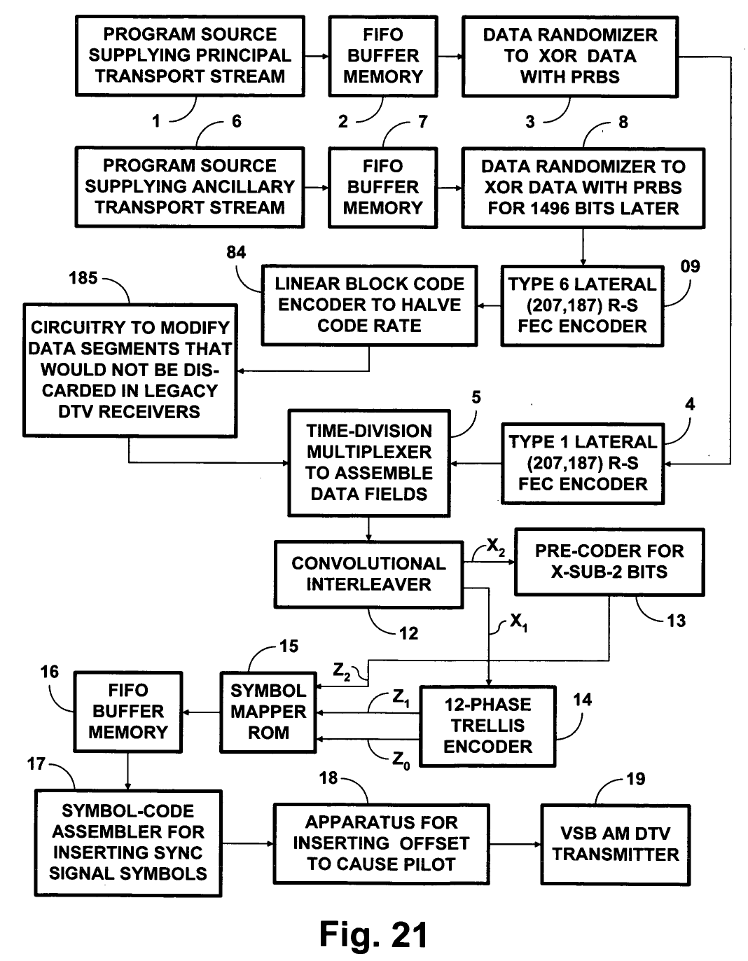

The DTV transmitter in FIG. 15 can be viewed from the standpoint that the binary linear block coding provides for robust transmission with the restriction of 8VSB alphabet providing additional robustness to provide super-robust transmission. In the FIG. 21 transmitter for broadcast DTV signals, the binary linear block coding provides for robust transmission; and the re-sampler 10 and the X₁ bits generator 11 used by the FIG. 15 transmitter to provide for super-robust transmission are dispensed with. The binary block-coded output signal from the encoder 84, as modified by the circuitry 85 as needed, is applied to the time-division multiplexer 5 input port without being re-sampled to still lower code rate. The DTV transmitter of FIG. 21 differs from that of FIG. 15 also in that the data randomizer 81 is replaced by a data randomizer 8, which uses a randomization pattern for a time only 1496 bits (one data packet) later.

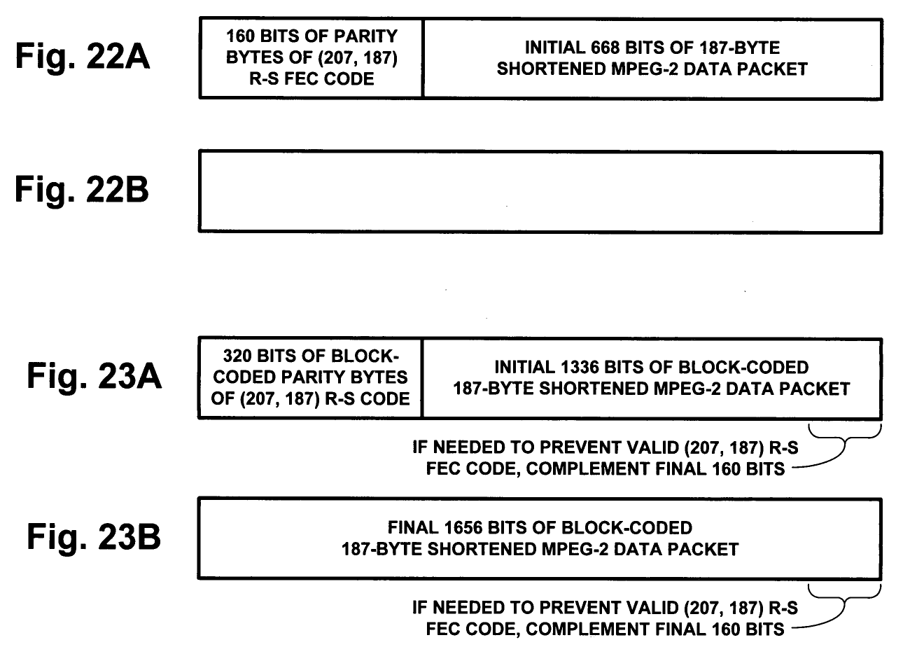

FIGS. 22A and 22B show halves of a (207, 187) R-S FEC codeword that the lateral (207, 187) R-S FEC encoder 09 supplies to be processed for robust or super-robust transmission. The encoder 09 is included both in the FIG. 15 DTV transmitter and in the FIG. 21 DTV transmitter. The encoder 09 positions the twenty parity-check bytes in each (207, 187) Reed-Solomon forward-error-correction codeword supplied to the encoder 84 for binary linear block code so that the twenty parity-check bytes occur before the 187 bytes of a shortened MPEG-2 data packet that complete the codeword.

FIGS. 23A and 23B show the two data segments that the encoder 84 for binary linear block code generates responsive to the respective halves of the (207, 187) R-S FEC codeword shown in FIGS. 22A and 22B. A legacy DTV receiver will recover the two data segments from robust data transmissions by the FIG. 21 DTV transmitter. Coincidentally, either or both of the two data segments might appear to the legacy DTV receiver to be a (207, 187) R-S FEC code, which then would be erroneously processed rather than being disregarded as containing uncorrected byte error. In the FIG. 21 DTV transmitter the circuitry 185 modifies any data segment of block-coded super-robust data that would otherwise not be disregarded by legacy DTV receivers, however. As FIGS. 23A and 23B show, the circuitry 185 modifies such a data segment by complementing the final one hundred sixty bits thereof, for example. Besides circuitry for complementing the final one hundred sixty bits of certain data segments supplied to the time-division multiplexer 5, the circuitry 185 in the FIG. 13 DTV transmitter typically includes a (207, 187) R-S FEC decoder. The decoder checks whether the block encoder 84 generates a (207, 187) R-S FEC codeword that is correct or correctable.

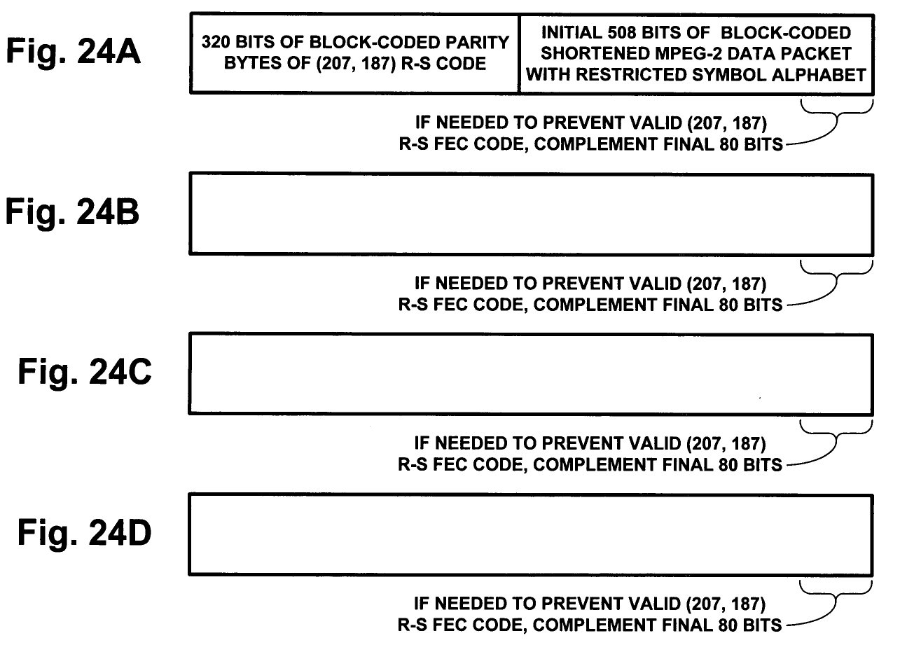

FIGS. 24A, 24B, 24C and 24D show respective ones of the four halves of the two data segments that the block encoder 84 in the FIG. 15 DTV transmitter generates responsive to the respective halves of an original (207, 187) R-S FEC codeword. Complementing the final eighty bits of any of these half data segments will modify the final twenty bytes of the full data segment generated by re-sampling that half data segment for super-robust transmission and consequently again halving code rate.

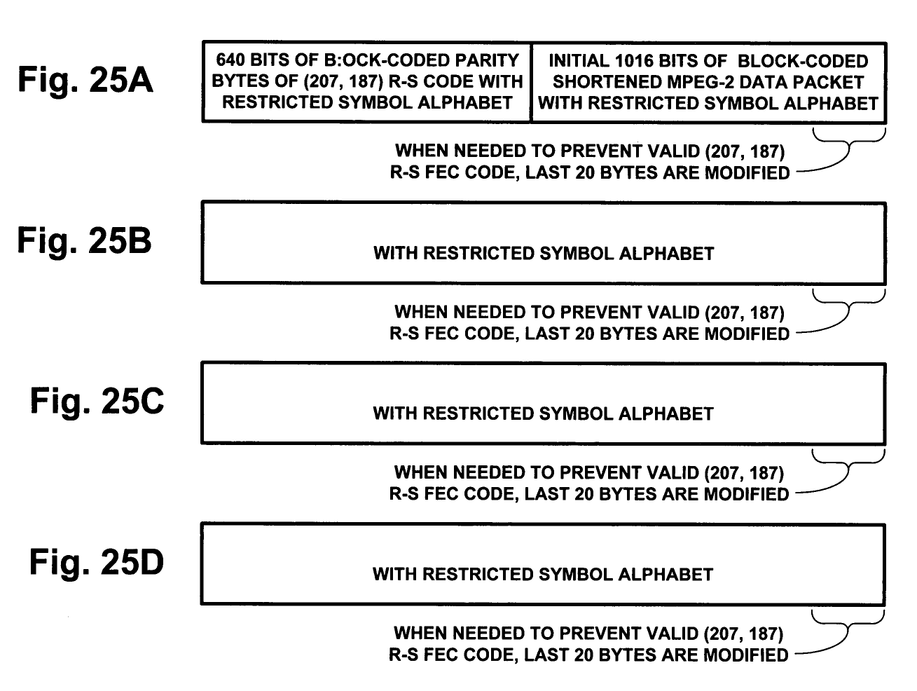

FIGS. 25A, 25B, 25C and 25D show the four full data segments generated by re-sampling the half data segments of FIGS. 24A, 24B, 24C and 24D for super-robust transmission. Any one of the four data segments may coincidentally appear to be a (207, 187) R-S FEC code that is correct or correctable, which would be erroneously processed when recovered by a legacy DTV receiver. The FIG. 15 DTV transmitter includes circuitry 85 to modify any data segment that otherwise would not be discarded in legacy DTV receivers, however. This modification is made by altering the half data segment that the block encoder 84 generates if when re-sampled the half data segment would generate a full data segment that coincidentally appears to be a (207, 187) R-S FEC code that is correct or correctable. For example, a portion of the circuitry 85 in the FIG. 15 DTV transmitter selectively complements the final eighty bits of the half data segment. Typically, the circuitry 85 includes an internal re-sampler and a (207, 187) R-S FEC decoder to check whether or not that re-sampler generates a (207, 187) R-S FEC codeword that is correct or correctable.

Acquaintance with the foregoing description will empower persons of ordinary skill in the art of digital design to design alternative ways of modifying data segments intended for robust or supper-robust transmission so that they will not appear to be a (207, 187) R-S FEC codeword that is correct or correctable. This should be taken into account when considering the scope of this aspect of the invention.

The FIG. 26 DTV transmitter time-division multiplexes ordinary 8VSB transmissions with robust data transmissions that employ a restricted symbol alphabet to halve code rate. There is no linear block encoding of the (207, 187) R-S FEC codewords from the (207, 187) R-S FEC encoder 09 to reduce code rate further. The FIG. 26 DTV transmitter differs from the FIG. 15 DTV transmitter in that the (207, 187) R-S FEC encoder 09 is connected to supply the (207, 187) R-S FEC codewords directly to the circuitry 85 to modify data segments so legacy receivers will discard them.

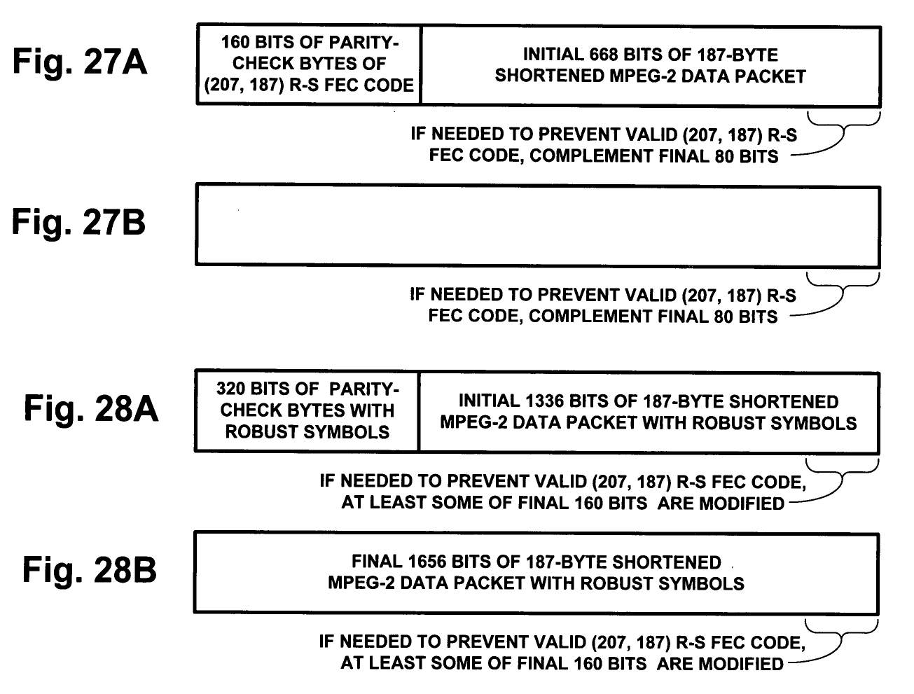

FIGS. 27A and 27B show halves of a (207, 187) R-S FEC codeword that the lateral (207, 187) R-S FEC encoder 09 supplies to the circuitry 85 in the FIG. 26 DTV transmitter. The encoder 09 positions the twenty parity-check bytes in each (207, 187) R-S FEC codeword supplied to the encoder 84 for binary linear block code so that the twenty parity-check bytes occur before the 187 bytes of a shortened MPEG-2 data packet that complete the codeword. Complementing the final eighty bits of either of these half (207-187) R-S FEC codewords will modify the final twenty bytes of the full data segment generated by re-sampling that half (207, 187) R-S FEC codeword for robust transmission at halved code rate. Such modification is made if the full data segment would appear to a legacy DTV receiver to be a (207, 187) R-S FEC codeword that does not contain uncorrectable byte error.

FIGS. 28A and 28B show the two data segments that the re-sampler 10 generates responsive to the respective halves of the (207, 187) R-S FEC codeword shown in FIGS. 27A and 27B. If the re-sampler 10 generates P2VSB symbol code, the circuitry 85 complementing the final eighty bits of a half (207, 187) R-S FEC codeword shown in FIG. 27A or 27B will cause the final 160 bits of the corresponding data segment shown in FIG. 28A or 28B to be complemented. If the re-sampler 10 generates PCPM symbol code, the circuitry 85 complementing the final eighty bits of a half (207, 187) R-S FEC codeword shown in FIG. 27A or 27B will cause odd alternate ones of final 160 bits of the corresponding data segment shown in FIG. 28A or 28B to be complemented.

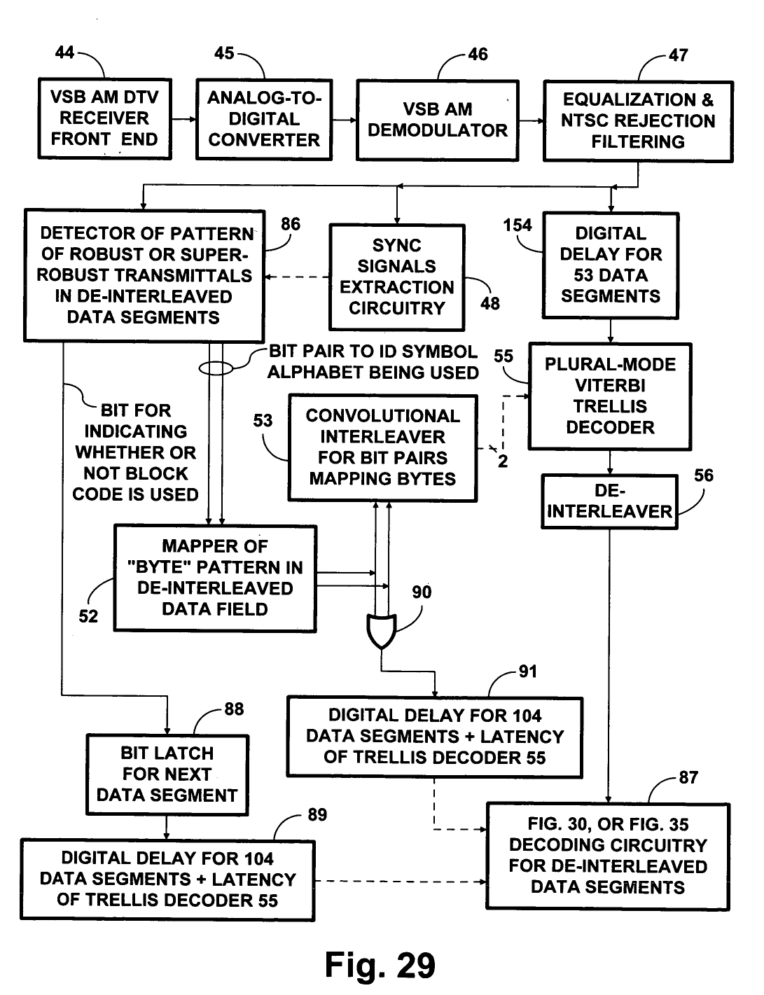

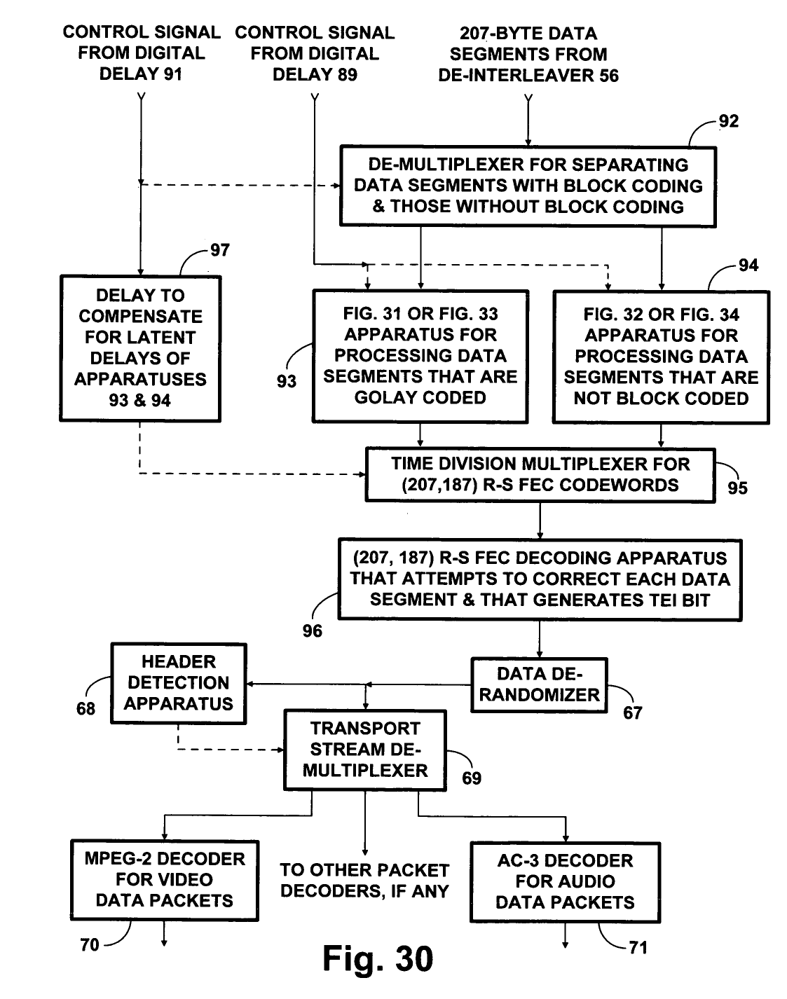

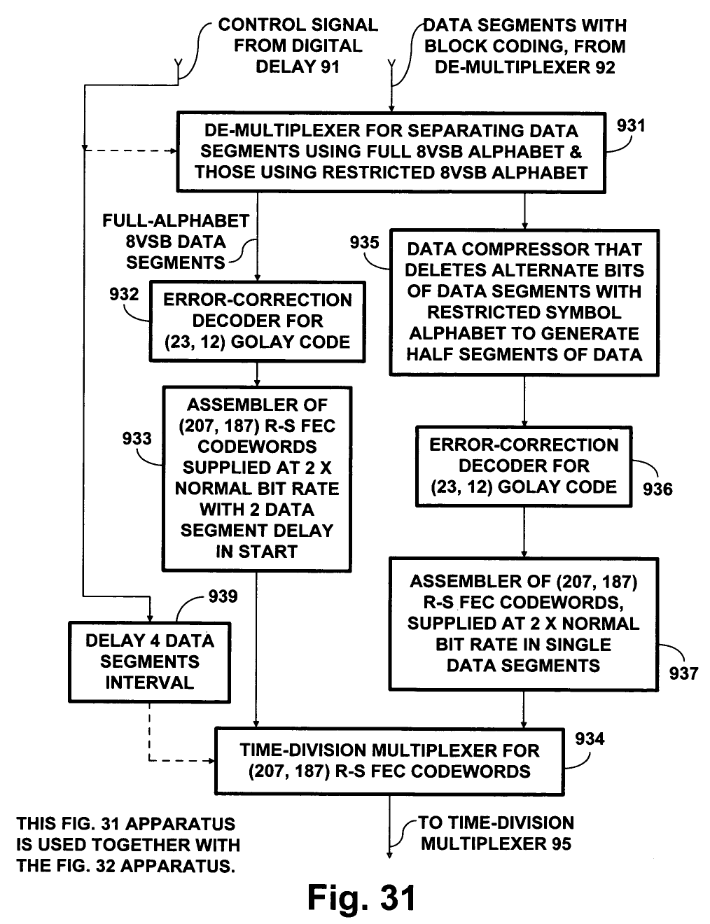

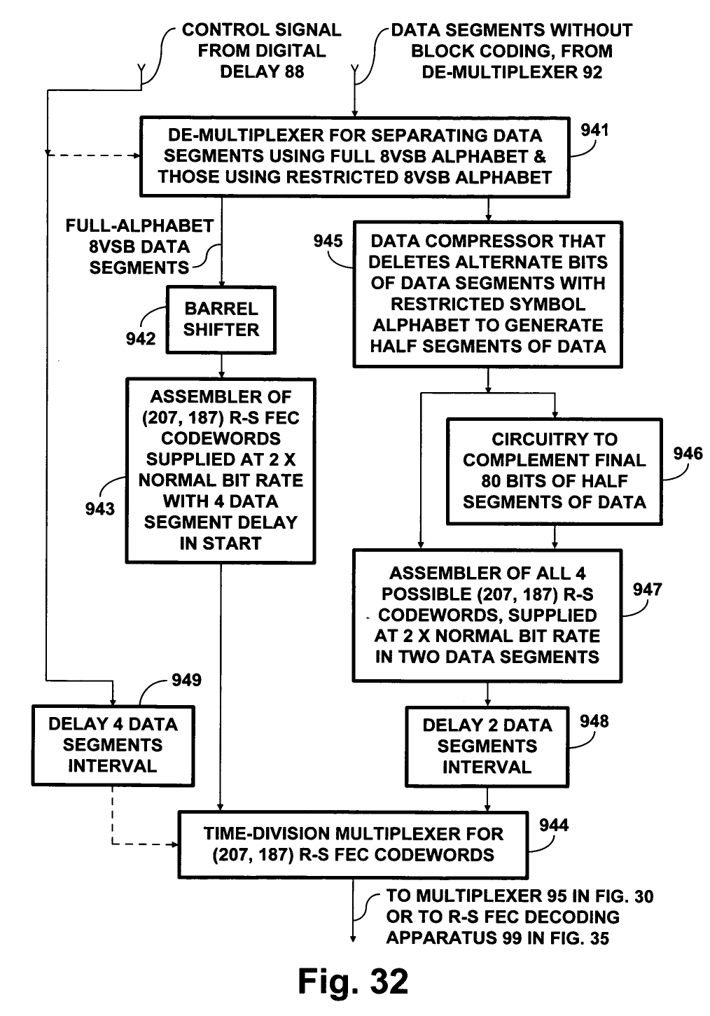

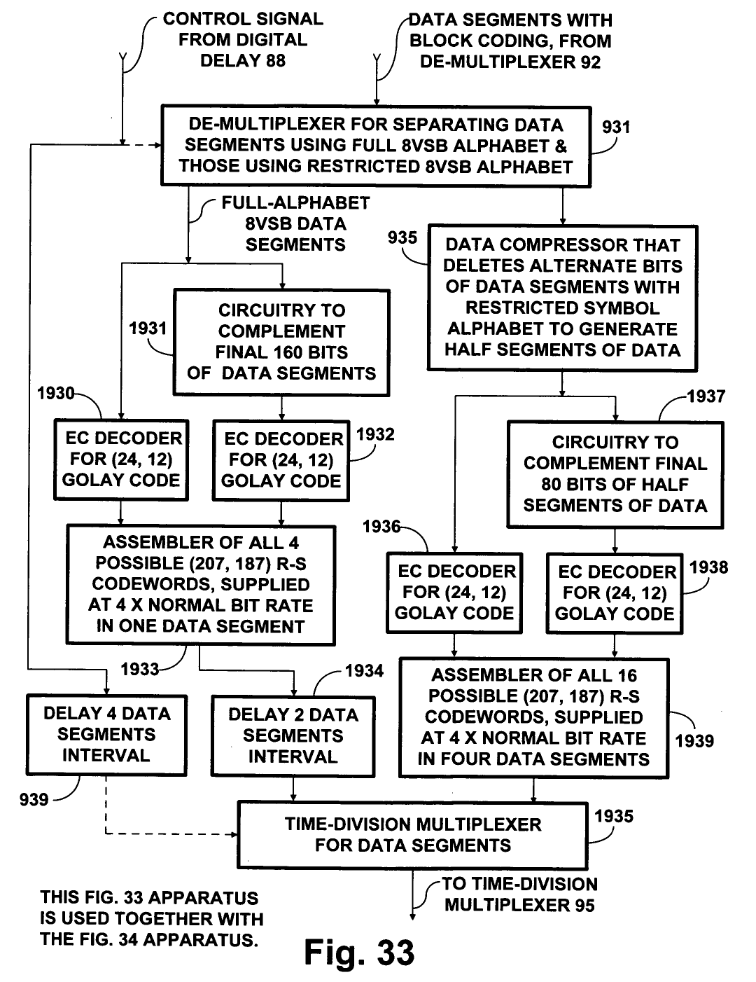

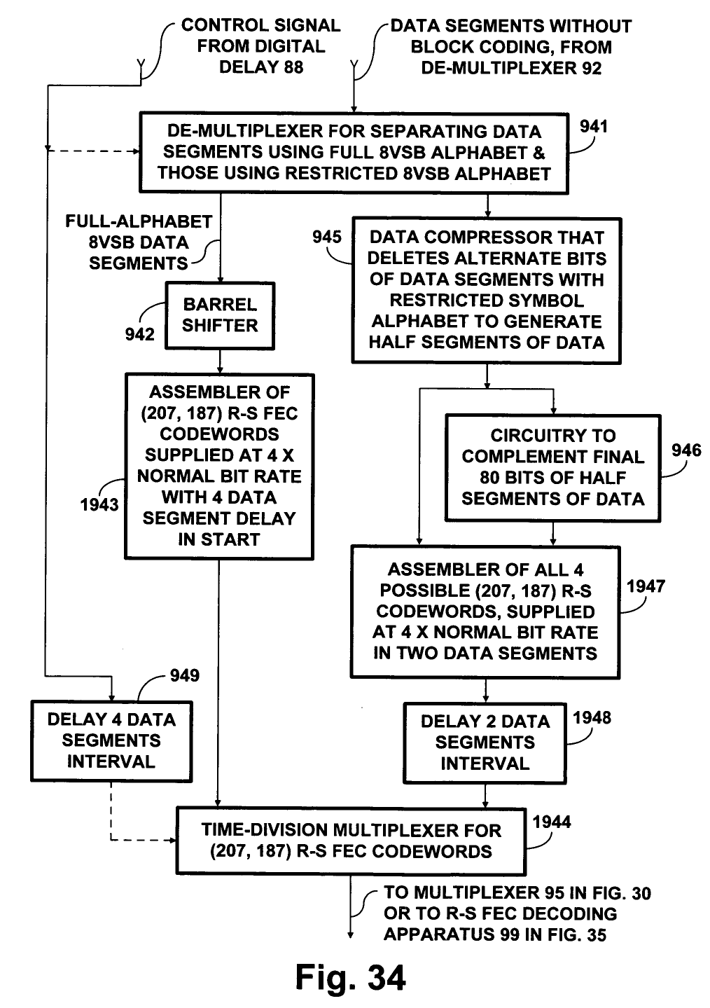

FIGS. 29 and 30 combine to form the schematic diagram of a DTV receiver capable of receiving DTV signals using (23, 12) binary Golay coding or capable of receiving DTV signals using (24, 12) binary extended Golay coding. The FIG. 29 portion of the DTV receiver includes a vestigial-sideband amplitude-modulation (VSB AM) DTV receiver front-end 44 for selecting a radio-frequency DTV signal for reception, converting the selected RF DTV signal to an intermediate-frequency DTV signal, and for amplifying the IF DTV signal. An analog-to-digital converter 45 is connected for digitizing the amplified IF DTV signal supplied from the DTV receiver front-end 44. A demodulator 46 is connected for demodulating the digitized VSB AM IF DTV signal to generate a digitized baseband DTV signal, which is supplied to digital filtering 47 for equalization of channel response and for rejection of co-channel interfering NTSC signal. Synchronization signals extraction circuitry 48 is connected for receiving the digital filtering 47 response. Responsive to data-field-synchronization (DFS) signals, the sync signals extraction circuitry 48 detects the beginnings of data frames and fields. Responsive to data-segment-synchronization (DSS) signals, the sync signals extraction circuitry 48 detects the beginnings of data segments. The DTV receiver front-end 44, the analog-to-digital converter 45, the demodulator 46, the digital filtering 47 and the sync signals extraction circuitry 48 correspond to the similarly numbered elements in the portion of a DTV receiver shown in FIG. 9A of U.S. patent application Ser. No. 10/955,212.

A DTV receiver that is adapted for usefully receiving ordinary-transmission, robust-transmission and super-robust transmission components of an 8VSB DTV broadcast signal has to have knowledge of when each of these components is being received. This knowledge permits symbol decoding of the restricted-alphabet components to be done in special way that improves the accuracy of symbol decoding decisions. The general procedure in the prior art is for the DTV transmitter to transmit information to the DTV receiver concerning the pattern of data segments recovered from robust-transmission and super-robust transmission components of the 8VSB DTV broadcast signal, which pattern obtained in each data field before its having been convolutionally interleaved and trellis coded. This information is transmitted in the reserved portion of the initial data segments of data fields, various coding schemes for such information being known. U.S. Pat. No. 6,563,436 titled “KERDOCK CODING AND DECODING SYSTEM FOR MAP DATA” and issued 13 May 2003 to M. Fimoff, R. W. Citta and J. Xia describes one way of doing this, for example.

FIG. 9A of U.S. patent application Ser. No. 10/955,212 shows circuitry for analyzing the symbol alphabet used in various portions of the reproduced baseband DTV signal. This circuitry includes a hard-decision decoder 49 for 8VSB symbols, a de-interleaver 50, and circuitry 51 to decide the symbol alphabet used in each data segment. In FIG. 29 illustrating this specification, these elements are replaced by a transmission-pattern detector 86 that responds to coding transmitted in the reserved portions of the initial data segments of data fields and detects therefrom the pattern of robust and super-robust transmittal in fields of de-interleaved data segments. The sync signals extraction circuitry 48 supplies the transmission-pattern detector 86 control signals indicating when coding descriptive of the pattern or robust and super-robust segments is expected to be received. In an exemplary design the sync signals extraction circuitry 48 includes a counter for counting at buad rate the number of symbols in one or more data frames, which counter is periodically reset responsive to data field synchronization signals. Whenever a range detector determines the count to be within the range in which coding descriptive of the pattern of robust transmissions is expected to be received, the range detector supplies the transmission-pattern detector 86 a control signal indicative of this determination. The transmission-pattern detector 86 determines the symbol alphabet used in each de-interleaved data segment. The transmission-pattern detector 86 also determines for each de-interleaved data segment whether or not that data segment employs binary linear block coding.

Assuming that two or three restricted alphabets are used besides the full 8VSB alphabet, the determinations that the transmission-pattern detector 86 makes concerning the symbol alphabet used in each data segment are expressed as bit pairs. E.g., 00 indicates full 8VSB alphabet; 01 indicates pseudo-2VSB; 10 indicates E-4VSB; 11 indicates a restricted alphabet that selects between two groups of possible symbols. The first group of possible symbols consists of symbols with −7, −5, +1 and +3 normalized modulation levels. The second group of possible symbols consists of symbols with −3, −1, +5 and +7 normalized modulation levels. The transmission-pattern detector 86 supplies the bit pairs coding the symbol alphabet used in each data segment to a mapper 52 of the byte pattern in the de-interleaved data field. The mapper 52 extends each bit pair decision by repeating it 206 times, to map the 207 bytes of a data segment as a line of bit pair decisions. A convolutional interleaver 53 generates the pattern of bit pair decisions mapping byte characteristics in the interleaved data field of the baseband DTV signal supplied as response from the digital filtering 47 for equalization of channel response and for rejection of co-channel interfering NTSC signal.

Digital delay circuitry 154 delays the digital filtering 47 response by 53 or so data segments to temporally align it with the bit pairs from the convolutional interleaver 53 that describe symbol usage in the interleaved data field. A plural-mode 12-phase trellis decoder 55 of Viterbi type is connected for receiving the digital filtering 47 response as delayed by the digital delay circuitry 154. When the bit pair decisions from the convolutional interleaver 53 indicate restricted-alphabet symbols are currently being supplied to the plural-mode trellis decoder 55, the decision tree in the trellis decoding is selectively pruned. This pruning excludes decisions that currently received symbols have normalized modulation levels that are excluded from the restricted alphabet of 8VSB symbols currently in use. The trellis decoder 55 is connected to supply bytes of data to a de-interleaver 56 that complements the convolutional interleaver 12 in the DTV transmitter. The mapper 52, the convolution interleaver 53, the trellis decoder 55 and the de-interleaver 56 corresponds to the similarly numbered elements in the portion of a DTV receiver shown in FIG. 9A of U.S. patent application Ser. No 10/955,212.

More particularly, circuitry similar to that shown in FIG. 2 is associated with the plural-mode 12-phase trellis decoder 55 of Viterbi type. This circuitry provides the trellis decoder 55 information concerning which symbols are precluded at which locations in the data field when the convolutional interleaver 53 supplies the trellis decoder 55 the bit pair 11 as a control signal. The bit pair 11 indicates that the symbols the trellis decoder 55 is receiving are from a restricted alphabet that selects between two groups of possible symbols. Symbols transmitted at −3, −1, +5 and +7 normalized modulation levels are precluded from locations in the data field reserved for the first group of possible symbols. Symbols transmitted at −7, −5, +1 and +3 normalized modulation levels are precluded from locations in the data field reserved for the second group of possible symbols. The ranges of decision in the plural-mode 12-phase trellis decoder 55 are adjusted to accommodate the decision tree being pruned in a time-dependent way as locations in the data field are scanned.

When the convolution interleaver 53 supplies the bit pair 00 as a control signal indicating to the plural-model 12-phase trellis decoder 55 that the symbols it currently receives are from ordinary 8VSB transmission, the ranges of decision in the trellis decoder 55 are the conventional ones for receiving A/53 DTV broadcasts. The decision tree in the plural-mode 12-phase trellis decoder 55 is not pruned. When the convolutional interleaver 53 supplies the bit pair 01 as a control signal indicating to the trellis decoder 55 that the symbols it currently receives are from pseudo-2 VSB transmission, the ranges of decision are adjusted to preclude −3, −1, +1 and +3 symbol decisions. The decision tree is pruned accordingly in the trellis decoder 55. When the convolutional interleaver 53 supplies the bit pair 10 as a control signal indicating to the trellis decoder 55 that the symbols it currently receives are from E-4VSB transmission, the ranges of decision are adjusted so as to preclude −7, −1, +3 and +5 symbol decisions. The decision tree is pruned accordingly in the trellis decoder 55. When the convolutional interleaver 53 supplies the bit pair 11 as a control signal indicating to the trellis decoder 55 that the symbols it currently receives are from a transmission using prescribed-coset-pattern modulation, the ranges of decision are adjusted to suit on a symbol-by-symbol basis. The decision tree is pruned accordingly in the trellis decoder 55.

FIG. 29 shows the de-interleaver 56 connected for supplying the data segments of successive fields of de-interleaved data to decoding circuitry 87 for data in the de-interleaved data segments. Output signals from the transmission-pattern detector 86 for detecting the pattern of robust and super-robust transmittal in fields of de-interleaved data segments are processed to generate control signals for the circuitry 87. An OR gate 88 is connected to respond to the bit pairs supplied from the transmission-pattern detector 86 that identify the symbol alphabet currently in use. Presuming that a 00 bit pair indicates full 8VSB alphabet, the OR gate 88 response is a logic ZERO when a data segment uses the full 8VSB symbol alphabet and is a logic ONE when a data segment uses a restricted symbol alphabet. Digital delay circuitry 89 delays the OR gate 88 response for providing the decoding circuitry 87 its first control signal. The transmission-pattern detector 86 supplies a bit latch 90 a bit indicating whether or not binary linear block coding is used in a data segment. The bit latch 90 responds to supply the bit throughout the duration of the next data segment. Digital delay circuitry 91 is connected for delaying the latched bit to provide the decoding circuitry 87 its second control signal. The digital delay circuits 91 and 89 provide delays somewhat longer than the duration of 104 data segments, compensating also for latency in the trellis decoder 55.

FIG. 30 shows in more detail representative decoding circuitry 87 used in a DTV receiver designed to receive DTV signals that use (23, 12) Golay coding or (24, 12) extended Golay coding. A de-multiplexer 92 is connected for receiving de-interleaved data segments from the convolutional interleaver 56. Responsive to the second control signal that the digital delay circuitry 91 supplies to the de-multiplexer 92, the de-multiplexer 92 separates those data segments with linear block coding from those data segments without linear block coding. FIG. 30 shows the de-multiplexer 92 connected so as to select those data segments with linear block coding to apparatus 93 for processing data segments that are Golay coded. FIG. 30 shows the de-multiplexer 92 further connected so as to select those data segments without linear block coding to apparatus 94 for processing data segments that are not block coded. A time-division multiplexer 95 is connected for time-division multiplexing together for application to a (207, 187) Reed-Solomon forward-error-correction decoding apparatus 96 those (207, 187) R-S FEC codewords respectively recovered by the apparatuses 93 and 94. The multiplexer 95 performs this time-division multiplexing responsive to the first control signal as supplied with delay from digital delay circuitry 89 and with further delay from digital delay circuitry 97. The further delay from digital delay circuitry 97 compensates for similar latent delay in each of the apparatuses 93 and 94. The (207, 187) R-S FEC decoding apparatus 96 corrects insofar as possible byte errors in each of the 207-byte data segments supplied by the time-division multiplexer 95 and toggles the Transport Error Indicator (TEI) bit in each data packet in those segments in which byte errors remain uncorrected. Presuming that the (207, 187) R-S FEC decoding apparatus 96 uses a conventional Reed-Solomon decoding algorithm that locates erroneous bytes, the apparatus 96 is capable of correcting up to ten erroneous bytes per (207, 187) R-S FEC codeword.

A data de-randomizer 67 is connected for receiving, as a 187-byte packet of randomized data, the portion of each data segment supplied by the lateral (207, 187) R-S FEC decoding apparatus 96 other than its twenty R-S FEC code parity-check bytes. Preferably, the (207, 187) R-S FEC decoding apparatus 96 is designed to supply the 187-byte data packets timed so as to keep the design of the data de-randomizer 67 simple. The data de-randomizer 67 is connected for supplying de-randomized data packets to header detection apparatus 68 and to a transport stream de-multiplexer 69. The data de-randomizer 67 response to each of the 187-byte packets of randomized data is a respective MPEG-2 data packet sans its initial byte of packet synchronization code. The transport stream de-multiplexer 69 responds to the header detection apparatus 68 detecting selected PIDs in certain types of the de-randomized data packets from the data de-randomizer 67 for sorting those types of de-randomized data packets to appropriate packet decoders. For example, video data packets are sorted to an MPEG-2 decoder 70. The MPEG-2 decoder 70 responds to the TEI bit in a data packet indicating that it still contains byte errors by not using the packet and instituting measures to mask the effects of the packet not being used. By way of further example, audio data packets are sorted to an AC-3 decoder 71.

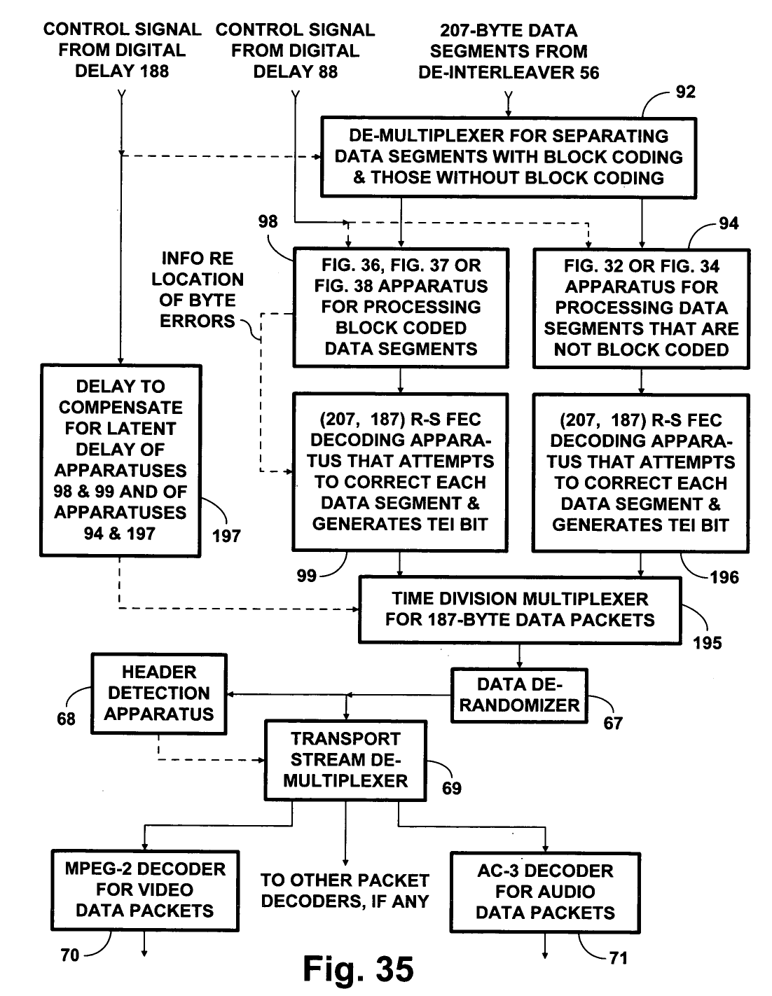

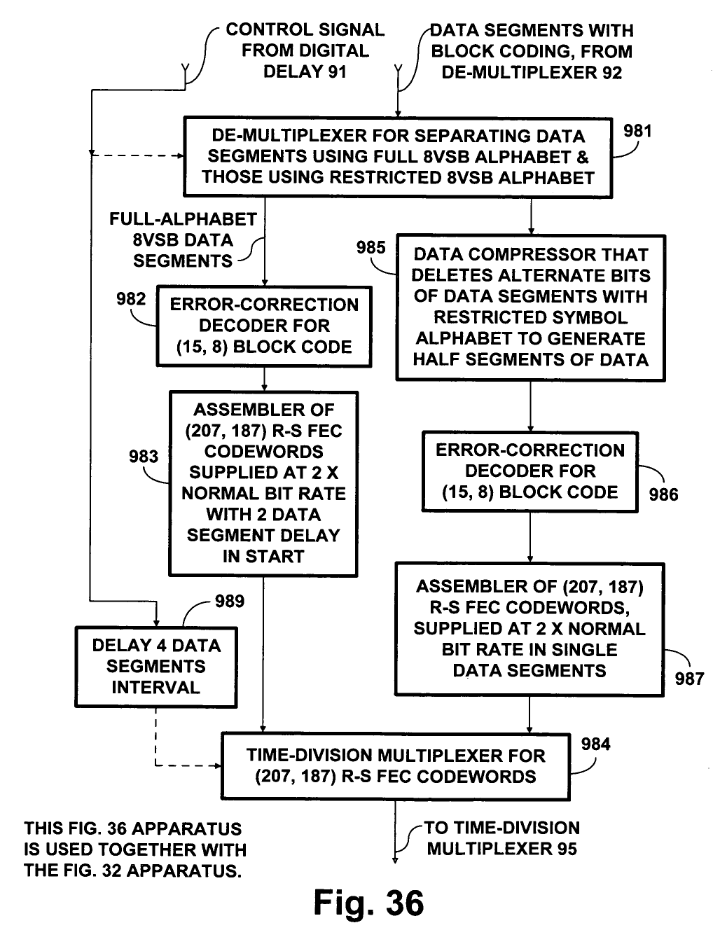

FIGS. 31 and 32 show in more detail one possible construction of the apparatus 93 for processing data segments that are Golay coded and one possible construction of the apparatus 94 for processing data segments that are not block coded. These possible constructions are suitable for a DTV receiver designed for receiving DTV signals that employ (23, 12) binary Golay coding.

The FIG. 31 apparatus 93 for processing data segments that are Golay coded includes a de-multiplexer 931 connected for receiving from the de-multiplexer 92 those de-interleaved data segments with block coding. Responsive to the second control signal supplied to the de-multiplexer 931 from the digital delay circuitry 89, the de-multiplexer 931 separates those block-coded data segments employing the full alphabet of 8VSB symbols from those block-coded data segments employing a restricted symbol alphabet.

FIG. 31 shows the de-multiplexer 931 connected so as to select those block-coded data segments employing the full alphabet of 8VSB symbols to an error-correction decoder 932 for (23, 12) binary Golay code. The error-correction decoder 932 is operable for recovering half a (207, 187) R-S FEC codeword each data segment interval. The half (207, 187) R-S FEC codewords that the error-correction decoder 932 supplies are unaccompanied by any response to the auxiliary header and the shim data that are included in each data segment of (23, 12) binary Golay code supplied to the decoder 932. The error-correction decoder 932 is connected for supplying the recovered half (207, 187) R-S FEC codewords to an assembler 933 of (207, 187) R-S FEC codewords. The codeword assembler 933 includes first-in, first-out memory for temporarily storing (207, 187) R-S FEC codewords. This FIFO memory is read from to supply a temporarily stored (207, 187) R-S FEC codeword at twice normal bit rate within the initial (or the final) half of a single data segment. The single data segment occurs two data segment intervals later than the first data segment containing the (207, 187) R-S FEC codeword in (23, 12) binary Golay code entered the error-correction decoder 932. The codeword assembler 933 is connected for supplying (207, 187) R-S FEC codewords to one input port of a time-division multiplexer for 934 for (207, 187) R-S FEC codewords. The time-division multiplexer 934 has another input port connected for receiving (207, 187) R-S FEC codewords recovered from the block-coded data segments employing a restricted symbol alphabet.

FIG. 31 shows the de-multiplexer 931 further connected so as to select those block-coded data segments employing a restricted symbol alphabet to a data compressor 935 that deletes alternate bits of data, generating a respective half data segment of block code from each complete data segment it receives. The data compressor 935 is connected to supplying the remaining bits of data to an error-correction decoder 936 for (23, 12) binary Golay code. The error-correction decoder 936 decodes each half data segment of (23, 12) binary Golay code it receives to generate a respective quarter of a (207, 187) R-S FEC codeword. A codeword assembler 937 is connected for receiving groups of four successive quarters of a (207, 187) R-S FEC codeword and is operable for assembling each such group into a respective complete (207, 187) R-S FEC codeword. The codeword assembler 937 includes first-in, first-out memory for temporarily storing successive quarters of (207, 187) R-S FEC codewords. This FIFO memory is read from to supply each complete (207, 187) R-S FEC codeword at twice normal bit rate within the initial (or the final) half of a single data segment. The codeword assembler 937 is connected for supplying these complete (207, 187) R-S FEC codewords to the appropriate input port of the time-division multiplexer 934.

Responsive to the second control signal supplied to the de-multiplexer 931 from the digital delay circuitry 89 and further delayed by digital delay circuitry 939, the time-division multiplexer 934 time-division multiplexer together (207, 187) R-S FEC codewords it receives from the codeword assemblers 933 and 937. The output port of the time-division multiplexer 934 is connected for supplying the (207, 187) R-S FEC codewords recovered from data segments that are Golay coded to the appropriate input port of the time-division multiplexer 95 shown in FIG. 30. The time-division multiplexer 95 delivers these (207, 187) R-S FEC codewords to the (207, 187) Reed-Solomon forward-error-correction decoding apparatus 96.

The FIG. 32 apparatus 94 for processing data segments that are not block coded includes a de-multiplexer 941 connected for receiving from the de-multiplexer 92 those de-interleaved data segments without linear block coding. Responsive to the second control signal supplied to the de-multiplexer 941 from the digital delay circuitry 89, the de-multiplexer 941 separates those data segments employing the full alphabet of 8VSB symbols from those data segments employing a restrictive symbol alphabet. FIG. 32 shows the de-multiplexer 941 connected so as to select those data segments employing the full alphabet of 8VSB symbols to a barrel shifter 942. The barrel shifter 942 barrel shifts a complete (207, 187) R-S FEC codeword from ordinary 8VSB transmission so that it twenty parity-check bytes precede the 187 bytes of the shortened MPEG-2 packet. This places the (207, 187) R-S FEC codewords from ordinary 8VSB transmission into the same form as the (207, 187) R-S FEC codewords recovered from robust and super-robust transmissions. Placing all the (207, 187) R-S FEC codewords into the same form facilitates them all being decoded by the same (207, 187) R-S FEC decoding apparatus 96 shown in FIG. 30. (Alternatively, the R-S FEC codewords recovered from robust and super-robust transmissions could be barrel-shifted to the same form as the R-S FEC codewords from ordinary 8VSB transmission.) The barrel shifter 942 is connected for supplying barrel-shifted data segments to an assembler 943 of complete (207, 187) R-S FEC codewords. The codeword assembler 943 includes first-in, first-out memory for temporarily storing (207, 187) R-S FEC codewords. This FIFO memory is read from to supply a temporarily stored (207, 187) R-S FEC codeword at twice normal bit rate within the initial (or the final) half of a single data segment. This single data segment begins four data segment intervals later than the data segment containing the original codeword as supplied to the barrel shifter 942. (Alternatively, the memory included within the codeword assembler 943 for temporarily storing R-S FEC codewords can be modified to accomplish the barrel shifting of those codewords, in which case the barrel shifter 942 is replaced by direction connection.) The codeword assembler 943 is connected for supplying (207, 187) R-S FEC codewords to one input port of a time-division multiplexer 944 for (207, 187) R-S FEC codewords to one input port of a time-division multiplexer 944 for (207, 187) R-S FEC codewords. The time-division multiplexer 944 has another input port connected for receiving (207, 187) R-S FEC codewords recovered from the data segments employing a restricted symbol alphabet, but no block coding.

FIG. 32 shows the de-multiplexer 941 further connected so as to select those block-coded data segments employing a restricted symbol alphabet to a data compressor 945 that deletes alternate bits of data, generating a respective half data segment from each complete data segment it receives. The data compressor 945 is connected for supplying the half data segments to circuitry 946 for complementing the final 80 bits of each of them. Each of the half data segments supplied from the data compressor 945 is possibly half of a (207, 187) R-S FEC codeword. Otherwise, the half data segment is such a half codeword that was modified so that the data segment from which it is extracted would be found by legacy receivers to contain uncorrectable byte error(s). The circuitry 946 complementing the final 80 bits of such a half data segment should regenerate half of a (207, 187) R-S FEC codeword. An assembler 947 is connected for receiving pairs of consecutive half data segments from the data compressor 945 and for receiving pairs of consecutive half data segments from the circuitry 946. The possible-codeword assembler 947 assembles one possible (207, 187) R-S FEC codeword from each pair of consecutive half data segments from the data compressor 945 and another possible (207, 187) R-S FEC codeword from each pair of consecutive half data segments from the circuitry 946. The possible codeword assembler 947 also assembles two further possible (207, 187) R-S FEC codewords, each combining an initial half codeword supplied by one of the components 945 and 946 with a final half codeword supplied by the other of the components 945 and 946. The (207, 187) R-S FEC decoding apparatus 96 will subsequently find only one of these four possible (207, 187), R-S FEC codewords to contain so few or no byte errors that a (207, 187) R-S FEC codeword free from byte error can be generated therefrom.

The assembler 947 supplies the four possible (207, 187) R-S FEC codewords at twice normal bit rate, so they fit into two data segment intervals. This facilitates the time-division multiplexing of these possible (207, 187) R-S FEC codewords with (207, 187) R-S FEC codewords from the codeword assemblers 943, 933 and 943. The possible-codeword assembler 947 supplies the four possible (207, 187) R-S FEC codewords beginning two data segments later than the first half segment giving rise to them entered the data compressor 945. Digital delay circuitry 948 delays each group of four possible (207, 187) R-S FEC codewords an additional two data segments intervals before their application to the appropriate input port of the time-division multiplexer 95. This too facilities the time-division multiplexing of these (207, 187) R-S FEC codewords with those from the codeword assemblers 943, 933 and 937.

Responsive to the second control signal supplied to the de-multiplexer 941 from the digital delay circuitry 89 and further delayed by digital delay circuitry 949, the time-division multiplexer 944 time-division multiplexes together (207, 187) R-S FEC codewords it receives from the codeword assembler 943 and from the possible-codeword assembler 947. The output port of the time-division multiplexer 944 is connected for supplying the (207, 187) R-S FEC codewords recovered from data segments that are not block coded to the appropriate input of the time-division multiplexer 95 shown in FIG. 30. The time-division multiplexer 95 delivers these (207, 187) R-S FEC codewords to the (207, 187) R-S decoding apparatus 96.

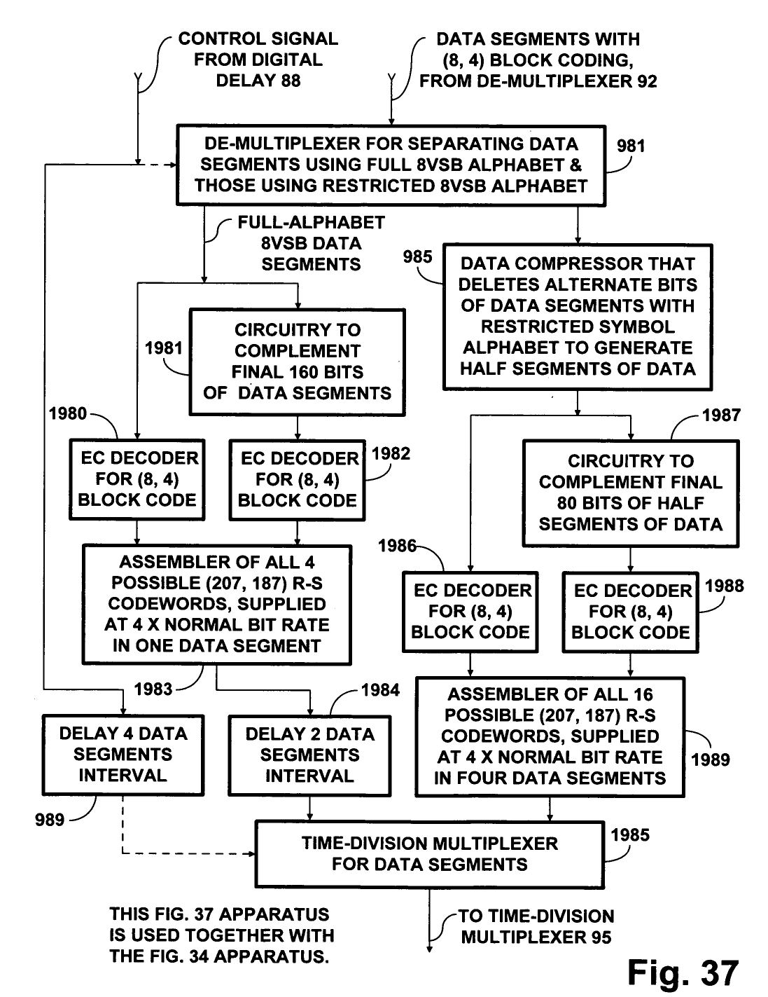

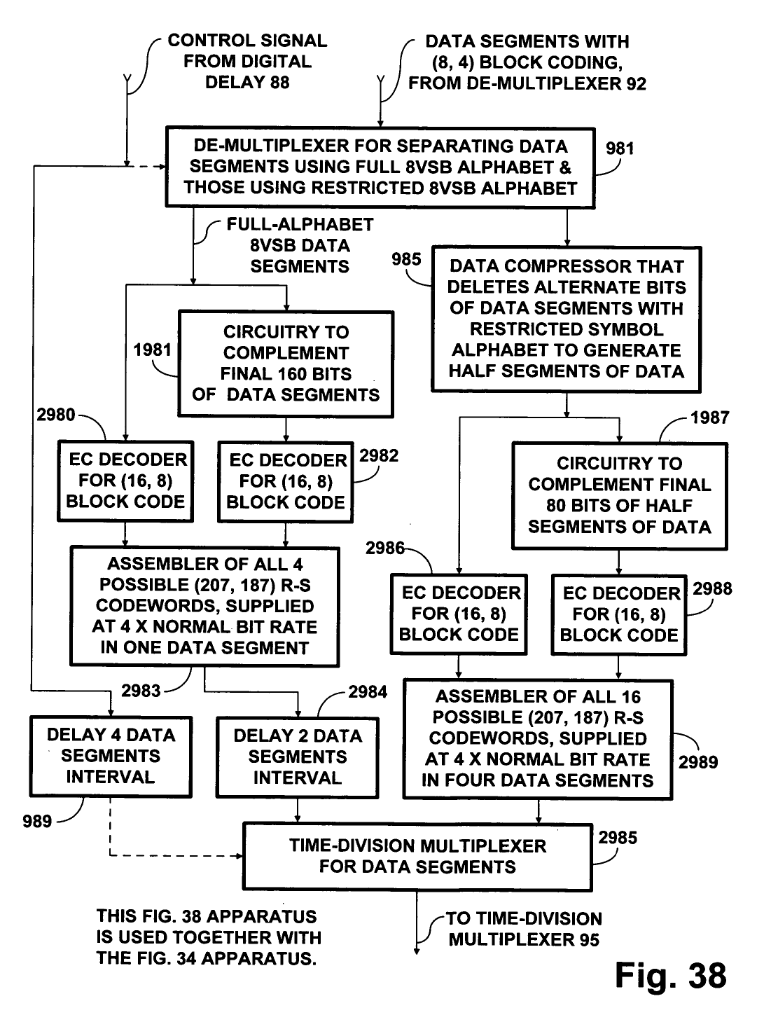

FIGS. 33 and 34 show in more detail another possible construction of the apparatus 93 for processing data segments that are Golay coded and another possible construction of the apparatus 94 for processing data segments that are not block coded. These other possible constructions are suitable for a DTV receiver designed for receiving DTV signals that employ (24, 12) binary extended Golay coding. The (24, 12) binary extended Golay coding halves code rate exactly, so auxiliary headers cannot be used if robust transmission of a (207, 187) R-S FEC codeword is to be fitted into two data segments. Nor can auxiliary headers be used if super-robust transmission of a (207, 187) R-S FEC codeword using a restricted symbol alphabet is to be fitted into four data segments.

The FIG. 33 apparatus 93 for processing data segments that are Golay coded includes the de-multiplexer 931 connected for receiving from the de-multiplexer 92 those de-interleaved data segments with block coding. Responsive to the second control signal supplied to the de-multiplexer 931 from the digital delay circuitry 89, the de-multiplexer 931 separates those block-coded data segments employing the full alphabet of 8VSB symbols from those block-coded data segments employing a restricted symbol alphabet. FIG. 33 shows the de-multiplexer 931 connected so as to select those block-coded data segments employing the full alphabet of 8VSB symbols to an error-correction decoder 1930 for (24, 12) binary extended Golay code. The error-correction decoder 1930 decodes each block-coded data segment to generate a respective half data segment that is possibly half a (207, 187) R-S FEC codeword. FIG. 33 also shows the de-multiplexer 931 connected for applying those block-coded data segments employing the full alphabet of 8VSB symbols to circuitry 1931 for complementing the final 160 bits of those data segments. An error-correction decoder 1932 for (24, 12) binary extended Golay code is connected for receiving the response of the circuitry 1931 to those block-coded data segments. The error-correction decoder 1932 decodes each data segment as modified by the circuitry 1931 to generate a respective half data segment that is possibly half a (207, 187) R-S FEC codeword. Only one of the two half data segments concurrently supplied by the error-correction decoders 1930 and 1932 actually is half a (207, 187) R-S FEC codeword.

An assembler 1933 is connected for receiving pairs of consecutive half data segments from the error-correction decoder 1930 and for receiving pairs of consecutive half data segments from the error-correction decoder 1932. The possible-codeword assembler 1933 assembles one possible (207, 187) R-S FEC codeword from each pair of consecutive half data segments from the error-correction decoder 1930 and another possible (207, 187) R-S FEC codeword from each pair of consecutive half data segments from the error-correction decoder 1932. The possible-codeword assembler 1933 also assembles two further possible (207, 187) R-S FEC codewords, each combining an initial half codeword supplied by one of the error-correction decoders 1930 and 1932 with a final half codeword supplied by the other of the error-correction decoders 1930 and 1932. The (207, 187) Reed-Solomon forward-error-correction decoding apparatus 96 will subsequently find only one of these four possible (207, 187) R-S FEC codewords to contain so few or no byte errors that a (207, 187) R-S FEC codeword free from byte error can be generated therefrom. The possible-codeword assembler 1933 is connected for supplying possible (207, 187) R-S FEC codewords to digital delay circuitry 1934 to be delayed for two data segment intervals. The digital delay circuitry 1934 is connected for applying delayed possible (207, 187) R-S FEC codewords to one input port of a time-division multiplexer 1935 for (207, 187) R-S FEC codewords. The time-division multiplexer 1935 has another input port connected for receiving (207, 187) R-S FEC codewords recovered from the block-coded data segments employing a restricted symbol alphabet.

FIG. 33 shows the de-multiplexer 931 further connected so as to select those block-coded data segments employing a restricted symbol alphabet to a data compressor 935 that deletes alternate bits of data, generating a respective half data segment of (24, 12) binary extended Golay code from each complete data segment it receives. The data compressor 935 is connected for supplying each half data segment to an error-correction decoder 1936 for (24, 12) binary extended Golay code and to circuitry 1937 for complementing the last eighty bits of each half data segment. The error-correction decoder 1936 decodes each half data segment of (24, 12) binary extended Golay code it receives to generate a respective possible quarter (207, 187) R-S FEC codeword. An error-correction decoder 1938 for (24, 12) binary extended Golay code is connected for receiving the response of the circuitry 1937. The error-correction decoder 1938 decodes each half data segment of (24, 12) binary extended Golay code it receives from the circuitry 1937 to generate a respective possible quarter (207, 187) R-S FEC codeword. A possible-codeword assembler 1939 is connected for receiving groups of four successive quarters of a (207, 187) R-S FEC codeword from each of the error-correction decoders 1936 and 1938. The possible-codeword assembler 1939 is operable for assembling sixteen possible complete (207, 187) R-S FEC codewords from each concurrent pair of groups of four successive possible quarter (207, 187) R-S FEC codewords. The possible-codeword assembler 1939 includes FIFO memory for temporarily storing successive pairs of possible quarter (207, 187) R-S FEC codewords. This FIFO memory is read from to supply each complete (207, 187) R-S FEC codeword at four times normal bit rate within one quarter of a single data segment. The possible-codeword assembler 1939 generates the sixteen possible complete (207, 187) R-S FEC codewords within four data segment intervals, facilitating their being time-division multiplexed with other (207, 187) R-S FEC codewords or possible codewords for application to the (207, 187) R-S FEC decoding apparatus 96. The possible-codeword assembler 939 is connected to supply these complete possible (207, 187) R-S FEC codewords to the appropriate input port of the time-division multiplexer 1935.

The FIG. 34 apparatus 94 for processing data segments that are not block coded is similar to that which FIG. 32 shows, but is arranged to supply (207, 187) R-S FEC codewords at four times normal bit rate rather than at two times normal bit rate. The (207, 187) R-S FEC codeword assembler 943 is replaced by a (207, 187) R-S FEC codeword assembler 1943 supplying (207, 187) R-S FEC codewords at quadrupled bit rate. A possible-codeword assembler 1947 that supplies (207, 187) R-S FEC codewords at quadrupled bit rate replaces the possible-codeword assembler 947. The digital delay circuitry 948 and the time-division multiplexer 944 are replaced by digital delay circuitry 1948 and by a time-division multiplexer 1944, respectively, both operative at quadrupled bit rate.

The sorting of data segments performed by the de-multiplexers 92, 931 and 941 can be performed by equivalent de-multiplexing apparatus. E.g., a de-multiplexer can separate de-interleaved data segments supplied by the de-interleaver 53 into one group employing the full alphabet of 8VSB and another group employing a restricted symbol alphabet. Then, a respective further de-multiplexer can separate each group into two subgroups, one composed of data segments using block coding and the other composed of data segments not using block coding. The time-division multiplexing of (207, 187) R-S FEC codewords performed by the multiplexers 934, 944 and 95 or by the multiplexers 1934, 1944 and 95 can be performed by equivalent multiplexing apparatus. E.g., the (207, 187) R-S FEC codewords generated from data segments using block coding can be time-division multiplexed together, and the (207, 187) R-S FEC codewords generated from data segments not using block coding can be time-division multiplexed together. Then, the resulting two groups of data segments can be time-division multiplexed together for application to the (207, 187) R-S FEC decoding apparatus 96.

FIG. 35 shows in more detail representative decoding circuitry 87 used in a DTV receiver designed to receive DTV signals that use (15, 8), (8, 4) or (16, 8) linear block coding. The de-multiplexer 92 is connected for receiving de-interleaved data segments from the convolutional interleaver 56. Responsive to the first control signal supplied to the de-multiplexer 92 from the digital delay circuitry 91, the de-multiplexer 92 separates those data segments with linear block coding from those data segments without linear block coding. FIG. 30 shows the de-multiplexer 92 connected so as to select those data segments with linear block coding to apparatus 98 for processing data segments that are block coded using (15, 8), (8, 4) or (16, 8) linear block coding. That apparatus 98 is operable to recover (207, 187) R-S FEC codewords and is connected for supplying those codewords to (207, 187) Reed-Solomon forward-error-correction decoding apparatus 99. The apparatus 98 decodes the (15, 8), (8, 4) or (16, 8) linear block coding so as also to generate information concerning the location of erroneous bytes in the (207, 187) R-S FEC codewords. This information is supplied to the (207, 187) R-S FEC decoding apparatus 99, so the apparatus 99 can use an alternative Reed-Solomon decoding algorithm that is capable of correcting up to twenty erroneous bytes per (207, 187) R-S FEC codeword, providing that the erroneous bytes have been previously located.

FIG. 35 shows the de-multiplexer 92 further connected so as to select those data segments without linear block coding to apparatus 94 for processing data segments that are not block coded. That apparatus 94 is operable to recover (207, 187) R-S FEC codewords and is connected for supplying those codewords to (207, 187) Reed-Solomon forward-error-correction decoding apparatus 196. The (207, 187) R-S FEC decoding apparatus 196 corrects insofar as possible byte errors in each of the 207-byte data segments supplied by the time division multiplexer 95 and toggles the Transport Error Indicator (TEI) bit in each data packet in those segments in which byte errors remain uncorrected. Presuming that the (207, 187) R-S FEC decoding apparatus 196 uses a conventional Reed-Solomon decoding algorithm that locates erroneous bytes, the apparatus 196 is capable of correcting up to ten erroneous bytes per (207, 187) R-S FEC codeword.

A time-division multiplexer 195 is connected for time-division multiplexing together packets of randomized data recovered by the (207, 187) R-S FEC decoding apparatuses 90 and 196. The multiplexer 195 performs this time-division multiplexing responsive to the first control signal as supplied with delay from digital delay circuitry 89 and with further delay from digital delay circuitry 197. The further delay from digital delay circuitry 197 compensates for the combined latent delay of the circuitry 98 and the apparatus 99. The further delay from digital delay circuitry 197 also compensates for the combined latent delay of the circuitry 94 and the apparatus 196.

In FIG. 35 the data de-randomizer 67 is connected for receiving 187-byte packets of randomized data from the output port of the time-division multiplexer 195. Preferably, the (207, 187) R-S FEC decoding apparatuses 99 and 196 are designed to supply 187-byte data packets to the time-division multiplexer 195 so as to facilitate those packets being time-division multiplexed and to keep the design of the data de-randomizer 67 simple. The data de-randomizer 67 is connected for supplying de-randomized data packets to the header detection apparatus 68 and to the transport stream de-multiplexer 69. The data de-randomizer 67 response to each of the 187-byte packets of randomized data is a respective MPEG-2 data packet sans its initial byte of packet synchronization code. The transport stream de-multiplexer 69 responds to the header detection apparatus 68 detecting selected PIDs in certain types of the de-randomized data packets from the data de-randomizer 67 for sorting those types of de-randomized data packets to appropriate packet decoders. For example, video data packets are sorted to the MPEG-2 decoder 70, and audio data packets are sorted to the AC-3 decoder 71.

FIGS. 36 and 32 show in more detail one possible construction of the apparatus 98 for processing data segments that are linear block coded and one possible construction of the apparatus 94 for processing data segments that are not block coded. These possible constructions are suitable for a DTV receiver designed for receiving DTV signals that employ (15, 8) binary linear block coding.

The FIG. 36 apparatus 98 for processing data segments that are block coded includes a de-multiplexer 981 connected for receiving from the de-multiplexer 92 those de-interleaved data segments with block coding. Responsive to the second control signal supplied to the de-multiplexer 981 from the digital delay circuitry 89, the de-multiplexer 981 separates those block-coded data segments employing the full alphabet of 8VSB symbols from those block-coded data segments employing a restricted symbol alphabet.

FIG. 36 shows the de-multiplexer 981 connected so as to select those block-coded data segments employing the full alphabet of 8VSB symbols to an error-correction decoder 982 for (15, 8) binary linear code. The error-correction decoder 982 is operable for recovering a (207, 187) R-S FEC codeword over two data segment intervals and is connected for supplying recovered (207, 187) R-S FEC codewords to a (207, 187) R-S FEC codeword assembler 983. The (207, 187) R-S FEC codewords that the error-correction decoder 982 supplies are unaccompanied by any response to the auxiliary header and the shim data in each data segment of (15, 8) binary linear block code supplied to the decoder 982. The codeword assembler 983 includes first-in, first-out memory for temporarily storing (207, 187) R-S FEC codewords. This FIFO memory is read from to supply a temporarily stored (207, 187) R-S FEC codeword at twice normal bit rate within the initial (or the final) half of a single data segment. The single data segment occurs two data segment intervals later than the first data segment containing the (207, 187) R-S FEC codeword in (15, 8) binary linear block code entered the error-correction decoder 982. The codeword assembler 983 is connected for supplying (207, 187) R-S FEC codewords to one input port of a time-division multiplexer 984 for (207, 187) R-S FEC codewords. The time-division multiplexer 984 has another input port connected for receiving (207, 187) R-S FEC codewords recovered from the block-coded data segments employing a restricted symbol alphabet.

FIG. 36 shows the de-multiplexer 981 further connected so as to select those block-coded data segments employing a restricted symbol alphabet to a data compressor 985 that deletes alternate bits of data, generating a respective half data segment of block code from each complete data segment it receives. The data compressor 985 is connected for supplying the remaining bits of data to an error-correction decoder 986 for (15, 8) binary linear block code. The error-correction decoder 986 decodes each half data segment of (15, 8) binary linear block code it receives to generate a respective quarter of a (207, 187) R-S FEC codeword. An assembler 987 is connected for receiving groups of four successive quarters of a (207, 187) R-S FEC codeword and is operable for assembling each such group into a respective complete (207, 187) R-S FEC codeword. The codeword assembler 987 includes first-in, first-out memory for temporarily storing successive quarters of (207, 187) R-S FEC codewords. This FIFO memory is read from to supply each complete (207, 187) R-S FEC codeword at twice normal bit rate within the initial (or final) half of a single data segment. The codeword assembler 987 is connected for supplying these complete (207, 187) R-S FEC codewords to the appropriate input port of the time-division multiplexer 984.

Responsive to the second control signal supplied to the de-multiplexer 981 from the digital delay circuitry 89 and further delayed by digital delay circuitry 989, the time-division multiplexer 984 time-division multiplexes together (207, 187) R-S FEC codewords it receives from the codeword assemblers 983 and 987. The output port of the time-division multiplexer 984 is connected for supplying the (207, 187) R-S FEC codewords recovered from data segments that are (15, 8) binary linear block coded to the input port of the (207, 187) Reed-Solomon forward-error-correction decoding apparatus 99 shown in FIG. 35.

FIGS. 37 and 34 show in more detail another possible construction of the apparatus 98 for processing data segments that are linear block coded and one possible construction of the apparatus 94 for processing data segments that are not block coded. These possible constructions are suitable for a DTV receiver designed for receiving DTV signals that employ (8, 4) binary linear block coding. The (8, 4) binary linear block coding halves code rate exactly, so it is impractical to use auxiliary headers.

The FIG. 37 apparatus 98 for processing data segments that are block coded includes the de-multiplexer 981 connected for receiving from the de-multiplexer 92 those de-interleaved data segments with block coding. Responsive to the second control signal supplied to the de-multiplexer 981 from the digital delay circuitry 89, the de-multiplexer 981 separates those block-coded data segments employing the full alphabet of 8VSB symbols from those block-coded data segments employing a restricted symbol alphabet. FIG. 37 shows the de-multiplexer 981 connected so as to select those block-coded data segments employing the full alphabet of 8VSB symbols to an error-correction decoder 1980 for (8, 4) binary linear block code. The error-correction decoder 1980 decodes each block-coded data segment to generate a respective half data segment that is possibly half a (207, 187) R-S FEC codeword. FIG. 37 also shows the de-multiplexer 981 connected for applying those block-coded data segments employing the full alphabet of 8VSB symbols to circuitry 1981 for complementing the final 160 bits of those data segments. As error-correction decoder 1982 for (8, 4) binary linear block code is connected for receiving the response of the circuitry 1981 to those block-coded data segments. The error-correction decoder 1982 decodes each data segment as modified by the circuitry 1981 to generate a respective half data segment that is possibly half a (207, 187) R-S FEC codeword. Only one of the two half data segments concurrently supplied by the error-correction decoders 1980 and 1982 actually is half a (207, 187) R-S FEC codeword.

A possible-codeword assembler 1983 is connected for receiving pairs of consecutive half data segments from the error-correction decoder 1980 and for receiving pairs of consecutive half data segments from the error-correction decoder 1982. The possible-codeword assembler 1983 assembles one possible (207, 187) R-S FEC codeword from each pair of consecutive half data segments from the error-correction decoder 1980 and another possible (207, 187) R-S FEC codeword from each pair of consecutive half data segments from the error-correction decoder 1982. The possible-codeword assembler 1983 also assembles two further possible (207, 187) R-S FEC codewords, each combining an initial half codeword supplies by one of the error-correction decoders 1980 and 1982 with a final half codeword supplied by the other of the error-correction decoders 1980 and 1982. The (207, 187) R-S FEC decoding apparatus 99 will subsequently find only one of these four possible (207, 187) R-S FEC codewords to contain so few or no byte errors that a (207, 187) R-S FEC codeword free from byte error can be generated therefrom. The possible-codeword assembler 1983 is connected for supplying possible (207, 187) R-S FEC codewords to digital delay circuitry 1984 to be delayed for two data segment intervals. The digital delay circuitry 1984 is connected for applying delayed possible (207, 187) R-S FEC codewords to one input port of a time-division multiplexer 1985 for (207, 187) R-S FEC codewords. The time-division multiplexer 1985 has another input port connected for receiving (207, 187) R-S FEC codewords recovered from the block-coded data segments employing a restricted symbol alphabet.

FIG. 37 shows the de-multiplexer 981 further connected so as to select those block-coded data segments employing a restricted symbol alphabet to a data compressor 985 that deletes alternate bits of data, generating a respective half data segment of (8, 4) binary linear block code from each complete data segment it receives. The data compressor 985 is connected for supplying each half data segment to an error-correction decoder 1986 for (8, 4) binary linear block code and to circuitry 1987 for complementing the last eighty bits of each half data segment. The error-correction decoder 1986 decodes each half data segment of (8, 4) binary linear block code it receives to generate a respective possible quarter (207, 187) R-S FEC codeword. An error-correction decoder 1988 for code is connected for receiving the response of the circuitry 1987. The error-correction decoder 1988 decodes each half data segment of (8, 4) binary linear block code it receives from the circuitry 1987 to generate a respective possible quarter (207, 187) R-S FEC codeword. A possible-codeword assembler 1989 is connected for receiving groups of four successive quarters of a (207, 187) R-S FEC codeword from each of the error-correction decoders 1986 and 1988. The assembler 1989 is operable to assembling sixteen possible complete (207, 187) R-S FEC codewords from each concurrent pair of groups of four successive possible quarter (207, 187) R-S FEC codewords. The possible-codeword assembler 1989 includes FIFO memory for temporarily storing successive pairs of possible quarter (207, 187) R-S FEC codewords. This FIFO memory is read from to supply each complete (207, 187) R-S FEC codeword at four times normal bit rate within one quarter of a single data segment. The possible-codeword assembler 1989 generates the sixteen possible complete (207, 187) R-S FEC codewords within four data segment intervals, facilitating their being time-division multiplexed with other (207, 187) R-S FEC codewords or possible codewords for application to the (207, 187) R-S FEC decoding apparatus 99. The possible-codeword assembler 1989 is connected to supply these complete possible (207, 187) R-S FEC codewords to the appropriate input port of the time-division multiplexer 1985.

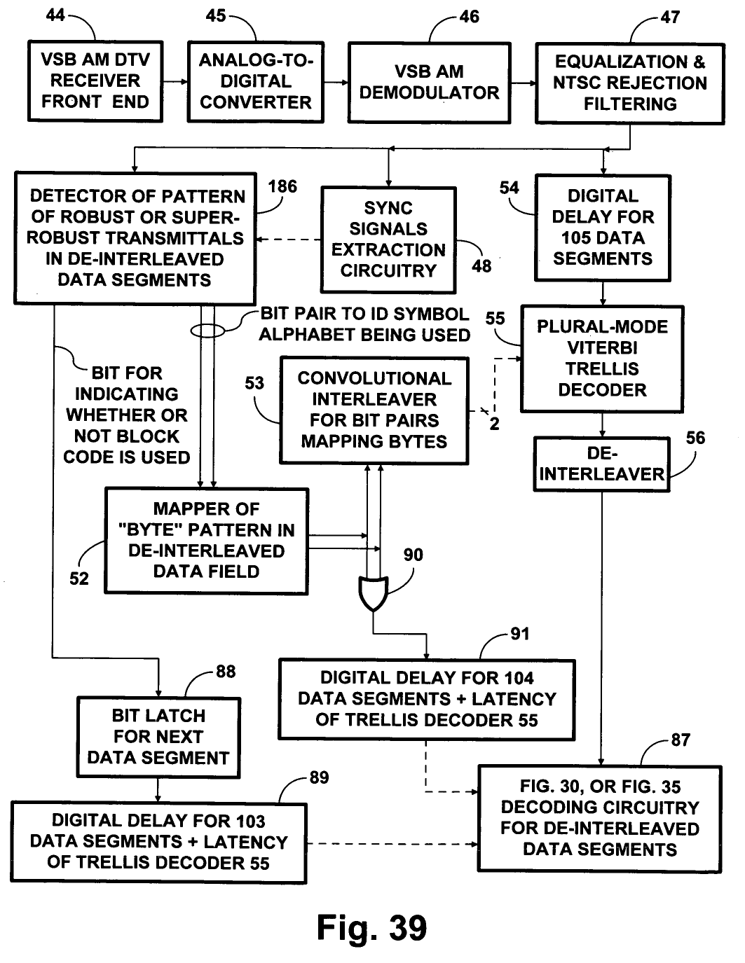

FIGS. 38 and 34 show in more detail still another possible construction of the apparatus 98 for processing data segments that are linear block coded and one possible construction of the apparatus 94 for processing data segments that are not block coded. These possible constructions are suitable for a DTV receiver designed for receiving DTV signals that employ (16, 8) binary linear block coding. The (16, 8) binary linear block coding halves code rate exactly, so it is impractical to use auxiliary headers. FIG. 38 shows a construction of the apparatus 98 for processing data segments that are linear block coded similar to that shown in FIG. 37, except for the error-correction decoders 1980, 1982, 1986 and 1988 for (8, 4) binary linear block coding being replaced respectively by error-correction decoders 2980, 2982, 2986 and 2988 for (16, 8) binary linear block coding.

FIG. 35 shows a connection from the apparatus 98 for processing block coded data segments to the (207, 187) R-S FEC decoding apparatus 99, which connection is used to convey information regarding the location of byte errors. FIG. 35 shows this connection as being separate from the connection from the apparatus 98 for processing block coded data segments to the (207, 187) R-S FEC decoding apparatus 99, which connection is used to convey (207, 187) R-S FEC codewords. In actual practice, it is convenient for implementing time-division multiplexing of the (207, 187) R-S FEC codewords to use bit extensions to the 8-bit bytes of the (207, 187) R-S FEC codewords for indicating which bytes are known to be erroneous. A 1-bit extension to each 8-bit byte of each (207, 187) R-S FEC codeword suffices for conveying byte error location information provided by error-detection decoders for (15, 8) or (16, 8) linear block coding. However, a 2-bit extension to each 8-bit byte of each (207, 187) R-S FEC codeword may be used for conveying half-byte error location information provided by error-detection decoders for (8, 4) linear block coding. Accordingly, FIG. 38 shows digital delay circuitry 2984, a time-division multiplexer 2985 and a possible-codeword assembler 2989 replacing the digital delay circuitry 1984, the time-division multiplexer 1985 and the possible-codeword assembler 1989 shown in FIG. 37. Alternatively, indications of error concerning halves of each 8-bit byte may be ORed to derive a single-bit indication as to whether the byte is erroneous. Such single-bit indications can be conveyed in respective 1-bit extensions of the 8-bit bytes of (207, 187) R-S FEC codewords.

FIG. 39 shows a modified FIG. 29 portion of the DTV receiver in which a transmission-pattern detector 186 to detect the pattern of robust and super-robust transmittals in fields of de-interleaved data segments replaces the FIG. 29 transmission-pattern detector 86. The transmission-pattern detector 186 detect the pattern by responding to codes that are transmitted in the portions of the initial data segments of data fields following the triple PN63 sequences in order to of robust and super-robust transmittals in fields of de-interleaved data segments. Instead, the transmission-pattern detector 186 determines the pattern of robust and super-robust transmittals in successive de-interleaved data segments by analyzing the data segments themselves concerning their respective natures. The transmission-pattern detector 186 includes symbol decoding circuitry followed by a de-interleaver that recovers de-interleaved segments of randomized data. Each de-interleaved segment of randomized data is analyzed to determine whether or not block coding is used therein. Each de-interleaved segment of randomized data is further analyzed to determine what sort of restriction, if any, was applied to the symbol alphabet used therein. FIG. 39 contains a further modification, made to accommodate a presumed 52-data-segment delay in the de-interleaver recovering de-interleaved segments of randomized data for analysis. In this further modification, digital delay circuitry 54 that delays the digital filtering 47 response by 105 or so data segments replaces the digital delay circuitry 154 that delays the digital filtering 47 response by 53 or so data segments.

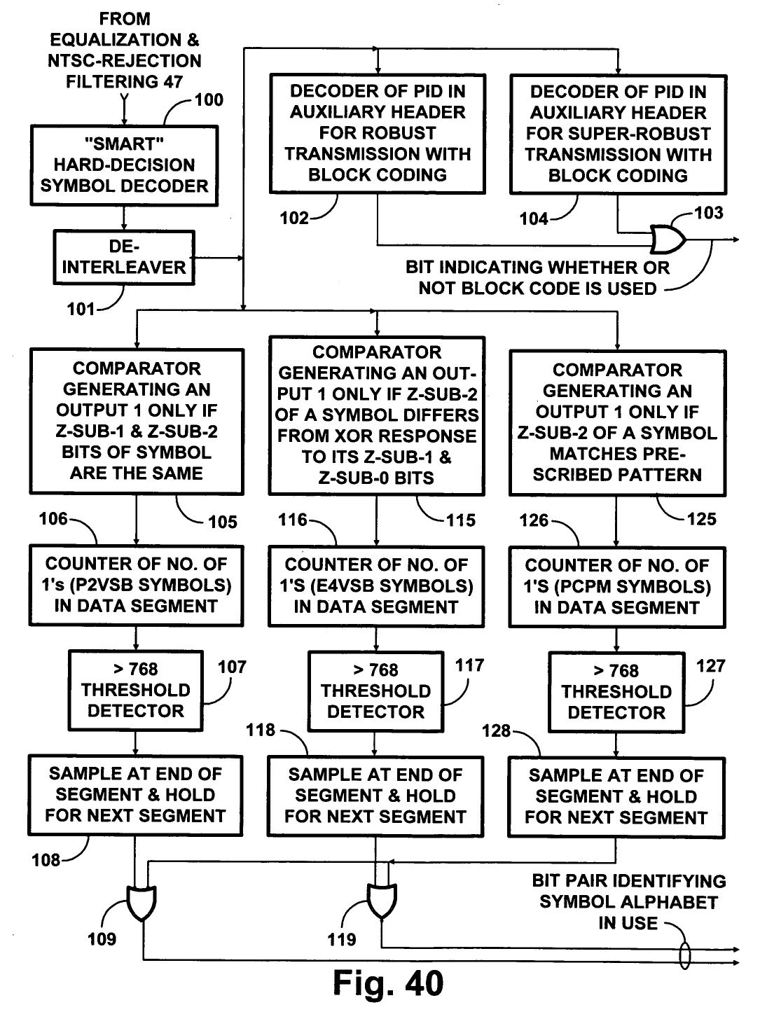

FIG. 40 shows in detail one possible embodiment of the transmission-pattern detector 186 to detect the pattern of robust and super-robust transmittals in fields of de-interleaved data segments. The transmission-pattern detector 186 as shown in FIG. 40 includes a “smart” hard-decision symbol decoder 100 connected to receive equalized baseband DTV signal from the NTSC-rejection and equalization filtering 47 as shown in FIG. 39. The hard-decision symbol decoder 100 is preferably of the “smart” type described by Hulyalkar et alii in U.S. Pat. No. 6,178,209 issued Jan. 23, 2001 and titled “METHOD OF ESTIMATING TRELLIS ENCODED SYMBOLS UTILIZING SIMPLIFIED TRELLIS DECODING”. The hard-decision symbol decoder 100 is connected for supplying the symbol decisions it makes to a de-interleaver 101 which is complementary to the convolutional interleaver 12 used in the DTV transmitter. Rather than using 8-bit bytes, the de-interleaver 101 uses 12-bit bytes, since the Z₀ bit of each symbol decision is carried forward as well as the Z₁ and Z₂ bits.

The Z₁ and Z₂ bits of the symbols from the de-interleaver 101 are applied as input signal to a decoder 102 for the PID sequence in auxiliary headers of data segments used for robust transmissions with linear block coding. The DTV receiver presumably includes per custom a symbol counter for counting the number of symbols per data field and possibly per data frame or frames. Presumably, this symbol counter includes a section counting the number of symbols per data segment, or a separate counter for counting the number of symbols per data segment is also included within the receiver. The decoder 102 includes a component decoder for decoding the range(s) within the count of the number of symbols per data segment in which range(s) the PID of a data segment reposes. When the symbol count is in such range(s), the Z₁ and Z₂ bits of the symbols from the de-interleaver 101 are evaluated within the decoder 102 to determine whether or not the PID of a robust transmission using linear block code is contained in those bits. If the PID of a robust transmission using linear block code is not contained in those bits, the decoder 102 supplies a logic ZERO to a first input port of a two-input OR gate 103. If the PID of a robust transmission using linear bock code is contained in those bits, the decoder 102 supplies a logic ONE to the first input port of the OR gate 103.

The Z₂ bits of the symbols from the de-interleaver 101 are applied as input signal to a decoder 104 for the PID sequence in auxiliary headers of data segments used for super-robust transmissions with linear block coding. The decoder 104 includes a component decoder for decoding the range within the count of the number of symbols per data segment in which range the PID sequence of a data segment reposes after expansion 2:1 as a result of alphabet restriction. When the symbol count is in that range, the Z₂ bits of the symbols from the de-interleaver 101 are evaluated within the decoder 104 to determine whether or not the PID of a robust transmission using linear block code is contained in those bits. If the PID of a robust transmission using linear block code is not contained in those Z₂ bits, the decoder 104 supplies a logic ZERO to a second input port of the two-input OR gate 103. If the PID of a robust transmission using linear block code is contained in those Z₂ bits, the decoder 104 supplies a logic ONE to the second input port of the OR gate 103. The OR gate 103 response provides the bit indicating whether or not Golay coding is used in a data segment, which bit the transmission-pattern detector 186 supplies to the bit latch 90.

In FIG. 40 a comparator 105 is connected for generating a logic ONE only if the Z₁ and Z₂ bits of a symbol from the de-interleaver 101 are the same as each other, which indicates the symbol is possibly a P2VSB symbol. The comparator 105 generates a logic ZERO if the Z₁ and Z₂ bits of a symbol from the de-interleaver 101 differ from each other, which indicates the symbol is not a P2VSB symbol. A counter 106 is connected to be reset to zero count at the beginning of each data segment and counts the number of logic ONES generated by the comparator 105 during that data segment. A threshold detector 107 is connected to receive, as its input signal, the counter 106 count. The threshold detector 107 generates a logic ONE only if the counter 106 count exceeds a threshold value and otherwise generates a logic ZERO. The threshold value is chosen to be somewhat less than 828, the number of symbols in a data segment, to allow for some symbols being erroneous owing to noise. By way of example, the threshold value is chosen to be 768. A sample-and-hold circuit 108 is connected to sample the threshold detector 107 response at the end of each data segment interval and to reproduce that response in its own output signal throughout the next data segment interval. A ONE output from the sample-and-hold circuit 108 indicates the likelihood that the data segment being presented to the trellis decoder 55 uses the P2VSB symbol alphabet.

In FIG. 40, a comparator 115 is connected for generating a logic ONE only if the Z₂ bit of a symbol from the de-interleaver 101 differs from the exclusive-OR response to the Z₁ and Z₀ bits of that symbol, which indicates the symbol is possibly an E4VSB symbol. The comparator 115 generates a logic the Z₂ bit of a symbol from the de-interleaver 101 is the same as the exclusive-OR response to the Z₁ and Z₀ bits of that symbol, which indicates the symbol is not an E4VSB symbol. A counter 116 is connected to be reset to zero count at the beginning of each data segment and counts the number of logic ONES generated by the comparator 115 during that data segment. A threshold detector 117 is connected to receive, as its input signal, the counter 116 count. The threshold detector 117 generates a logic ONE only if the counter 116 count exceeds a threshold value and otherwise generates a logic ZERO. The threshold value is chosen to be somewhat less than 828, the number of symbols in a data segment, to allow for some symbols being erroneous owing to noise. By way of example, the threshold value is chosen to be 768. A sample-and-hold circuit 118 is connected to sample the threshold detector 117 response at the end of each data segment interval and to reproduce that response in its own output signal throughout the next data segment interval. A ONE output from the sample-and-hold circuit 118 indicates the likelihood that the data segment being presented to the trellis decoder 55 uses the E4VSB symbol alphabet.

In FIG. 40 a comparator 125 is connected for generating a logic ONE only if the Z₂ bit of a symbol from the de-interleaver 101 equals the prescribed value for a PCPM symbol. Otherwise, the comparator 125 generates a logic ZERO. A counter 126 is connected to be reset to zero count at the beginning of each data segment and counts the number of logic ONES generated by the comparator 125 during that data segment. A threshold detector 127 is connected to receive, as its input signal, the counter 126 count. The threshold detector 127 generates a logic ONE only if the counter 126 count exceeds a threshold value and otherwise generates a logic ZERO. The threshold value is chosen to be somewhat less than 828, the number of symbols in a data segment, to allow for some symbols being erroneous owing to noise. By way of example, the threshold value is chosen to be 768. A sample-and-hold circuit 128 is connected to sample the threshold detector 127 response at the end of each data segment interval and to reproduce that response in its own output signal throughout the next data segment interval. A ONE output from the sample-and-hold circuit 128 indicates the likelihood that the data segment being presented to the trellis decoder 55 uses prescribed-coset-pattern modulation.

The sample-and-hold circuit 128 is connected for supplying its output signal as input signals to the first input ports of OR gates 119 and 129, the output ports of which supply the bit pair input signal for the mapper 52. When the output signal from the sample-and-hold circuit 128 is a ONE, the OR gates 119 and 129 supply the mapper 52 a 11 bit pair indicative that the data segment being presented to the trellis decoder 55 uses prescribed-coset-pattern modulation. When the output signal from the sample-and-hold circuit 108 is a ONE and both the output signals from the sample-and-hold circuits 118 and 128 are ZEROes, the OR gates 119 and 129 supply the mapper 52 a 01 bit pair indicative that the data segment being presented to the trellis decoder 55 uses 2PVSB modulation. When the output signal from the sample-and-hold circuit 108 is a ONE and both the output signals from the sample-and-hold circuits 118 and 128 are ZEROes, the OR gates 119 and 129 supply the mapper 52 a 01 bit pair indicative that the data segment being presented to the trellis decoder 55 uses 2PVSB modulation. When all the output signals from the sample-and-hold circuits 108, 118 and 128 are ZEROes, the OR gates 119 and 129 supply the mapper 52 a 00 bit pair indicative that the data segment being presented to the trellis decoder 55 uses ordinary 8VSB modulation.

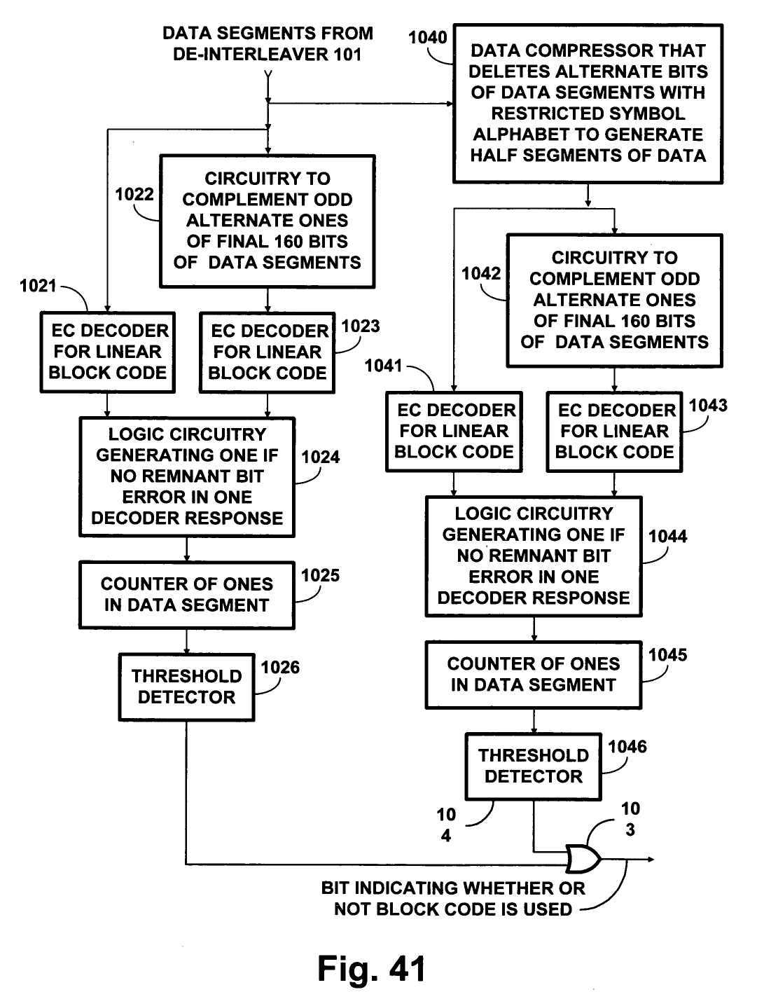

FIG. 41 shows a detector of robust transmission with block coding which can replace the decoder 102 for the PID sequence in auxiliary headers of data segments using linear block coding for robust transmissions. The FIG. 41 detector of robust transmission with block coding comprises elements 1021, 1022, 1022, 1023, 1024, 1025 and 1026. It does not rely on auxiliary header information and so can be used with linear block codes that halve code rate as well as with (23, 12) binary Golay code or with (15, 8) binary linear block code. More particularly, de-interleaved data segments from the de-interleaver 101 are supplied to an error-correction decoder 1021 for the particular linear block code in use. De-interleaved data segments from the de-interleaver 101 are also supplied to circuitry 1022 for complementing the final 160 bits of those data segments and supplying the data segments as so modified to another error-correction decoder 1023 for the particular linear block code in use. The error-correction decoders 1021 and 1023 supply respective logic circuitry 1024 indications as to whether decoded “codewords” of length used by the prescribed linear block code are or are not free of remnant bit error. The logic circuitry 1024 generates a logic ONE if either of the error-correction decoders 1021 and 1023 finds the currently decoded block-code “codeword” is free of remnant bit error. A counter 1025 is connected for counting the logic ONEs generated during each data segment interval and supplying that count to a threshold detector 1026. If the count exceeds a prescribed number, the response of the threshold detector 1026 is a log ONE. Otherwise, it is a logic ZERO. Since there are 36 codewords of (23, 12) Golay code per data segment, the threshold count will be somewhat less than 36—say, 28—if such code is used. Since there are 34.5 codewords of (24, 12) extended Golay code per data segment, the threshold count will be somewhat less than 34—say, 26—if such code is used. And so on for other linear block codes. OR gate 103 is connected to receive the response of the threshold detector 1026 as an input signal thereof. When that input signal is a logic ONE, signaling that the data segment being analyzed probably implements robust transmission with block coding, the single-bit response of the OR gate 103 is a logic ONE, signaling that the data segment being analyzed uses block coding.

FIG. 41 also shows a detector of super-robust transmission with block coding which can replace the decoder 104 for the PID sequence in auxiliary headers of data segments using linear block coding and limited symbol alphabet for super-robust transmissions. The FIG. 41 detector of super-robust transmissions with block coding comprises elements 1040, 1041, 1042, 1042, 1043, 1044, 1045 and 1046. It does not rely on auxiliary header information and so can be used with linear block codes that halve code rate as well as with (23, 12) binary Golay code or (15, 8) binary linear block code. More particularly, de-interleaved data segments from the de-interleaver 101 are supplied to a data compressor 1040 that responds to the Z₂ bits, but not the Z₁ bits, in each data segment. The half data segments from the data compressor 1040 are supplied to an error-correction decoder 1041 for the particular linear block code in use. The half data segments from the data compressor 1040 are also supplied to circuitry 1042 for complementing the final 160 bits of those data segments and supplying the data segments as so modified to another error-correction decoder 1043 for the particular linear block code in use. The error-correction decoders 1041 and 1043 supply respective logic circuitry 1044 indications as to whether decoded “codewords” of length used by the prescribed linear block code are or are not free of remnant bit error. The logic circuitry 1044 generates a logic ONE if either of the error-correction decoders 1041 and 1043 finds the currently decoded block-code “codeword” is free of remnant bit error. A count 1045 is connected for counting the logic ONEs generated during each half data segment interval and supplying that count to a threshold detector 1046. If the count exceeds a prescribed number, the response of the threshold detector 1046 is a logic ONE. Otherwise, it is a logic ZERO. Since there are 18 codewords of (23, 12) Golay code per half data segment, the threshold count will be somewhat less than 18—say, 14—if such code is used. Since there are 17+ codewords of (24, 12) extended Golay code per data segment, the threshold count will be somewhat less than 17—say, 13—if such code is used. And so on for other linear block codes. OR gate 103 is connected to receive the response of the threshold detector 1046 as an input signal thereof. When that input signal is a logic ONE, signaling that the data segment being analyzed probably implements super-robust transmission with block coding, the single-bit response of the OR gate 103 is a logic ONE, signaling that the data segment being analyzed uses block coding.

Each of the possible-codeword assemblers assembles a set of possible R-S FEC codewords from information about a particular R-S FEC codeword transmitted with more redundant coding within a group of data segments. It is conceivable that on infrequent occasion the (207, 187) R-S FEC decoding apparatus might find more than one of such a set of possible R-S FEC codewords to be correctable. The likelihood of this occurring can be reduced by the following sort of procedure. Each data segment in the group is modified so as to undo possible modification at the transmitter done to avoid legacy DTV receivers mistaking that data segment for a correctable (207, 187) R-S FEC codeword recovered from an ordinary 8VSB transmission. The data segment as so modified at the receiver is then subjected to (207, 187) R-S FEC decoding. This is done to decide whether the data segment would have had to be modified at the transmitter, so that legacy DTV receivers would not mistake that data segment for a correctable (207, 187) R-S FEC codeword recovered from an ordinary 8VSB transmission. If and only if it is decided that a data segment would not have had to be so modified at the transmitter, possible codewords that would depend in part from the modified form of the data segment are excluded from the set of possible codewords supplied to the R-S FEC decoding apparatus.

What is claimed is:

1. A method used in connection with the generation of 8VSB digital television signals, said method used for generating an output digital signal with twice the number 1656-bit data segments as there are 1496-bit data packets in an input digital signal that said output digital signal is generated responsive to, said method comprising the steps of:
coding each of said 1496-bit data packets with a (207, 187) Reed-Solomon forward-error-correction coding algorithm to generate a respective 1656-bit Reed-Solomon codeword;
binary linear block coding consecutive groups of k bits in mk-bit sequences each including one said respective 1656-bit Reed-Solomon codeword to generate respective consecutive contiguous groups of n bits, each said group of n bits forming a respective codeword of a prescribed binary linear block code, k being an integer that is a multiple of four, mk being a multiple of k, and n being an integer at least twice k; and
including, within a respective pair of 1656-bit data segments in said output digital signal, said consecutive contiguous groups of n bits generated by binary linear block coding one of said mk-bit sequences.

2. The method of claim 1, wherein said step of binary linear block coding uses (23, 12) binary Golay coding with n being twenty-three and k being twelve, said method including a step of
inserting auxiliary headers into each said 1656-bit codeword of (207, 187) Reed-Solomon forward-error-correction coding to generate a 1728-bit sequence used as the respective said mk-bit sequence in said step of binary linear block coding is (23, 12) binary Golay coding with n being twenty-three and k being twelve.

3. The method of claim 1, wherein said step of binary linear block coding uses (24, 12) binary Golay coding with n being twenty-four and k being twelve.

4. The method of claim 1 wherein said step of binary linear block coding uses (8, 4) binary linear block coding with n being eight and k being four.

5. The method of claim 1 wherein said step of binary linear block coding uses (16, 8) binary linear block coding with n being sixteen and k being eight.

6. The method of claim 1, wherein said step of binary linear block coding uses (15, 8) binary linear block coding with n being fifteen and k being eight, said method including steps of
inserting auxiliary headers into each said 1656-bit codeword of (207, 187) Reed-Solomon forward-error-correction coding to generate a 1760-bit sequence used as the respective said mk-bit sequence in said step of binary linear block coding; and
inserting a respective six shim bits into each of said 1656-bit data segments in said output digital signal.

7. A method for generating a code descriptive of symbols from a restricted alphabet of 8VSB symbols, said method for generating a code descriptive of symbols from a restricted alphabet of 8VSB symbols being used in connection with the generation of 8VSB digital television signals and comprising in addition to the steps of said method of claim 1 an additional step of:
inserting a prescribed respective bit immediately following each bit in said output digital signal generated by the method of claim 1, said method of claim 7 being used in connection with broadcasting digital television signals.

8. A receiver for digital television signals transmitted at radio frequencies using vestigial-sideband amplitude-modulation in accordance with trellis-coded symbols selected from an 8VSB symbol alphabet, said receiver comprising:
circuitry for receiving a selected one of said digital television signals transmitted at radio frequencies and recovering therefrom a baseband digital television signal comprising said trellis-coded symbols selected from said 8VSB symbol alphabet;
a trellis decoder connected for receiving said baseband digital television signal and decoding said trellis-coded symbols to recover data fields of convolutionally interleaved data segments.
a de-interleaver connected for responding to said convolutionally interleaved data segments to supply fields of successive de-interleaved data segments;
a transmission-pattern detector connected for responding to portions of said baseband digital television signal to detect the patterns of any robust or super-robust transmittals in said fields of successive de-interleaved data segments, connected for supplying indications of the nature of redundant coding that each of said de-interleaved data segments uses if it was not transmitted as a complete codeword of (207, 187) Reed-Solomon forward-error-correction coding but was transmitted to include a redundantly coded aliquot portion of a complete codeword of (207, 187) Reed-Solomon forward-error-correction coding;
de-multiplexing circuitry controlled responsive to said indications supplied from said transmission-pattern detector for sorting said de-interleaved data segments that were transmitted as respective complete codewords of (207, 187) Reed-Solomon forward-error-correction coding from groups of said de-interleaved data segments that each include a respective portion of a redundantly coded complete codeword of (207, 187) Reed-Solomon forward-error-correction coding;
apparatus for recovering complete codewords of (207, 187) Reed-Solomon forward-error-correction coding from said groups of said de-interleaved data segments that each include a respective portion of a redundantly coded complete codeword of (207, 187) Reed-Solomon forward-error-correction coding;
(207, 187) Reed-Solomon forward-error-correction decoding apparatus connected for responding to each complete codeword of (207, 187) Reed-Solomon forward-error-correction coding supplied from said de-interleaver or from said apparatus for recovering complete codewords of (207, 187) Reed-Solomon forward-error-correction coding from said groups of data segments each of which data segments therein contains a respective portion of a redundantly coded complete codeword of (207, 187) Reed-Solomon forward-error-correction coding, said (207, 187) Reed-Solomon forward-error-correction decoding apparatus connected for supplying packets of randomized data extracted from respective ones of said complete Reed-Solomon forward-error-correction codewords received thereby, said (207, 187) Reed-Solomon forward-error-correction decoding apparatus being of a type operable for correcting up to ten erroneous bytes in any packet of randomized data supplied therefrom and for furnishing indications of whether or not each packet of randomized data supplied therefrom contains uncorrected erroneous bytes;
a data de-randomizer connected for supplying packets of de-randomized data in response to said packets of randomized data supplied to said data de-randomizer from said (207, 187) Reed-Solomon forward-error-correction decoding apparatus;
header detection apparatus connected for detecting the packet identification bits in each packet of de-randomized data supplied from said data de-randomizer; and
a transport stream de-multiplexer connected for sorting said packets of de-randomized data supplied from said data de-randomizer responsive to the packet identification bits said header detection apparatus detects within each of said packets of de-randomized data.

9. The receiver of claim 8 for digital television signals, some data segments of which are apt to employ binary linear block coding together with the full alphabet of 8VSB symbols, wherein said de-multiplexing circuitry is connected for separating groups of two said de-interleaved data segments that employ binary linear block coding together with the full alphabet of 8VSB symbols, and where said apparatus for recovering complete codewords of (207, 187) Reed-Solomon forward-error-correction coding from said groups of said de-interleaved data segments that each include a respective portion of a redundantly coded complete codeword of (207, 187) Reed-Solomon forward-error-correction coding comprises:
an error-correction decoder for binary linear coding, connected for receiving said separated groups of two said de-interleaved data segments that employ binary linear block coding together with the full alphabet of 8VSB symbols, and connected for supplying a respective half codeword of (207, 187) Reed-Solomon forward-error-correction coding in response to each said separated de-interleaved data segment that employs binary linear block coding together with the full alphabet of 8VSB symbols; and
a codeword assembler connected for receiving half codewords of (207, 187) Reed-Solomon forward-error-correction coding from said error-correction decoder for binary linear coding, and connected for said supplying said (207, 187) Reed-Solomon forward-error-correction decoding apparatus with complete codewords of (207, 187) Reed-Solomon forward-error-correction coding assembled from said half codewords.

10. The receiver of claim 9 for digital television signals, wherein said binary linear block coding is (23, 12) binary Golay coding.

11. The receiver of claim 8 for digital television signals, some data segments of which are apt to employ binary linear block coding together with only a restricted alphabet of 8VSB symbols that further halves code rate, wherein said de-multiplexing circuitry is connected for separating groups of four said de-interleaved data segments that employ binary linear block coding together with only said restricted alphabet of 8VSB symbols, and wherein said apparatus for recovering complete codewords of (207, 187) Reed-Solomon forward-error-correction coding from said groups of said de-interleaved data segments that each include a respective portion of a redundantly coded complete codeword of (207, 187) Reed-Solomon forward-error-correction coding comprises:
a data compressor that generates a respective compressed de-interleaved data segment responsive to each of said de-interleaved data segments that employs binary linear block coding together with only said restricted alphabet of 8VSB symbols;
an error-correction decoder for binary linear block coding, connected for receiving said compressed de-interleaved data segments from said data compressor, and connected for supplying quarter codewords of (207, 187) Reed-Solomon forward-error-correction coding recovered from respective compressed de-interleaved data segments; and
a codeword assembler, connected for receiving said quarter codewords of (207, 187) Reed-Solomon forward-error-correction coding from said error-correction decoder for binary linear block coding, and connected for supplying said (207, 187) Reed-Solomon forward-error-correction decoding apparatus with complete codewords of (207, 187) Reed-Solomon forward-error-correction coding assembled from those received said quarter codewords of (207, 187) Reed-Solomon forward-error-correction coding.

12. The receiver of claim 11 for digital television signals, wherein said binary linear block coding is (23, 12) binary Golay coding.

13. The receiver of claim 8 for digital television signal, some data segments of which are apt to employ binary linear block coding together with the full alphabet of 8VSB symbols, wherein said de-multiplexing circuitry is connected for separating groups of two said de-interleaved data segments that employ binary linear block coding together with the full alphabet of 8VSB symbols, and wherein said apparatus for recovering complete codewords of (207, 187) Reed-Solomon forward-error-correction coding from said groups of said de-interleaved data segments that each include a respective portion of a redundantly coded complete codeword of (207, 187) Reed-Solomon forward-error-correction coding comprises:
a first error-correction decoder for binary linear block coding, connected for receiving said separated de-interleaved data segments that employ binary linear block coding together with the full alphabet of 8VSB symbols, and connected for supplying a respective possible half codeword of (207, 187) Reed-Solomon forward-error-correction coding in response to each said separated de-interleaved data segment that employs binary linear block coding together with the full alphabet of 8VSB symbols;
circuitry for modifying each said separated de-interleaved data segments that employ binary linear block coding together with the full alphabet of 8VSB symbols to generate a respective modified separated de-interleaved data segment that binary linear block coding together with the full alphabet of 8VSB symbols, said modifying being such as to counteract possible prior modification of that data segment that might have been made at the transmitter so that the data segment would be disregarded by legacy digital television receivers;
a second error-correction decoder for binary linear block coding, connected for receiving said modified separated de-interleaved data segments that employ binary linear block coding together with the full alphabet of 8VSB symbols, and connected for supplying a respective possible half codeword of (207, 187) Reed-Solomon forward-error-correction coding in response to each said separated de-interleaved data segment that employs binary linear block coding together with the full alphabet of 8VSB symbols; and
a possible-codeword assembler for assembling four complete possible codewords of (207, 187) Reed-Solomon forward-error-correction coding from each two possible initial half codewords that said first and second error-correction decoders concurrently supply and from each two possible final half codewords that said first and second error-correction decoders supply most immediately thereafter, said complete possible codewords being included in said complete codewords of (207, 187) Reed-Solomon forward error-correction coding that said apparatus for recovering complete codewords of (207, 187) Reed-Solomon forward-error-correction coding supplies and that said (207, 187) Reed-Solomon forward-error-correction decoding apparatus responds to.

14. The receiver of claim 13 for digital television signals, wherein said binary linear block coding is (24, 12) binary extended Golay coding.

15. The receiver of claim 8 for digital television signals, some data segments of which are apt to employ binary linear block coding together with only a restricted alphabet of 8VSB symbols that further halves code rate, wherein said de-multiplexing circuitry is connected for separating groups of four said de-interleaved data segments that employ binary linear block coding together with only said restricted alphabet of 8VSB symbols, and wherein said apparatus for recovering complete codewords of (207, 187) Reed-Solomon forward-error-correction coding from said groups of said de-interleaved data segments that each include a respective portion of a redundantly coded complete codeword of (207, 187) Reed-Solomon forward-error-correction coding comprises:
a data compressor that generates a respective compressed de-interleaved data segment responsive to each of said de-interleaved data segments that employs binary linear block coding together with only said restricted alphabet of 8VSB symbols;
a first error-correction decoder for binary linear block coding, connected for receiving said separated de-interleaved data segments employ binary linear block coding together with only said restricted alphabet of 8VSB symbols, and connected for supplying a respective possible quarter codeword of (207, 187) Reed-Solomon forward-error-correction coding in response to each said separated de-interleaved data segment that employs binary linear block coding together with said restricted alphabet of 8VSB symbols;
circuitry for modifying each said separated de-interleaved data segments that employ binary linear block coding together with only said restricted alphabet of 8VSB symbols to generate a respective modified separated de-interleaved data segment that employs binary linear block coding together with said restricted alphabet of 8VSB symbols, said modifying being such as to counteract possible prior modification of that data segment that might have been made at the transmitter so that the data segment would be disregarded by legacy digital television receivers;
a second error-correction decoder for binary linear block coding, connected for receiving said modified separated de-interleaved data segments that employ binary linear block coding together with only said restricted alphabet of 8VSB symbols, and connected for supplying a respective possible quarter codeword of (207, 187) Reed-Solomon forward-error-correction coding in response to each said separated de-interleaved data segment that employs binary linear block coding together with said restricted alphabet of 8VSB symbols; and
a possible-codeword assembler for assembling sixteen complete possible codewords of (207, 187) Reed-Solomon forward-error-correction coding from each set of four successive pairs of possible quarter codewords that said first and second error-correction decoders concurrently supply, said complete possible codewords being included in said complete codewords of (207, 187) Reed-Solomon forward-error-correction coding that said apparatus for recovering complete codewords of (207, 187) Reed-Solomon forward-error-correction coding supplies and that said (207, 187) Reed-Solomon forward-error-correction decoding apparatus responds to.

16. The receiver of claim 15 for digital television signals, wherein said binary linear block coding is (24, 12) binary extended Golay coding.

17. The receiver of claim 8 for digital television signals, some data segments of which are apt to employ a restricted alphabet of 8VSB symbols that causes halving of code rate over ordinary 8VSB with ⅔ trellis coding, wherein said de-multiplexing circuitry is connected for separating groups of said de-interleaved data segments that employ only said restricted alphabet of 8VSB symbols and have half the code rate of ordinary 8VSB with ⅔ trellis coding, and wherein said apparatus for recovering complete codewords of (207, 187) Reed-Solomon forward-error-correction coding from said groups of said de-interleaved data segments that each include a respective portion of a redundantly coded complete codeword of (207, 187) Reed-Solomon forward-error-correction coding comprises:
a data compressor that deletes alternate bits of each said de-interleaved data segment that employs only said restricted alphabet of 8VSB symbols and has half the code rate of ordinary 8VSB with ⅔ trellis coding, thereby to generate a possible half codeword of (207, 187) Reed-Solomon forward-error-correction coding; circuitry for modifying each possible half codeword of (207, 187) Reed-Solomon forward-error correction coding for counteracting prior modification of that possible half codeword that might have been made at the transmitter so that the data segment containing that possible half codeword would be disregarded by legacy digital television receivers; and
a possible-codeword assembler for assembling four complete possible codewords of (207, 187) Reed-Solomon forward-error-correction coding from pairs of the possible half codewords generated by said data compressor and their modifications made by said circuitry for modifying each possible half codeword of (207, 187) Reed-Solomon forward-error-correction coding, said complete possible codewords being included in said complete codewords of (207, 187) Reed-Solomon forward-error-correction coding that said apparatus for recovering complete codewords of (207, 187) Reed-Solomon forward-error-correction coding supplies and that said (207, 187) Reed-Solomon forward-error-correction decoding apparatus responds to.

18. A receiver for digital television signals transmitted at radio frequencies using vestigial-sideband amplitude-modulation in accordance with trellis-coded symbols selected from an 8VSB symbol alphabet, said receiver comprising:
circuitry for receiving a selected one of said digital television signals transmitted at radio frequencies and recovering therefrom a baseband digital television signal comprising said trellis-coded symbols selected from said 8VSB symbol alphabet;
a trellis decoder connected for receiving said baseband digital television signal and decoding said trellis-coded symbols to recover data fields of convolutionally interleaved data segments;
a de-interleaver connected for responding to said convolutionally interleaved data segments to supply fields of successive de-interleaved data segments;
a transmission-pattern detector connected for responding to portions of said baseband digital television signal to detect the patterns of any robust or super-robust transmittals in said fields of successive de-interleaved data segments, connected for supplying indications of the nature of redundant coding that each of said de-interleaved data segments uses if it was not transmitted as a complete codeword of (207, 187) Reed-Solomon forward-error-correction coding but was transmitted to include a redundantly coded aliquot portion of a complete codeword of (207, 187) Reed-Solomon forward-error-correction coding;
de-multiplexing circuitry controlled responsive to said indications supplied from said transmission-pattern detector for sorting said de-interleaved data segments that were transmitted as respective complete codewords of (207, 187) Reed-Solomon forward-error-correction coding from groups of said de-interleaved data segments that each include a respective portion of a redundantly coded complete codeword of (207, 187) Reed-Solomon forward-error-correction coding;
apparatus for recovering complete codewords of (207, 187) Reed-Solomon forward-error-correction coding from said groups of said de-interleaved data segments that each include a respective portion of a redundantly coded complete codeword of (207, 187) Reed-Solomon forward-error-correction coding;
first (207, 187) Reed-Solomon forward-error-correction decoding apparatus, which is connected to receive each of said complete codewords of Reed-Solomon forward-error-correction coding supplied from said de-interleaver, which is connected for supplying packets of randomized data extracted from respective ones of said complete Reed-Solomon forward-error-correction codewords received thereby, which is operable for correcting up to ten erroneous bytes in any data packet supplied therefrom, and which is operable for furnishing indications of whether or not each data packet supplied therefrom contains uncorrected erroneous bytes;
second (207, 187) Reed-Solomon forward-error-correction decoding apparatus, which is connected to receive complete codewords of Reed-Solomon forward-error-correction coding supplied from said apparatus for recovering complete codewords of (207, 187) Reed-Solomon forward-error-correction coding from said groups of said de-interleaved data segments that each include a respective portion of a redundantly coded complete codeword of (207, 187) Reed-Solomon forward-error-correction coding, which is connected for supplying packets of randomized data extracted from respective ones of said complete Reed-Solomon forward-error-correction codewords received thereby, which is connected to respond to indications from said error-correction decoder apparatus of the locations of erroneous bytes in each complete codeword of Reed-Solomon forward-error-correction coding received from said Reed-Solomon forward-error-correction codeword assembler, which because of erroneous bytes already being located is operable for correcting up to twenty erroneous bytes in any data packet supplied therefrom, and which is operable for furnishing indications of whether or not each data packet supplied therefrom contains uncorrected erroneous bytes;
data de-randomization apparatus connected for supplying packets of de-randomized data in response to said packets of randomized data supplied to said data de-randomizer from said first and second (207, 187) Reed-Solomon forward-error-correction decoding apparatuses; header detection apparatus connected for detecting the packet identification bits in each packet of de-randomized data supplied from said data de-randomization apparatus; and
a transport stream de-multiplexer connected for sorting said packets of de-randomized data supplied from said data de-randomization apparatus responsive to the packet identification bits said header detection apparatus detects within each of said packets of de-randomized data.

19. The receiver of claim 18 for digital television signals, some data segments of which are apt to employ (15, 8) binary linear block coding together with the full alphabet of 8VSB symbols, wherein said de-multiplexing circuitry is connected for separating groups of two said de-interleaved data segments that employ (15, 8) binary linear block coding together with the full alphabet of 8VSB symbols, and wherein said apparatus for recovering complete codewords of (207, 187) Reed-Solomon forward-error-correction coding from said groups of said de-interleaved data segments that each include a respective portion of a redundantly coded complete codeword of (207, 187) Reed-Solomon forward-error-correction coding comprises:
an error-correction decoder for (15, 8) binary linear coding, connected for receiving said separated groups of two said de-interleaved data segments that employ binary linear block coding together with the full alphabet of 8VSB symbols, and connected for supplying a respective half codeword of (207, 187) Reed-Solomon forward-error-correction coding in response to each said separated de-interleaved data segment that employs (15, 8) binary linear block coding together with the full alphabet of 8VSB symbols; and
a codeword assembler connected for receiving half codewords of (207, 187) Reed-Solomon forward-error-correction coding from said error-correction decoder for binary linear coding, and connected for said supplying said second (207, 187) Reed-Solomon forward-error-correction decoding apparatus with complete codewords of (207, 187) Reed-Solomon forward-error-correction coding assembled from said half codewords.

20. The receiver of claim 18 for digital television signals, some data segments of which are apt to employ (15, 8) binary linear block coding together with only a restricted alphabet of 8VSB symbols that further halves code rate, wherein said de-multiplexing circuit is connected for separating groups of four said de-interleaved data segments that employ (15, 8) binary linear block coding together with only said restricted alphabet of 8VSB symbols, and wherein said apparatus for recovering complete codewords of (207, 187) Reed-Solomon forward-error-correction coding from said groups of said de-interleaved data segments that each include a respective portion of redundantly coded complete codeword of (207, 187) Reed-Solomon forward-error-correction coding comprises:
a data compressor that generates a respective compressed de-interleaved data segment responsive to each of said de-interleaved data segments that employs (15, 8) binary linear block coding together with only said restricted alphabet of 8VSB symbols;
an error-correction decoder for (15, 8) binary linear block coding, connected for receiving said compressed de-interleaved data segments from said data compressor, and connected for supplying quarter codewords of (207, 187) Reed-Solomon forward-error-correction coding recovered from respective compressed de-interleaved data segments; and
a codeword assembler, connected for receiving said quarter codewords of (207, 187) Reed-Solomon forward-error-correction coding from said error-correction decoder for (15, 8) binary linear block coding, and connected for supplying said second (207, 187) Reed-Solomon forward-error-correction decoding apparatus with complete codewords of (207, 187) Reed-Solomon forward-error-correction coding assembled from those received said quarter codewords of (207, 187) Reed-Solomon forward-error-correction coding.

21. The receiver of claim 18 for digital television signals, some data segments of which are apt to employ binary linear block coding together with the full alphabet of 8VSB symbols, wherein said de-multiplexing circuitry is connected for separating groups of two said de-interleaved data segments that employ binary linear block coding together with the full alphabet of 8VSB symbols, and wherein said apparatus for recovering complete codewords of (207, 187) Reed-Solomon forward-error-correction coding from said groups of said de-interleaved data segments that each include a respective portion of a redundantly coded complete codeword of (207, 187) Reed-Solomon forward-error-correction coding comprises:
a first error-correction decoder for binary linear block coding, connected for receiving said separated de-interleaved data segments that employ binary linear block coding together with the full alphabet of 8VSB symbols, and connected for supplying a respective possible half codeword of (207, 187) Reed-Solomon forward-error-correction coding in response to each said separated de-interleaved data segment that employs binary linear block coding together with the full alphabet of 8VSB symbols;
circuitry for modifying each said separated de-interleaved data segments that employ binary linear block coding together with the full alphabet of 8VSB symbols to generate a respective modified separated de-interleaved data segment that binary linear block coding together with the full alphabet of 8VSB symbols, said modifying being such as to counteract possible prior modification of that data segment that might have been made at the transmitter so that the data segment would be disregarded by legacy digital television receivers;
a second error-correction decoder for binary linear block coding, connected for receiving said modified separated de-interleaved data segments that employ binary linear block coding together with the full alphabet of 8VSB symbols, and connected for supplying a respective possible half codeword of (207, 187) Reed-Solomon forward-error-correction coding in response to each said separated de-interleaved data segment that employs binary linear block coding together with the full alphabet of 8VSB symbols; and
a possible-codeword assembler for assembling four complete possible codewords of (207, 187) Reed-Solomon forward-error-correction coding from each two possible initial half codewords that said first and second error-correction decoders concurrently supply and from each two possible final half codewords that said first and second error-correction decoders supply most immediately thereafter, said complete possible codewords being included in said complete codewords of (207, 187) Reed-Solomon forward-error-correction coding that said apparatus for recovering complete codewords of (207, 187) Reed-Solomon forward-error-correction coding supplies and that said second (207, 187) Reed-Solomon forward-error-correction decoding apparatus responds to.

22. The receiver of claim 21 for digital television signals, wherein said binary linear block coding is (16, 8) binary linear block coding.

23. The receiver of claim 8 for digital television signals, some data segments of which are apt to employ binary linear block coding together with only a restricted alphabet of 8VSB symbols that further halves code rate, wherein said de-multiplexing circuitry is connected for separating groups of four said de-interleaved data segments that employ binary linear block coding together with only said restricted alphabet of 8VSB symbols, and wherein said apparatus for recovering complete codewords of (207, 187) Reed-Solomon forward-error-correction coding from said groups of said de-interleaved data segments that each include a respective portion of a redundantly coded complete codeword of (207, 187) Reed-Solomon forward-error-correction coding comprises:
a data compressor that generates a respective compressed de-interleaved data segment responsive to each of said de-interleaved data segments that employs linear block coding together with only said restricted alphabet of 8VSB symbols;
a first error-correction decoder for binary linear block coding, connected for receiving said separated de-interleaved data segments that employ binary linear block coding together with only said restricted alphabet of 8VSB symbols, and connected for supplying a respective possible quarter codeword of (207, 187) Reed-Solomon forward-error-correction coding in response to each said separated de-interleaved data segment that employs binary linear block coding together with said restricted alphabet of 8VSB symbols;
circuitry for modifying each said separated de-interleaved data segments that employ binary linear block coding together with only said restricted alphabet of 8VSB symbols to generate a respective modified separated de-interleaved data segment that employs binary linear block coding together with said restricted alphabet of 8VSB symbols, said modifying being such as to counteract possible prior modification of that data segment that might have been made at the transmitter so that the data segment would be disregarded by legacy digital television receivers;
a second error-correction decoder for binary linear block coding, connected for receiving said modified separated de-interleaved data segments that employ binary linear block coding together with only said restricted alphabet of 8VSB symbols, and connected for supplying a respective possible quarter codeword of (207, 187) Reed-Solomon forward-error-correction coding in response to each said separated de-interleaved data segment that employs binary linear block coding together with said restricted alphabet of 8VSB symbols; and
a possible-codeword assembler for assembling sixteen complete possible codewords of (207, 187) Reed-Solomon forward-error-correction coding from each set of four successive pairs of possible quarter codewords that said first and second error-correction decoders concurrently supply, said complete possible codewords being included in said complete codewords of (207, 187) Reed-Solomon forward-error-correction coding that said apparatus for recovering complete codewords of (207, 187) Reed-Solomon forward-error-correction coding supplies and that said second (207, 187) Reed-Solomon forward-error-correction decoding apparatus responds to.

24. The receiver of claim 23 for digital television signals, wherein said binary linear block coding is (16, 8) binary linear block coding.

25. The receiver of claim 18 for digital television signals, some data segments of which are apt to employ a restricted alphabet of 8VSB symbols that causes halving of code rate over ordinary 8VSB with ⅔ trellis coding, wherein said de-multiplexing circuitry is connected for separating groups of said de-interleaved data segments that employ only said restricted alphabet of 8VSB symbols and have half the code rate of ordinary 8VSB with ⅔ trellis coding, and wherein said apparatus for recovering complete codewords of (207, 187) Reed-Solomon forward-error-correction coding from said groups of said de-interleaved data segments that each include a respective portion of a redundantly coded complete codeword of (207, 187) Reed-Solomon forward-error-correction coding comprises:
a data compressor that deletes alternate bits of each said de-interleaved data segment that employs only said restricted alphabet of 8VSB symbols and has half the code rate of ordinary 8VSB with ⅔ trellis coding, thereby to generate a possible half codeword of (207, 187) Reed-Solomon forward-error-correction coding;
circuitry for modifying each possible half codeword of (207, 187) Reed-Solomon forward-error-correction coding for counteracting prior modification of that possible half codeword that might have been made at the transmitter so that the data segment containing that possible half codeword would be disregarded by legacy digital television receivers; and
a possible-codeword assembler for assembling four complete possible codewords of (207, 187) Reed-Solomon forward-error-correction coding from pairs of the possible half codewords generated by said data compressor and their modifications made by said circuitry for modifying each possible half codeword of (207, 187) Reed-Solomon forward-error-correction coding, said complete possible codewords being included in said complete codewords of (207, 187) Reed-Solomon forward-error-correction coding that said apparatus for recovering complete codewords of (207, 187) Reed-Solomon forward-error-correction coding supplies and that said first (207, 187) Reed-Solomon forward-error-correction decoding apparatus responds to.
